(19) United States
(12) Patent Application Publication
(10) Pub. No.: US 2023/0342773 A1
(43) Pub. Date: Oct. 26, 2023

(54) Methods, systems, and devices of managing digital assets, including digital asset deposits, digital asset term deposits, digital asset withdrawals, and early withdrawals of digital asset term deposits

(71) Applicant: STANDARD CHARTERED BANK (SINGAPORE) LIMITED, Singapore (SG)

(72) Inventors: Nilav Bose, Singapore (SG); Keith Macdonald, Singapore (SG); Stuart McConnell, London (GB); Simon Figures, San Francisco, CA (US); Ho Hee Jung, Singapore (SG)

(21) Appl. No.: 17/049,926

(22) PCT Filed: Feb. 7, 2020
(86) PCT No.: PCT/SG2020/050058

§ 371 Date: Oct. 22, 2020

(51) Int. Cl. G06Q 20/40; G06Q 20/38; G06Q 20/36

(52) U.S. Cl. CPC G06Q 20/401; G06Q 20/389; G06Q 20/367

(57) ABSTRACT

Embodiments relate to methods and systems for managing digital assets. The method includes receiving, from a user, and processing a request to receive digital assets. The processing includes determining a fiat amount based on the digital assets. The processing includes recording, in a distributed ledger, the digital asset issuance to user. The processing includes depositing, with a main bank, the fiat amount received from user. The method includes receiving, from user, and processing a request to deposit digital assets. The processing includes determining a second fiat amount based on the digital assets. The processing includes generating, in the distributed ledger, first and second records. First record represents a deposit of digital assets with a designated bank. Second record represents a transfer of digital assets from the designated bank to the main bank in exchange for deposit of the second fiat amount by the main bank with the designated bank.

### TECHNICAL FIELD

The present disclosure relates generally to managing digital assets, and more specifically, to methods, systems, devices, and logic for managing the deposit and withdrawal of digital assets, including interest-bearing deposits and withdrawals of digital assets and interest-bearing term deposits and withdrawals of digital assets.

### BACKGROUND

There are various forms of digital assets in existence today, including well known and widely used/held digital assets such as Bitcoin, Ethereum, XRP by Ripple, Bitcoin Cash, Litecoin, Stellar Lumens, EOS, Ethereum Classic, Tether, TrueUSD, MakerDAO, USD Coin, smart contracts, etc. In terms of utility, certain digital assets have been designed to provide many similar features to those of fiat currencies (e.g., the US Dollar, the Singapore Dollar, etc.). For example, certain digital assets may be exchanged between other digital assets (and fiat currencies), stored/saved (e.g., stored in digital wallets), transferred between users (e.g., transferred from a digital wallet of one user to a digital wallet of another user), and/or used to make a payment for a good and/or service (e.g., transferred from a digital wallet of a user to a digital wallet of a retailer). Stablecoins have become increasingly popular over the years due to its relative stability of value, making it more suitable than many other forms of digital assets for payments and as a stable store of value.

### BRIEF SUMMARY

While digital assets are becoming more widely used and accepted, it is recognized in the present disclosure that conventional approaches to digital assets have encountered difficulties and/or problems in replicating, matching, and/or mirroring certain features, utilities, functionalities, characteristics, and/or aspects of fiat currencies. Digital assets offer benefits that are important for the infrastructure of a modern financial ecosystem. In this regard, it is recognized in the present disclosure that example embodiments of managing digital assets, including cryptocurrencies and its underlying technology concepts, may be applied to create futuristic value storage and/or transfer, distribution and transaction systems. Present example embodiments relate generally to and/or include systems, subsystems, processors, devices, logic, methods, and processes for managing digital asset, including, but not limited to, managing of digital asset issuance and/or generation; managing of digital asset deposits, including interest-bearing deposits of digital assets; managing of withdrawals of deposited digital assets, including corresponding interest accrued from the deposit of such digital assets; managing of withdrawals of fiat currency, including corresponding interest accrued from digital asset deposits; managing of interest-bearing fiat currency term deposits, including flexible (or early termination) fiat currency term deposits, transferring of fiat currency term deposits, or taking over of fiat currency term deposits; managing of interest-bearing digital asset term deposits, including flexible (or early termination) digital asset term deposits, transferring of digital asset term deposits, or taking over of digital asset term deposits; managing of withdrawals of fiat currency term deposits, including withdrawals of fiat currency deposited in term deposits and corresponding interest accrued from such fiat currency term deposits; managing of withdrawals of digital asset term deposits, including withdrawals of digital asset deposited in term deposits and corresponding interest accrued from such digital asset term deposits; managing of withdrawals from digital asset term deposits, including withdrawals of fiat currency from digital asset term deposits and corresponding interest accrued from such digital asset term deposits; managing of early or pre-term withdrawals of fiat currency deposited in term deposits, and corresponding interest accrued from the early withdrawal of such fiat currency term deposits; managing of early or pre-term withdrawals of digital assets deposited in term deposits, and corresponding interest accrued from the early withdrawal of such digital asset term deposits; managing of early or pre-term withdrawals of fiat currency from digital asset term deposits, and corresponding interest accrued from the early withdrawal of fiat currency from digital asset term deposits; managing of transfers or take overs, by one or more users, of term deposits of fiat currency from another user who wish to perform an early withdrawal of such fiat currency term deposit; managing of transfers or take overs, by one or more users, of term deposits of digital assets from another user who wish to perform an early withdrawal of such digital asset term deposit; and managing of customer information sharing networks, or the like, for enabling financial institutions and other organizations/entities to share anonymized and/or semi-anonymized customer information, including customer onboarding information, customer intake information, know-your-client (KYC) information, credit history or credit check information, anti-money laundering (AML) information, etc., among or between each other.

In an exemplary embodiment, a method of managing digital assets is described. The method may include receiving, from a first user, a first deposit request. The first deposit request may be a request to deposit a first amount of a digital asset. The method may also include performing, by a processor, a digital asset deposit process. The digital asset deposit process may be for processing the first deposit request. The digital asset deposit process may include determining a first amount of a fiat currency. The first amount of the fiat currency may be determined based on the first amount of the digital asset. The digital asset deposit process may also include generating, in a first distributed ledger, a first deposit record. The first deposit record may include a first record. The first record may be a record of a transfer of the first amount of the digital asset from the first user to a designated financial institution. The first record may represent a deposit of the first amount of the digital asset made by the first user with the designated financial institution. The first deposit record may include a second record. The second record may be a record of a transfer of the first amount of the digital asset from the designated financial institution to a main financial institution. The second record may represent a transfer of the first amount of the digital asset from the designated financial institution to the main financial institution in exchange for a deposit of the first amount of the fiat currency by the main financial institution with the designated financial institution. The method may also include receiving, from the first user, a first withdrawal request. The first withdrawal request may be a request to withdraw a second amount of the digital asset. The second amount of the digital asset may be at least a portion of the first amount of the digital asset deposited by the first user pursuant to the first deposit record. The method may also include performing, by the processor, a digital asset withdrawal process. The digital asset withdrawal process may be for processing the first withdrawal request. The digital asset withdrawal process may include determining a second amount of the fiat currency. The second amount of the fiat currency may be determined based on the second amount of the digital asset. The digital asset withdrawal process may also include determining a first accrued amount. The first accrued amount may represent an amount of interest accrued by depositing the second amount of the digital asset. The digital asset withdrawal process may also include generating, in the first distributed ledger, a first withdrawal record. The first withdrawal record may include a third record. The third record may be a record of a transfer of the second amount of the digital asset from the main financial institution to the designated financial institution. The third record may represent a transfer of the second amount of the digital asset from the main financial institution to the designated financial institution in exchange for a withdrawal of the second amount of the fiat currency by the main financial institution from the designated financial institution. The first withdrawal record may also include a fourth record. The fourth record may be a record of a transfer of the second amount of the digital asset from the designated financial institution to the first user. The fourth record may represent a withdrawal of the second amount of the digital asset by the first user from the designated financial institution. The digital asset withdrawal process may also include generating, by the processor, an instruction to the designated financial institution to transfer the first accrued amount to the first user.

In another exemplary embodiment, a method of managing digital assets is described. The method may include receiving, from a first user, a first deposit request. The first deposit request may be a request to deposit a first amount of a digital asset. The method may also include selecting, by a processor from among a plurality of financial institutions, a designated financial institution for the first deposit request based on one or more predetermined criterion. The method may also include identifying, by the processor, a main financial institution. The method may also include performing, by the processor, a digital asset deposit process. The digital asset deposit process may be for processing the first deposit request. The digital asset deposit process may include determining a first amount of a fiat currency. The first amount of the fiat currency may be determined based on the first amount of the digital asset. The digital asset deposit process may also include generating, in a first distributed ledger, a first deposit record. The first deposit record may include a first record. The first record may be a record of a transfer of the first amount of the digital asset from the first user to the designated financial institution. The first record may represent a deposit of the first amount of the digital asset made by the first user with the designated financial institution. The first deposit record may also include a second record. The second record may be a record of a transfer of the first amount of the digital asset from the designated financial institution to the main financial institution. The second record may represent a transfer of the first amount of the digital asset from the designated financial institution to the main financial institution in exchange for a deposit of the first amount of the fiat currency by the main financial institution with the designated financial institution. The digital asset deposit process may also include transferring, from the main financial institution to the designated financial institution, the first amount of the fiat currency. The method may also include receiving, from the first user, a first withdrawal request. The first withdrawal request may be a request to withdraw the first amount of the digital asset deposited by the first user pursuant to the first deposit record. The method may also include performing, by the processor, a digital asset withdrawal process. The digital asset withdrawal process may be for processing the first withdrawal request. The digital asset withdrawal process may include determining a first accrued amount. The first accrued amount may represent an amount of interest accruable and/or accrued by depositing the first amount of the fiat currency with the designated financial institution. The digital asset withdrawal process may also include generating, in the first distributed ledger, a first withdrawal record. The first withdrawal record may include a third record. The third record may be a record of a transfer of the first amount of the digital asset from the main financial institution to the designated financial institution. The third record may represent a transfer of the first amount of the digital asset from the main financial institution to the designated financial institution in exchange for a withdrawal of the first amount of the fiat currency by the main financial institution from the designated financial institution. The first withdrawal record may include a fourth record. The fourth record may include a record of a transfer of the first amount of the digital asset from the designated financial institution to the first user. The fourth record may represent a withdrawal of the first amount of the digital asset by the first user from the designated financial institution. The digital asset withdrawal process may also include transferring, from the designated financial institution to the main financial institution, the first amount of the fiat currency. The digital asset withdrawal process may also include transferring, from the designated financial institution to the first user, the first accrued amount.

In another exemplary embodiment, a method of managing digital assets is described. The method may include receiving, by a processor from a first user, a first deposit request. The first deposit request may be a request to perform a term deposit of a first amount of a digital asset. The first deposit request may include a start date and end date of the term deposit. The method may also include performing, by the processor, a digital asset deposit process. The digital asset deposit process may be for processing the first deposit request. The digital asset deposit process may include generating, in the first distributed ledger, a first deposit record. The first deposit record may include a first record. The first record may be a record of a transfer of the first amount of the digital asset from the first user to a designated financial institution. The first record may represent a term deposit of the first amount of the digital asset made by the first user with the designated financial institution. The method may also include receiving, by the processor from the first user, an early withdrawal request. The early withdrawal request may be a request to withdraw a second amount of the digital asset before the end date of the term deposit. The second amount of the digital asset may be at least a portion of the first amount of the digital asset deposited by the first user pursuant to the first deposit record. The method may also include performing, by the processor, an early withdrawal process. The early withdrawal process may be for processing the early withdrawal request. The early withdrawal process may include identifying a second user for taking over, from the first user on a transfer date, a portion of the term deposit equal to the second amount of the digital asset. The early withdrawal process may include determining a first accrued amount. The first accrued amount may be an amount of interest to be provided to the first user for depositing the second amount of the digital asset up to the transfer date. The early withdrawal process may include generating, in the first distributed ledger, a first transfer record. The first transfer record may include a second record. The second record may be a record of a transfer of the second amount of the digital asset from the designated financial institution to the first user. The second record may represent an early withdrawal of the second amount of the digital asset deposited by the first user with the designated financial institution. The first transfer record may also include a third record. The third record may be a record of a transfer of the second amount of the digital asset from the second user to the designated financial institution. The third record may represent a taking over of the portion of the term deposit equal to the second amount of the digital asset made by the second user. The early withdrawal process may also include generating, by the processor, an instruction to the designated financial institution to transfer the first accrued amount to the first user.

In another exemplary embodiment, a method of managing digital assets is described. The method may include receiving, from a first user, a first deposit request. The first deposit request may be a request to deposit a first amount of a digital asset. The method may also include selecting, by a processor from among a plurality of financial institutions, a designated financial institution for the first deposit request based on one or more predetermined criterion. The method may also include identifying, by the processor, a main financial institution. The method may also include determining, by the processor, whether or not the designated financial institution has previously completed a first new customer intake process for the first user. The first new customer intake process may be a process performed by the designated financial institution before accepting a new customer. Responsive to a determination that the designated financial institution has not completed the first new customer intake process for the first user, the method may include determining, by the processor, whether or not a second financial institution has previously performed a second new customer intake process for the first user. The second new customer intake process may be a process performed by the second financial institution before accepting a new customer. The second financial institution may be a financial institution other than the designated financial institution. Responsive to a determination that the designated financial institution has not completed the first new customer intake process for the first user and responsive to a determination that the second financial institution has previously performed the second new customer intake process for the first user, the method may include providing, by the processor to the designated financial institution, one or more results from the second new customer intake process for the first user. Responsive to a determination that the designated financial institution has not completed the first new customer intake process for the first user and responsive to a determination that the second financial institution has previously performed the second new customer intake process for the first user, the method may also include performing, by the processor, an abbreviated customer review process in replacement of the first new customer intake process. The abbreviated customer review process may include using the one or more results from the second new customer intake process for the first user. Responsive to a determination that the designated financial institution has not completed the first new customer intake process for the first user and responsive to a determination that the second financial institution has previously performed the second new customer intake process for the first user, the method may also include performing, by the processor, a digital asset deposit process based on the abbreviated customer review process. The digital asset deposit process may be for processing the first deposit request. The digital asset deposit process may include generating, in a first distributed ledger, a first deposit record. The first deposit record may include a first record. The first record may be a record of a transfer of the first amount of the digital asset from the first user to a designated financial institution. The first record may represent a deposit of the first amount of the digital asset made by the first user with the designated financial institution. The first deposit record may also include a second record. The second record may be a record of a transfer of the first amount of the digital asset from the designated financial institution to the main financial institution. The second record may represent a transfer of the first amount of the digital asset from the designated financial institution to the main financial institution in exchange for a deposit of the first amount of the fiat currency by the main financial institution with the designated financial institution. The method may also include receiving, from the first user, a first withdrawal request. The first withdrawal request may be a request to withdraw a second amount of the digital asset. The second amount of the digital asset may be at least a portion of the first amount of the digital asset deposited by the first user pursuant to the first deposit record. The method may also include performing, by the processor, a digital asset withdrawal process. The digital asset withdrawal process may be for processing the first withdrawal request. The digital asset withdrawal process may include determining a second amount of a fiat currency. The second amount of the fiat currency may be determined based on the second amount of the digital asset. The digital asset withdrawal process may also include determining a first accrued amount. The first accrued amount may represent an amount of interest accrued by depositing the second amount of the digital asset. The digital asset withdrawal process may also include generating, in the first distributed ledger, a first withdrawal record. The first withdrawal record may include a third record. The third record may be a record of a transfer of the second amount of the digital asset from the main financial institution to the designated financial institution. The third record may represent a transfer of the second amount of the digital asset from the main financial institution to the designated financial institution in exchange for a withdrawal of the second amount of the fiat currency by the main financial institution from the designated financial institution. The first withdrawal record may also include a fourth record. The fourth record may be a record of a transfer of the second amount of the digital asset from the designated financial institution to the first user. The fourth record may represent a withdrawal of the second amount of the digital asset by the first user from the designated financial institution. The digital asset withdrawal process may also include generating, by the processor, an instruction to the designated financial institution to transfer the first accrued amount to the first user.

In another exemplary embodiment, a method of managing digital assets is described. The method may include receiving, from a first user, a first digital asset request. The first digital asset request may be a request to receive a first amount of a digital asset. The method may also include performing, by a processor, a digital asset exchange process. The digital asset exchange process may be for processing the first digital asset request. The digital asset exchange process may include determining a first amount of a fiat currency. The first amount of the fiat currency determined based on the first amount of the digital asset. Responsive to receiving, from the first user, the first amount of the fiat currency, the digital asset exchange process may also include recording, in a first distributed ledger, an issuance of the first amount of the digital asset to the first user. Responsive to receiving, from the first user, the first amount of the fiat currency, the digital asset exchange process may also include depositing, with a main financial institution, the first amount of the fiat currency received from the first user. The method may also include receiving, from the first user, a first deposit request. The first deposit request may be a request to deposit the first amount of the digital asset. The method may also include performing, by a processor, a digital asset deposit process. The digital asset deposit process may be for processing the first deposit request. The digital asset deposit process may include determining a second amount of the fiat currency. The second amount of the fiat currency may be determined based on a current fiat currency valuation of the first amount of the digital asset. The digital asset deposit process may also include generating, in the first distributed ledger, a first deposit record. The first deposit record may include a first record. The first record may be a record of a transfer of the first amount of the digital asset from the first user to a designated financial institution. The first record may represent a deposit of the first amount of the digital asset made by the first user with the designated financial institution. The first deposit record may also include a second record. The second record may be a record of a transfer of the first amount of the digital asset from the designated financial institution to the main financial institution. The second record may represent a transfer of the first amount of the digital asset from the designated financial institution to the main financial institution in exchange for a deposit of the second amount of the fiat currency by the main financial institution with the designated financial institution.

### BRIEF DESCRIPTION OF THE FIGURES

For a more complete understanding of the present disclosure, example embodiments, and their advantages, reference is now made to the following description taken in conjunction with the accompanying figures, in which like reference numbers indicate like features, and:

FIG. 1 is an illustration of an example embodiment of a system for managing digital assets;

FIG. 2 is an illustration of an example embodiment of a processor for managing digital assets;

FIG. 3 is an illustration of an example embodiment of a request processor;

FIG. 4 is an illustration of an example embodiment of a transaction processor;

FIG. 5A is an illustration of an example embodiment of a digital asset generator processing an issuance of digital assets;

FIG. 5B is an illustration of an example embodiment of a digital asset deposit processor processing a digital asset deposit and/or digital asset term deposit;

FIG. 5C is an illustration of an example embodiment of a digital asset withdrawal processor processing a digital asset withdrawal and/or withdrawal of digital assets from a digital asset term deposit;

FIG. 5D is an illustration of an example embodiment of a digital asset withdrawal processor processing an early withdrawal of digital assets from a digital asset term deposit;

FIG. 5E is an illustration of an example embodiment of a digital asset deposit processor processing a digital asset deposit and/or digital asset term deposit with a designated financial institution by a current financial institution on behalf of a user;

FIG. 5F is an illustration of an example embodiment of a digital asset withdrawal processor processing a digital asset withdrawal and/or withdrawal of digital assets from a digital asset term deposit by a current financial institution on behalf of a user;

FIG. 6 is an illustration of an example embodiment of a method of issuing digital assets;

FIG. 7 is an illustration of an example embodiment of a method of depositing digital assets and/or performing digital asset term deposits;

FIG. 8 is an illustration of an example embodiment of a method of withdrawing digital assets; and

FIG. 9 is an illustration of an example embodiment of a method of performing an early withdrawal of digital assets from a digital asset term deposit.

Although similar reference numbers may be used to refer to similar elements in the figures for convenience, it can be appreciated that each of the various example embodiments may be considered to be distinct variations.

Example embodiments will now be described with reference to the accompanying figures, which form a part of the present disclosure and which illustrate example embodiments which may be practiced. As used in the present disclosure and the appended claims, the terms “embodiment”, “example embodiment”, “exemplary embodiment”, and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on”, and the terms “a”, “an”, and “the” may include singular and plural references. Furthermore, as used in the present disclosure and the appended claims, the term “by” may also mean “from”, depending on the context. Furthermore, as used in the present disclosure and the appended claims, the term “if” may also mean “when” or “upon”, depending on the context. Furthermore, as used in the present disclosure and the appended claims, the words “and/or” may refer to and encompass any and all possible combinations of one or more of the associated listed items.

### DETAILED DESCRIPTION

Various forms of digital assets are in existence today. Certain digital assets may be utilized in similar ways as fiat currencies. Fiat currencies may include, for example, the US Dollar, the Singapore Dollar, the British Pound Sterling, the Euro, the Japanese Yen, the Chinese Yuan, etc. For example, digital assets may be stored/saved (e.g., in digital wallets), transferred between users in a peer-to-peer (P2P) manner (e.g., transferred from a digital wallet of one user to a digital wallet of another user), and/or transferred to a retailer/merchant as payment for a good and/or service (e.g., transferred from a digital wallet of a user to a digital wallet of a retailer). Certain digital assets, such as stablecoins, or the like, have become increasingly popular over the years. Stablecoins have become popular among those users who prefer more certainty in terms of valuation (e.g., as compared to the potentially wild fluctuations in value seen in other types of digital assets, such as Bitcoin, Ethereum, etc.) and prefer to utilize such digital assets in much the same manner as fiat currencies (e.g., for payment of goods and services). Stablecoins are available in several forms. For example, stablecoins may be backed by, pegged to, and/or collateralized by one or more fiat currencies (e.g., the US Dollar, etc.). As another example, stablecoins may be backed by, pegged to, and/or collateralized by one or more commodities, such as precious metals (e.g., gold, etc.). In yet another example, stablecoins may be backed by, pegged to, and/or collateralized by one or more other digital assets (e.g., one or more cryptocurrencies such as Bitcoin, etc.).

While digital assets are becoming more widely used and accepted, it is recognized in the present disclosure that conventional approaches to digital assets have encountered difficulties and/or problems in replicating, matching, and/or mirroring certain features, utilities, functionalities, characteristics, and/or aspects of fiat currencies.

Present example embodiments relate generally to and/or include systems, subsystems, processors, devices, logic, methods, and processes for addressing conventional problems, including those described above and in the present disclosure. More specifically, example embodiments relate to systems, subsystems, processors, devices, logic, methods, and processes for managing digital asset, including, but not limited to, managing of digital asset issuance and/or generation; managing of digital asset deposits, including interest-bearing deposits of digital assets; managing of withdrawals of deposited digital assets, including corresponding interest accrued from the deposit of such digital assets; managing of withdrawals of fiat currency, including corresponding interest accrued, from digital asset deposits; managing of interest-bearing fiat currency term deposits, including flexible (or early termination) fiat currency term deposits, transferring of fiat currency term deposits, or taking over of fiat currency term deposits; managing of interest-bearing digital asset term deposits, including flexible (or early termination) digital asset term deposits, transferring of digital asset term deposits, or taking over of digital asset term deposits; managing of withdrawals of fiat currency term deposits, including withdrawals of fiat currency deposited in term deposits and corresponding interest accrued from such fiat currency term deposits; managing of withdrawals of digital asset term deposits, including withdrawals of digital asset deposited in term deposits and corresponding interest accrued from such digital asset term deposits; managing of withdrawals from digital asset term deposits, including withdrawals of fiat currency from digital asset term deposits and corresponding interest accrued from such digital asset term deposits; managing of early or pre-term withdrawals of fiat currency deposited in term deposits, and corresponding interest accrued from the early withdrawal of such fiat currency term deposits; managing of early or pre-term withdrawals of digital assets deposited in term deposits, and corresponding interest accrued from the early withdrawal of such digital asset term deposits; managing of early or pre-term withdrawals of fiat currency from digital asset term deposits, and corresponding interest accrued from the early withdrawal of fiat currency from digital asset term deposits; managing of transfers or take overs, by one or more users, of term deposits of fiat currency from another user who wish to perform an early withdrawal of such fiat currency term deposit; managing of transfers or take overs, by one or more users, of term deposits of digital assets from another user who wish to perform an early withdrawal of such digital asset term deposit; and managing of customer information sharing networks, or the like, for enabling financial institutions and other organizations/entities to share anonymized and/or semi-anonymized customer information, including customer onboarding information, customer intake information, know-your-client (or “KYC”) information, credit history or credit check information, anti-money laundering (or “AML”) information, etc., among or between each other.

As used in the present disclosure, the term “digital asset” may also be referred to as a “digital token”, or the like, and may include, but is not limited to, cryptocurrencies, digital tokens, security-backed tokens, unsecured tokens, stablecoins, altcoins, public key and private key pairs, smart contracts, RSA, and the like. Furthermore, the term “hashing”, or the like, is a term known in the art and, where applicable, may broadly and equivalently refer to a transformation or mapping of an input into a fixed-length string or series of characters (e.g., by using a hashing algorithm, hashing function, or the like). Similarly, the term “hash” may, where applicable, broadly refer to a fixed-length string or series of characters resulting from hashing an input (e.g., by using a hashing algorithm, hashing function, or the like. As known in the art, it is impossible to derive an original input from its hash. Furthermore, the terms “encrypting”, “encryption”, and “encrypt” are terms known in the art and, where applicable, may broadly and equivalently refer to a conversion of an input into a series of characters (or encrypted input) in such a way that the input can be readily recovered from the encrypted input (e.g., if an appropriate key is applied to decrypt the encrypted input). Furthermore, the terms “digitally signing”, “digital signing”, “digitally sign”, “signing”, “sign”, and the like, are terms known in the art for creating digital signatures and, where applicable, may broadly and equivalently refer to encrypting an input using a private key (i.e., for digital signatures, which is unlike the general approach of encrypting a message using a public key) so as to create a digital signature in such a manner that a recipient can, by applying a corresponding public key (i.e., a public key that corresponds to the private key used to create the digital signature; for digital signatures, the public key is used to decrypt the digital signature, which is unlike the general approach of decrypting a message using a private key), validate that the digital signature was signed (or encrypted) by the private key. Furthermore, the terms “deposit”, “deposits”, “depositing”, and the like, when referring to digital assets from a first entity to a second entity, may include, but is not limited to, a transferring of digital assets from the first entity to the second entity with an agreement that the second entity will, upon receiving a withdrawal request from the first entity, transfer such digital assets back to the first entity along with any mutually agreed upon accrued interest. It is to be understood in the present disclosure that one or more elements and/or aspects of example embodiments may include and/or be implement, in part or in whole, solely and/or in cooperation with other elements, using networking technologies, cloud computing, artificial intelligence, machine learning, deep learning, and/or one or more forms of distributed ledger technology (or “DLT”) (e.g., blockchain).

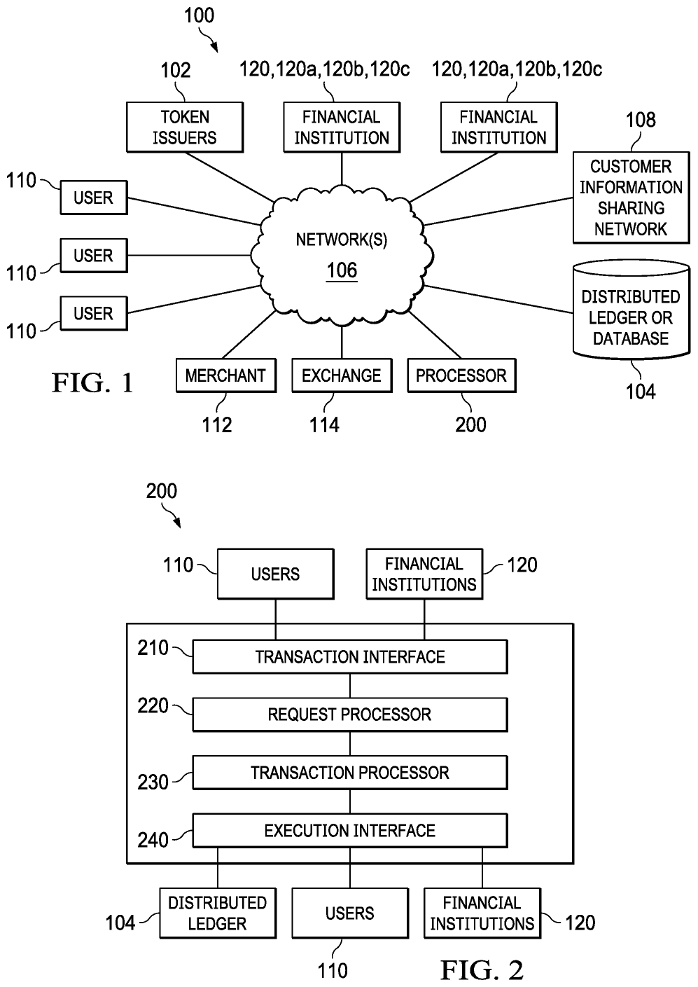

Example embodiments will now be described below with reference to the accompanying FIGS. 1-9, which form a part of the present disclosure.

### Example Embodiments of a System for Managing Digital Assets (e.g., System 100)

As an overview, an example embodiment of a system (e.g., system 100) for managing digital assets is illustrated in FIG. 1. The system 100 is configurable or configured to perform one or more of a plurality of functions, operations, actions, methods, and/or processes, including those described in the present disclosure. As a non-limiting example, the system 100 is configurable or configured to generate, manage, process, and/or configure one or a plurality of different types/forms of digital assets.

The system 100 includes and/or communicates with a plurality of users 110. One or more of the users 110 may own and/or hold digital assets managed and/or manageable by the system 100. The system 100 also includes and/or communicates with one or more merchants 112, which may include retailers, e-retailers, users 110, and/or any entity offering products and/or services in exchange for payment. The system 100 may also include and/or communicate with one or more digital asset exchanges 114. The system 100 also includes and/or communicates with one or more token issuers 102. The system 100 also includes and/or communicates with one or more financial institutions 120. Such financial institutions 120 include designated financial institutions 120b (e.g., financial institutions who may accept digital asset deposits from users 110; as further described in the present disclosure), main financial institutions 120a (e.g., financial institutions who may cooperate with designated financial institutions 120b to enable such designated financial institution 120b to accept digital asset deposits from users 110 by providing, for example, liquidity in the form of fiat currencies to the designated financial institutions 120b; as further described in the present disclosure), and/or current financial institutions 120c (e.g., financial institutions that have already reviewed and/or onboarded a user as a customer of the financial institution, which may include one or more existing or current financial institutions of a user; as further described in the present disclosure). Each financial institution 120 may provide, among other things, products and/or services to users 110, other financial institutions 120, merchants 112, and/or digital asset exchanges 114, including, but not limited to, fiat currency deposits in traditional financial or bank accounts (e.g., interest-bearing savings account, interest-bearing checking account, etc.), digital asset deposits (e.g., in a similar, substantially the same, and/or equivalent manner as interest-bearing deposits of fiat currency in traditional financial or bank accounts), term deposits of digital assets (e.g., transferrable term deposits from one user to another user, including situations when a user who holds a term deposit wishes to perform an early withdrawal of the term deposit, in which case, example embodiments may enable another user to take over such term deposit), fiat currency withdrawals from traditional financial or bank accounts, digital asset withdrawals (e.g., in a similar, substantially the same, and/or equivalent manner as withdrawals of fiat currency from traditional interest-bearing financial or bank accounts), sharing of anonymized and/or semi-anonymized customer information (e.g., between financial institutions and/or other entities, including between a current financial institution 120c and a designated financial institution 120b, between a current financial institution 120c and a main financial institution 120a, between a main financial institution 120a and a designated financial institution 120b, between a financial institution 120a, 120b, 120c and a token issuer 102, between a financial institution 120a, 120b, 120c and a merchant 112, between a financial institution 120a, 120b, 120c and an exchange 114, etc. The system 100 includes and/or communicates with one or more distributed ledgers 104 (e.g., blockchain 104), databases 104, or the like. The system 100 may include and/or communicate with one or more networks 106, communication channels 106, or the like. The system 100 also includes and/or communicates with one or more customer information sharing networks 108, or the like. The system 100 includes one or more processors (e.g., processor 200), or the like. The processor 200 is configurable or configured to connect to and/or communicate with one or more users 110, one or more token issuers 102, one or more financial institutions 120, one or more merchants 112, one or more exchanges 114, one or more distributed ledgers 104 (e.g., blockchain 104) and/or databases 104, one or more networks 106, and one or more customer information sharing networks 108. Although the figures illustrate the system 100 as having one processor 200, it is to be understood that the system 100 may include more than one processor 200 without departing from the teachings of the present disclosure.

As used in the present disclosure, when applicable, a reference to a system (e.g., system 100) and/or processor (e.g., processor 200) may also refer to, apply to, and/or include a computing device, processor, server, system, cloud-based computing, or the like, and/or functionality of a processor, computing device, server, system, cloud-based computing, or the like. The system 100 and/or processor 200 (and/or its elements, as described in the present disclosure) may be any processor, server, system, device, computing device, controller, microprocessor, microcontroller, microchip, semiconductor device, or the like, configurable or configured to perform, among other things, a processing and/or managing of information, data communications, hashing of information, encryption and decryption of information, creating digital signatures, and/or other actions described above and in the present disclosure. Alternatively or in addition, the system 100 and/or processor 200 (and/or its elements, as described in the present disclosure) may include and/or be a part of a virtual machine, software, processor, computer, node, instance, host, or machine, including those in a networked computing environment. As used in the present disclosure, a network and/or cloud may be a collection of devices connected by communication channels that facilitate communications between devices and allow for devices to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof. A network or cloud may include, but is not limited to, computing grid systems, peer to peer systems, mesh-type systems, distributed computing environments, cloud computing environment, etc. Such network or cloud may include hardware and software infrastructures configured to form a virtual organization comprised of multiple resources which may be in geographically disperse locations. Network may also refer to a communication medium between processes on the same device. Also as referred to herein, a network element, node, or server may be a device deployed to execute a program operating as a socket listener and may include software instances.

In an example embodiment, when the processor 200 processes a digital asset purchase request (e.g., a request to purchase stablecoins) from a user 110 to purchase digital assets (e.g., a first amount of digital assets) and performs an issuance of digital assets to the user 110 in exchange for fiat currency (e.g., a first amount of fiat currency) from the user 110, information pertaining to the purchase of the digital assets by the user 110 may be recorded, stored, and/or made available (e.g., made available, in an anonymized or semi-anonymized manner, to financial institutions 120 and/or other entities who are members of an example embodiment of a customer information sharing network 108; and/or recorded and/or stored in or on a distributed ledger 104).

In another example embodiment, when the processor 200 processes a digital asset deposit request from a user 110 to deposit digital assets (e.g., a first amount of digital assets) with a designated financial institution 120b, a transfer of the digital assets from the user 110 to the designated financial institution 120b, a transfer of the digital assets (e.g., the first amount of digital assets) from the designated financial institution 120b to a main financial institution 120a in exchange for a deposit of fiat currency (e.g., a first amount of fiat currency) by the main financial institution 120a with the designated financial institution 120b (e.g., to provide liquidity to the designated financial institution 120b; as further described in the present disclosure), and/or a deposit of fiat currency (e.g., the first amount of fiat currency) by the main financial institution 120a with the designated financial institution 120b in exchange for the transfer of the digital assets (e.g., the first amount of digital assets) from the designated financial institution 120b to the main financial institution 120a (e.g., to provide liquidity to the designated financial institution 120b; as further described in the present disclosure) may be recorded, stored, and/or made available (e.g., made available, in an anonymized or semi-anonymized manner, to financial institutions 120 and/or other entities who are members of an example embodiment of a customer information sharing network 108; and/or recorded and/or stored in or on a distributed ledger 104).

As another example embodiment, when the processor 200 processes a digital asset withdrawal request from a user 110 to withdraw, from a designated financial institution 120b, digital assets (e.g., a second amount of digital assets) that were previously deposited by the user 110 with the designated financial institution 120b, a transfer of the digital assets (e.g., the second amount of digital assets) from a main financial institution 120a to the designated financial institution 120b in exchange for a return of fiat currency (e.g., a second amount of fiat currency) that was previously deposited, by the main financial institution 120a, with the designated financial institution 120b (e.g., as part of processing a digital asset deposit request, as described above and in the present disclosure), a transfer of fiat currency (e.g., the second amount of fiat currency) from the designated financial institution 120b back to the main financial institution 120a in exchange for the transfer of the digital assets (e.g., the second amount of digital assets) back from the main financial institution 120a to the designated financial institution 120b (as further described in the present disclosure), and a transfer of the digital assets (e.g., the second amount of digital assets) from the designated financial institution 120 to the user 110 may be recorded, stored, and/or made available (e.g., made available, in an anonymized or semi-anonymized manner, to financial institutions 120 and/or other entities who are members of an example embodiment of a customer information sharing network 108; and/or recorded and/or stored in or on a distributed ledger 104).

These and other elements of the system 100 will now be further described with reference to the accompanying figures.

The Processor (e.g., Processor 200).

FIGS. 2-5 illustrate example embodiments of the processor (e.g., processor 200). The processor 200 is configurable or configured to manage digital assets, including, but not limited to, managing of digital asset issuance and/or generation; managing of digital asset deposits, including interest-bearing deposits of digital assets; managing of withdrawals of deposited digital assets, including payment of corresponding interest accrued from the deposit of such digital assets; managing of interest-bearing term deposits, including fixed term and flexible term deposits, transferring or taking over, as between users/customers, of term deposits, and interest-bearing term deposits of digital assets; managing of withdrawals of term deposits, including withdrawals of digital assets deposited in term deposits, and corresponding interest accrued from such term deposits; managing of early or pre-term withdrawals of digital assets deposited in term deposits, and corresponding interest accrued from the early withdrawal of such term deposits; managing of transfers or take overs, by users, of term deposits of digital assets from other users who wish to perform early withdrawal of such term deposits; and managing of customer information sharing networks, or the like, for enabling financial institutions and other organizations to share anonymized or semi-anonymized customer information, including customer onboarding information, know-your-client (KYC) information, etc., among each other.

Example embodiments of the processor 200 may include one or more transaction interfaces (e.g., transaction interfaces 210). The transaction interface 210 is configurable or configured to communicate with one or more elements of the system 100, including those described in the present disclosure and/or illustrated in the Figures.

The processor 200 may also include one or more request processors (e.g., request processor 220). Alternatively or in addition, the processor 200 may be configurable or configured to perform one or more functions or actions of one or more request processors 220. Alternatively or in addition, the processor 200 may include one or more transaction processors (e.g., transaction processor 230). Alternatively or in addition, the processor 200 may be configurable or configured to perform one or more functions or actions of one or more transaction processors 230. Alternatively or in addition, the processor 200 may include one or more execution interfaces (e.g., execution interfaces 240). Alternatively or in addition, the processor 200 may be configurable or configured to perform one or more functions or actions of one or more execution interfaces 240.

Although FIGS. 2-5 may illustrate one transaction interface 210, one request processor 220, one transaction processor 230, and one execution interface 240, it is to be understood that the processor 200 may include more or less than one transaction interface 210, more or less than one request processor 220, more or less than one transaction processor 230, and/or more or less than one execution interface 240 without departing from the teachings of the present disclosure. It is also to be understood in the present disclosure that, although the functions and/or processes performed by the processor 200 are described in the present disclosure as being performed by particular elements of the processor 200, the functions and/or processes performed by a particular element of the processor 200 may also be performed by one or more other elements and/or cooperatively performed by more than one element of the processor 200 without departing from the teachings of the present disclosure. It is also to be understood in the present disclosure that, although the functions and/or processes performed by the processor 200 are described in the present disclosure as being performed by particular elements of the processor 200, the functions and/or processes performed by two or more particular elements of the processor 200 may be combined and performed by one element of the processor 200 without departing from the teachings of the present disclosure.

These elements of the processor 200 will now be further described with reference to the accompanying figures.

The Transaction Interface (e.g., Transaction Interface 210).

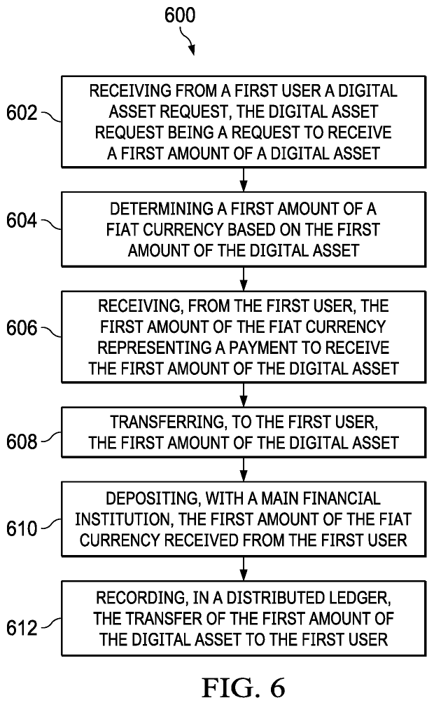

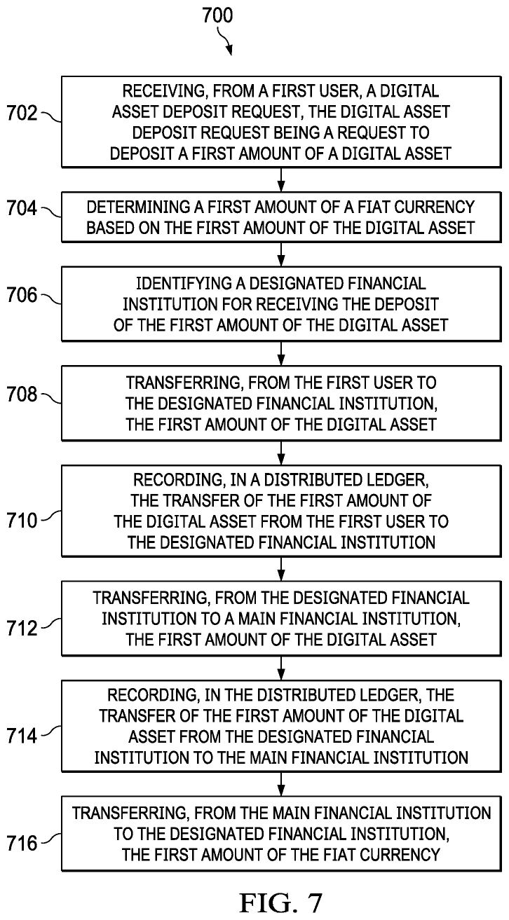

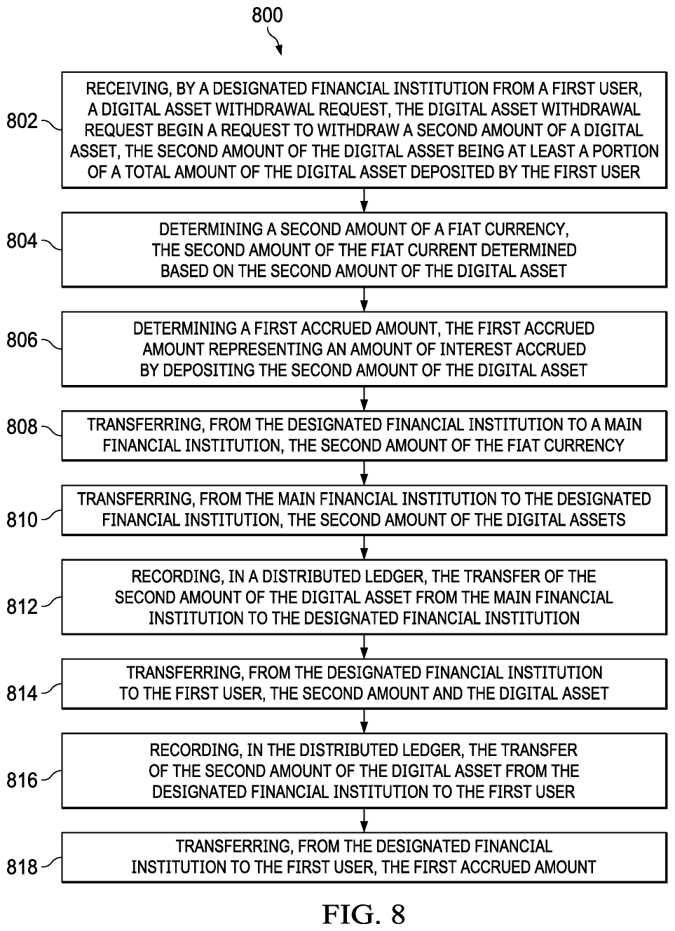

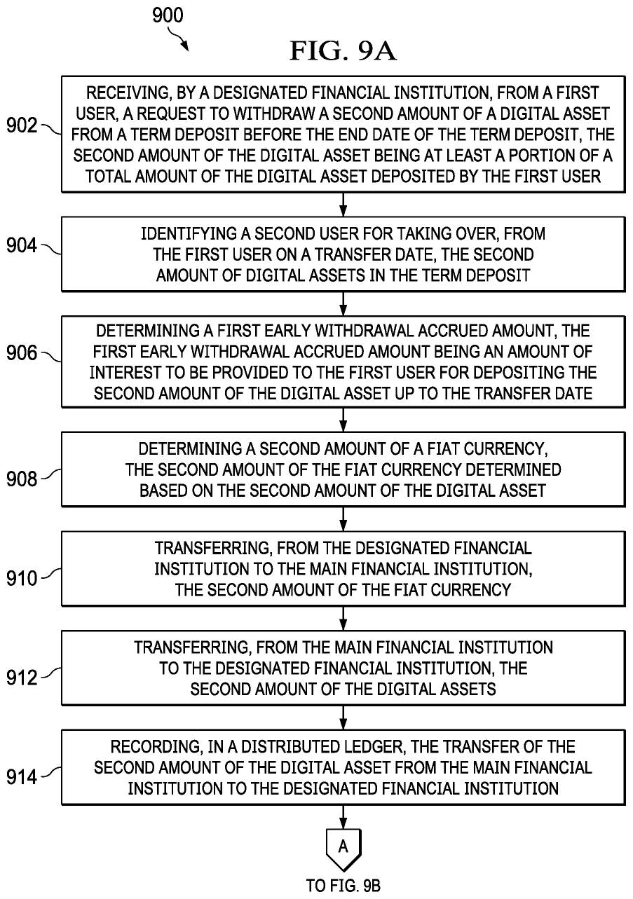

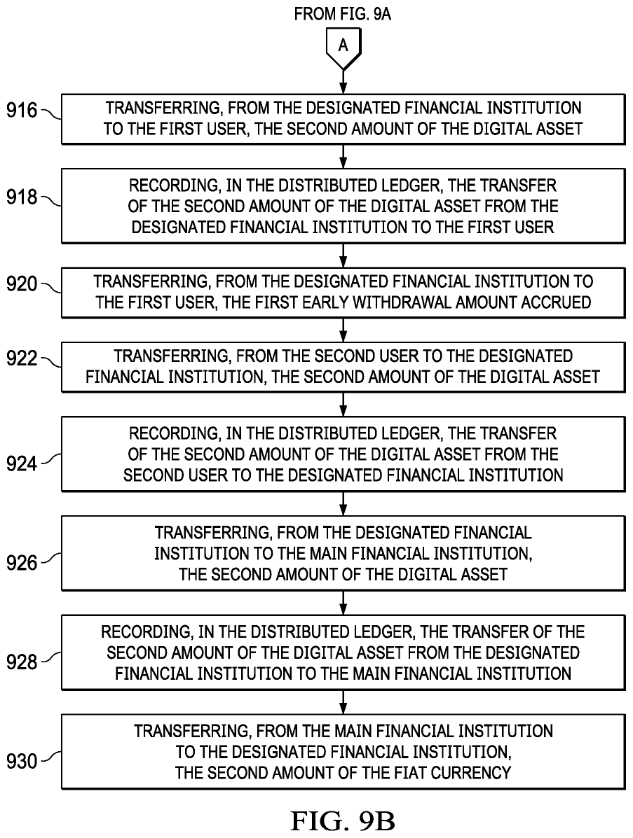

Example embodiments of the processor 200 include one or more transaction interfaces (e.g., transaction interfaces 210). As illustrated in FIG. 2, the transaction interface 210 is configurable or configured to communicate with one or more users 110. The transaction interface 210 is also configurable or configured to communicate with one or more financial institutions 120. For example, the transaction interface 210 may receive digital asset requests (e.g., action 602 in FIG. 6; as further described in the present disclosure) from users 110, financial institutions 120, token issuers 102, merchants 112, and/or exchanges 114. The transaction interface 210 may also receive digital asset deposit requests, including digital asset term deposit requests (e.g., action 702 in FIG. 7; as further described in the present disclosure), from users 110, financial institutions 120, token issuers 102, merchants 112, and/or exchanges 114. The transaction interface 210 may also receive digital asset withdrawal requests (e.g., action 802 in FIG. 8; as further described in the present disclosure) from users 110, financial institutions 120, token issuers 102, merchants 112, and/or exchanges 114. The transaction interface 210 may also receive requests to perform early withdrawal of digital assets from term deposits (e.g., action 902 in FIG. 9; as further described in the present disclosure) from users 110, financial institutions 120, token issuers 102, merchants 112, and/or exchanges 114. The transaction interface 210 may also receive customer information sharing requests (as further described in the present disclosure) from financial institutions 120, token issuers 102, merchants 112, and/or exchanges 114.

The transaction interface 210 is configurable or configured to communicate with one or more other processors 200. The transaction interface 210 is be configurable or configured to communicate with one or more merchants 112. The transaction interface 210 is also configurable or configured to communicate with one or more exchanges 114. The transaction interface 210 is also configurable or configured to communicate with one or more token issuers 102. The transaction interface 210 is also configurable or configured to communicate with one or more distributed ledgers 104 and/or databases 104. The transaction interface 210 is also configurable or configured to communicate with one or more customer information sharing networks 108. The transaction interface 210 is also configurable or configured to communicate with one or more the above via one or more networks 106.

When the transaction interface 210 receives communications (e.g., requests, including those described in the present disclosure) from one or more users 110, one or more financial institutions 120, and/or one or more of the other entities and/or elements described above and in the present disclosure, the transaction interface 210 is configurable or configured to selectively communicate information received with one or more other elements of the processor 200. For example, the transaction interface 210 may be configurable or configured to communicate with the request processor 220. In some embodiments, the transaction interface 210 may also be configurable or configured to communicate with the transaction processor 230, the execution processor 240, and/or the request processor 220, transaction processor 230, and/or execution processor 240 of other processors 200.

The Request Processor (e.g., Request Processor 220).

In an example embodiment, the processor 200 includes one or more request processors (e.g., request processors 220) for performing, among other things, checks and/or verifications of requests received by the processor 200 from, for, or on behalf of users 110, financial institutions 120, merchants 112, exchanges 114, token issuers 102, other elements of the processor 200, and/or other processors 200.

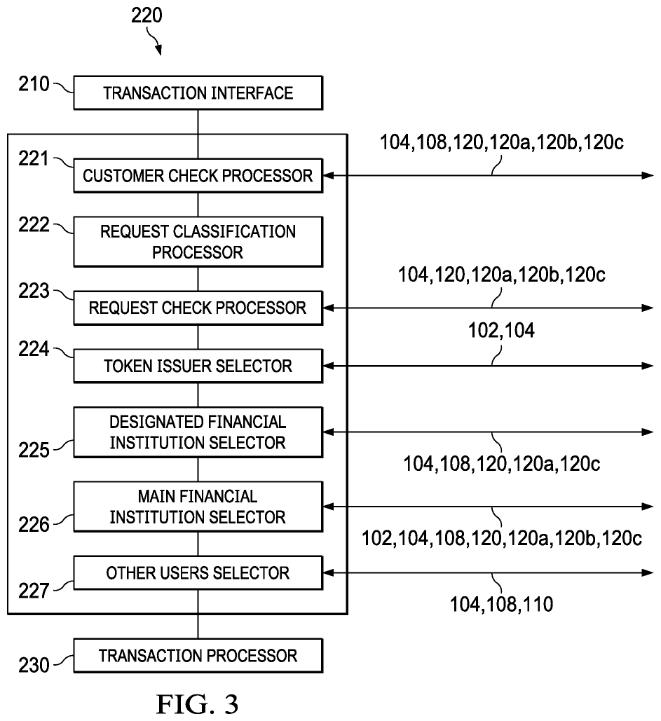

The request processor 220 includes one or more elements for performing the processing of the various different checks and/or verifications of requests received by the processor 200. As illustrated in FIG. 3, the request processor 220 may include one or more customer check processors (e.g., customer check processor 221). The customer check processor 221 may perform, among other things, checks, verifications, queries, reviews, and/or research on potential new customers (e.g., onboarding checks, KYC checks, etc.) and/or existing customers (e.g., updated checks, top-up checks, etc.), including checks via the customer information sharing network 108, the distributed ledger 104, and/or financial institutions 120. The request processor 220 may include one or more request classification processors (e.g., request classification processor 222). As will be further described in the present disclosure, the request classification processor 222 may perform, among other things, an identification, classification, and/or categorization of requests received by the processor 200. For example, the request classification processor 222 may classify a request as a digital asset issuance request, digital asset deposit request, digital asset withdrawal request, digital asset term deposit request, digital asset term deposit withdrawal request, request for early withdrawal of digital asset from term deposit, customer information sharing request, etc. The request processor 220 may include one or more request check processors (e.g., request check processor 223). As will be further described in the present disclosure, the request check processor 223 may perform, among other things, a check on the validity of requests received by the processor (e.g., check via distributed ledger 104 to confirm that a user in fact owns the digital assets that the user wants to deposit, etc.). The request processor 220 may include one or more token issuer selectors (e.g., a token issuer selector 224). As will be further described in the present disclosure, the token issuer selector 224 may perform, among other things, a selection of a token issuer 102 to perform issuance of new digital assets in exchange for fiat currency and/or other digital assets. For example, the token issuer selector 224 may select, from among a plurality of token issuers 102, a token issuer 102 each time a digital asset request (or request to purchase digital assets) is received. The request processor 220 may include one or more designated financial institution selectors (e.g., designated financial institution selector 225). As will be further described in the present disclosure, the designated financial institution selector 225 may perform, among other things, a selection of a designated financial institution 120b to perform a deposit (and/or withdrawal) of digital assets. For example, the designated financial institution selector 225 may select, from among a plurality of financial institutions 120, a designated financial institution 120b each time a digital asset deposit request is received. The request processor 220 may include one or more main financial institution selectors (e.g., main financial institution selector 226). As will be further described in the present disclosure, the main financial institution selector 226 may perform, among other things, a selection of a main financial institution 120a. The main financial institution 120a may be a financial institution who will provide liquidity (e.g., in fiat currency and/or other digital assets) to a designated financial institution 120b in exchange for receiving digital assets that the designated financial institution 120b received from a depositing user 110. For example, the main financial institution selector 226 may select, from among a plurality of financial institutions 120, a main financial institution 120a each time a digital asset deposit request is received. The request processor 220 may include one or more other users selectors (e.g., other users selector 227). As will be further described in the present disclosure, the other users selector 227 may perform, among other things, a selection of one or more users 110 who will take over term deposits from other users 110 who wish to perform early withdrawals of their term deposits. For example, the other users selector 227 may select, from among a plurality of users 110, a user 110 to take over a term deposit from another user 110 each time a request for early withdrawal of a term deposit is received.

Although FIG. 3 may illustrate one customer check processor 221, one request classification processor 222, one request check processor 223, one token issuer selector 224, one designated financial institution selector 225, one main financial institution selector 226, and one other users selector 227, it is to be understood that the request processor 220 may include more or less than one customer check processor 221, more or less than one request classification processor 222, more or less than one request check processor 223, more or less than one token issuer selector 224, more or less than one designated financial institution selector 225, more or less than one main financial institution selector 226, and/or more or less than one other users selector 227 without departing from the teachings of the present disclosure. It is also to be understood in the present disclosure that, although the functions and/or processes performed by the request processor 220 are described in the present disclosure as being performed by particular elements of the request processor 220, the functions and/or processes performed by a particular element of the request processor 220 may also be performed by one or more other elements and/or cooperatively performed by more than one element of the request processor 220 without departing from the teachings of the present disclosure. It is also to be understood in the present disclosure that, although the functions and/or processes performed by the request processor 220 are described in the present disclosure as being performed by particular elements of the request processor 220, the functions and/or processes performed by two or more particular elements of the request processor 220 may be combined and performed by one element of the request processor 220 without departing from the teachings of the present disclosure.

These elements of the request processor 220 will now be further described with reference to the accompanying figures.

The Customer Check Processor (e.g., Customer Check Processor 221).

In an example embodiment, the request processor 220 includes one or more customer check processors (e.g., customer check processor 221). The customer check processor 221 is configurable or configured to perform checks, verifications, queries, reviews, and/or research on users, including potential new customers (e.g., onboarding or intake checks, KYC checks, credit checks, etc.) and/or existing customers (e.g., status checks, updated checks, top-up checks, etc.). Such checks, verifications, queries, reviews, and/or research may be performed via and/or in cooperation with the customer information sharing network 108, the distributed ledger 104, and/or other financial institutions 120.

For example, when a first financial institution 120, 120b receives a request to deposit digital assets (e.g., receives directly from a user 110, via selection by a processor 120, via selection by a processor 120 of the first financial institution 120, 120b, or via selection by a processor 120 of another financial institution 120, etc.), the processor 120 may perform a processing of the digital asset deposit request. In performing the processing, the customer check processor 221 may first check whether or not the user 110 is an existing customer of the first financial institution 120, 120b and/or whether or not the first financial institution 120, 120b has previously performed a new customer check for the user 110 (e.g., onboarding or intake checks, KYC checks, credit checks, etc.). If the user 110 is an existing customer of the first financial institution 120, 120b and/or if a new customer check was previously performed for the user 110, the customer check processor 221 may return a confirmation, approval, or the like that the digital asset deposit request may proceed to one or more other elements of the request processor 220 for further processing, such as the request classification processor 222, the request check processor 223, etc. If, on the other hand, the user 110 is not an existing customer of the first financial institution 120, 120b and a new customer check was not previously performed for the user 110, the customer check processor 221 may be configurable or configured to perform a new customer check for the user 110. The new customer check performed by the customer check processor 221 may be a full customer check, such as a conventional KYC check, onboarding or intake check, credit check, etc. Alternatively, example embodiments of the customer check processor 221 may perform the new customer check by performing an abbreviated or shortened new customer intake or review process. Such abbreviated or shortened new customer intake or review process may include, rely on, be based on, leverage, and/or take advantage of new customer checks (and/or existing customer information) for the user 110 that were previously performed by (and/or already in possession of) one or more other financial institutions 120 (e.g., a known, recognized, and/or reputable financial institution; a participating or member financial institution of the customer information sharing network 108; a financial institution who shares, anonymously or semi-anonymously, as further described below and in the present disclosure, customer information on the distributed ledger 104 and/or customer information sharing network 108; etc.). For example, the customer check processor 221 may communicate with the customer information sharing network 108 and/or a distributed ledger 104 to determine whether or not such other financial institution(s) 120 (e.g., a known, recognized, and/or reputable financial institution; a participating or member financial institution of the customer information sharing network 108; a financial institution who shares, anonymously or semi-anonymously, as further described below and in the present disclosure, customer information on the distributed ledger 104 and/or customer information sharing network 108; etc.) have previously performed a new customer check on the user 110 (which may be full onboarding or intake checks, KYC checks, credit checks, etc.) and/or whether or not the user 110 is an existing customer of such other financial institution(s) 120. In a situation where the customer check processor 221 confirms via the customer information sharing network 108 and/or the distributed ledger 104 that existing information regarding the user 110 is available (e.g., results of a previously performed new customer check by another financial institution 120, information indicating that the user 110 is an existing customer of another financial institution 120, etc.), the customer check processor 221 may request for such existing information about the user 110 and/or accept such existing information in replacement of performing a full customer check on the user 110. For example, if the customer check processor 221 is performing, for a first financial institution 120b, a new customer check for a digital asset deposit request from a first user 110 and confirms from information shared on the customer information sharing network 108 and/or the distributed ledger 104 that the first user 110 is an existing customer in good standing (and/or any other information that may be shared, including minimum or average balances, banking history, credit rating, etc.) of a second financial institution 120 and/or that a new customer check was previously performed for the first user 110 by the second financial institution 120, the customer check processor 221 may return a confirmation that the first financial institution 120b may proceed to accept the first user's 110 digital asset deposit request based on the shared information, which may be subject to other processing by the processor 200 (e.g., processing by one or more other elements of the request processor 220, such as the request classification processor 222, the request check processor 223, etc.). As another example, if the customer check processor 221 is performing, for a first financial institution 120a, a new customer check for a digital asset deposit request from a second user 110 and is unable to confirm from the customer information sharing network 108 and/or the distributed ledger 104 that the second user 110 is an existing customer in good standing (and/or any other information that may be shared, including minimum or average balances, banking history, credit rating, etc.) and/or that a new customer check was previously performed for the second user 110 by a second financial institution 120, the customer check processor 221 may require that the first financial institution 120b and/or the customer check processor 221 perform additional new customer checks (i.e., the abbreviated or shortened new customer intake process is not sufficient) before accepting the second user's 110 digital asset deposit request.

It is recognized in the present disclosure that making available and/or sharing between financial institutions 120 of certain customer and/or financial information, including providing identities of customers 110 along with new customer check results. KYC check results, financial histories, credit ratings, etc., may not be desired and/or may be in violation of certain laws, rules, and/or regulations. In this regard, example embodiments may be configurable to transform, replace, map, anonymize, hash, encrypt, and/or the like (hereinafter “transform”) the identities and/or identity information of users/customers 110 prior to making any corresponding information (e.g., new customer check results, KYC checks, financial histories, credit ratings, etc.) available on or to customer information sharing networks 108, distributed ledgers 104, financial institutions 120, merchants 112, token issuers 102, and/or exchanges 114. For example, a second financial institution 120 may transform, via hashing using a known hashing algorithm (e.g., SHA-256), identity information of a customer (e.g., the first user) of the second financial institution. Identity information of a user/customer 110 may include, for example, the full name, passport number, national ID numbers, drivers license numbers, etc. of the user/customer 110. The second financial institution 120 may then share and/or make available such transformed customer identity information of the first user 110 along with corresponding customer information of the first user 110 (e.g., new customer check results, KYC checks, financial histories, credit ratings, etc.) on or via customer information sharing networks 108 and/or distributed ledgers 104. In such an example, a first financial institution 120b who receives a digital asset deposit request from the first user 110 (who is not an existing customer of the first financial institution 120b) may, using a known hashing algorithm (e.g., SHA-256), hash the identity information of the first user 110 and use such hashed customer identity information to perform the abbreviated or shortened new customer intake process (e.g., by using the hashed customer identity information to search for a matching hashed customer identity information in or on the customer information sharing network 108 and/or distributed ledger 104; or to check with other financial institutions 120 using the hashed customer identity information). Alternatively, an example embodiment may provide additional security, anonymity, and/or confidentiality by not requiring the first user 110 to disclose his/her identity information to the first financial institution 120b. For example, the first user 110 may provide only his/her transformed/hashed customer identity information (instead of providing his/her customer identity information for the first financial institution to perform the hashing) in or along with the digital asset deposit request, in which case the first financial institution 120b can then take such transformed/hashed customer identity information to search the customer information sharing network 108 and/or distributed ledger 104. It is to be understood in the present disclosure that the transforming of the customer identity information may be performed in other ways, including assigning of a unique sequence of characters to each customer/user, encrypting using a known encryption algorithm, etc., without departing from the teachings of the present disclosure.

The Request Classification Processor (e.g., Request Classification Processor 222).

In an example embodiment, the request processor 220 includes one or more request classification processors (e.g., request classification processor 222). The request classification processor 222 is configurable or configured to receive requests from users 110, financial institutions 120, etc. (e.g., via the transaction interface 210). The request classification processor 222 may be configurable or configured to perform, among other things, an identification, classification, grouping, and/or categorization of each request. In example embodiments, the request classification processor 222 may classify a request received from a user 110 as being a digital asset request, digital asset issuance request, and/or request to purchase digital assets when the request is a request to receive digital assets in exchange for fiat currency (and/or other digital assets). The request classification processor 222 may classify a request from a user 110 to a financial institution 120 as being a digital asset deposit request when the request is a request to transfer digital assets from the user 110 to the financial institution 120b under a mutual agreement that the financial institution 120b will, upon receiving a withdrawal request from the user 110, transfer such digital assets back to the user 110 along with any mutually agreed upon accrued interest. The request classification processor 222 may classify a request from a user 110 to a financial institution 120b as being a digital asset withdrawal request when the request is a request to transfer digital assets back from the financial institution 120b to the user 110 along with any mutually agreed upon accrued interest. The request classification processor 222 may classify a request from a user 110 to a financial institution 120b as being a digital asset term deposit when the request is a request to transfer digital assets from the user 110 to the financial institution 120b under a mutual agreement that the financial institution 120b will, after a mutually agreed upon end date and/or upon receiving a withdrawal request from the user 110, transfer such digital assets back to the user 110 along with any mutually agreed upon accrued interest. The request classification processor 222 may classify a request from a user 110 to a financial institution 120b as being a request for withdrawal of digital assets from a term deposit when the request is a request to transfer, after a mutually agreed upon end date, digital assets back from the financial institution to the user along with any mutually agreed upon accrued interest. The request classification processor 222 may classify a request from a user 110 to a financial institution 120b as being a request for early withdrawal of digital assets from a term deposit when the request is a request to transfer, prior to a mutually agreed upon end date, digital assets back from the financial institution 120b to the user 110 along with any mutually agreed upon early withdrawal accrued interest. The request classification processor 222 may classify a request from a first financial institution 120 to a second financial institution 120 (e.g., via the customer information sharing network 108 and/or the distributed ledger 104) as being a request to share customer information when the request is a request to share more information pertaining to a transformed customer identity information.

The Request Check Processor (e.g., Request Check Processor 223).

In an example embodiment, the request processor 220 includes one or more request check processors (e.g., request check processor 223). The request check processor 223 is configurable or configured to perform checks on the requests received by the processor 200. For example, the request check processor 223 may perform checks via the distributed ledger 104 to confirm that a user 110 in fact own the digital assets that the user 110 is requesting to deposit with a financial institution 120b.

The Token Issuer Selector (e.g., Token Issuer Selector 224).

In an example embodiment, the request processor 220 includes one or more token issuer selectors (e.g., token issuer selector 224). The token issuer selector 224 is configurable or configured to cooperate with, among other elements, the request classification processor 222 to select one or more token issuers 102. Specifically, when the request classification processor 222 classifies a request from a user 110 as being a digital asset request, digital asset issuance request, and/or request to purchase digital assets, the token issuer selector 224 may be configurable or configured to select a token issuer 102 to perform the issuance and/or transfer of the requested digital assets to the user in exchange for payment in fiat currency and/or other digital assets. As will be further described in the present disclosure, when the user 110 pays fiat currency to the token issuer 102 for the digital assets, the processor 102 (e.g., the digital asset generator 232, as further described in the present disclosure) may be configurable or configured to deposit the fiat currency with a financial institution 120a. In example embodiments, the processor 102 (e.g., the digital asset generator 232, as further described in the present disclosure) may also be configurable or configured to create a record of the issuance and/or transfer of digital assets to the user 110 in the distributed ledger 104. The processor 102 may also be configurable or configured to share or make available, via or on the customer information sharing network 108 and/or distributed ledger 104, information pertaining to the user 110 receiving the issuance of the digital assets.

The token issuer selector 224 is configurable or configured to select the token issuer 102 from among a plurality of token issuers 102 based on one or more criterion. For example, the token issuer 102 may be selected based on whether or not the user 110 has previously purchased digital assets from the token issuer 102. As another example, the token issuer 102 may be selected based on whether or not the token issuer 102 is a participant or member of a customer information sharing network 108. As another example, the token issuer 102 may be selected based on whether or not the token issuer 102 shares or makes available customer information on the distributed ledger 104. As another example, the token issuer 102 may be selected based on whether or not the token issuer 102 and a current financial institution 120c (i.e., an existing financial institution of the user 110) are participants or members of the same customer information sharing network 108. As another example, the token issuer 102 may be selected based on whether or not the token issuer 102 and a current financial institution 120c (i.e., an existing financial institution of the user 110) share or make available customer information on the same distributed ledger 104.

The Designated Financial Institution Selector (e.g., Designated Financial Institution Selector 225).

In an example embodiment, the request processor 220 includes one or more designated financial institution selectors (e.g., designated financial institution selector 225). The designated financial institution selector 225 is configurable or configured to cooperate with, among other elements, the request classification processor 222 to select one or more designated financial institutions 120b. Specifically, when the request classification processor 222 classifies a request from a user 110 as being a digital asset deposit request or digital asset term deposit request, the designated financial institution selector 225 may be configurable or configured to select, from among a plurality of financial institutions 120, a designated financial institution 120b to be the financial institution that receives the digital asset deposit from the user 110. It is to be understood that if the digital asset deposit request is sent directly to a particular designated financial institution 120b (or a processor 120 of a particular designated financial institution 120b) and/or if the digital asset deposit request stipulates or indicates a particular designated financial institution 120b, the designated financial institution selector 225 may not select, from among a plurality of financial institutions 120, a designated financial institution 120b since one has already been selected by the user 110.

The designated financial institution selector 225 is configurable or configured to select the designated financial institution 120b from among a plurality of financial institutions 120 based on one or more criterion. For example, the designated financial institution 120b may be selected based on interest rate(s) offered for digital asset deposits (e.g., whichever financial institution offers the highest interest rate). As another example, the designated financial institution 120b may be selected based on whether or not the user 110 is an existing customer of the designated financial institution 120b (which reduces or eliminates the need to perform new customer checks). As another example, the designated financial institution 120b may be selected based on whether or not the designated financial institution 120b is a participant or member of a customer information sharing network 108. As another example, the designated financial institution 120b may be selected based on whether or not the designated financial institution 120b shares or makes available customer information on the distributed ledger 104. As another example, the designated financial institution 120b may be selected based on whether or not the designated financial institution 120b and a current financial institution 120c (i.e., an existing financial institution of the user 110) are participants or members of the same customer information sharing network 108. As another example, the designated financial institution 120b may be selected based on whether or not the designated financial institution 120b and a current financial institution 120c (i.e., an existing financial institution of the user 110) share or make available customer information on the same distributed ledger 104.

The Main Financial Institution Selector (e.g., Main Financial Institution Selector 226).

In an example embodiment, the request processor 220 includes one or more main financial institution selectors (e.g., main financial institution selector 226). The main financial institution selector 226 is configurable or configured to cooperate with, among other elements, the request classification processor 222 to select one or more main financial institutions 120a. Specifically, when the request classification processor 222 classifies a request from a user 110 as being a digital asset deposit request or digital asset term deposit request, the main financial institution selector 226 may be configurable or configured to select, from among a plurality of financial institutions 120, a main financial institution 120a. The main financial institution 120a may be the financial institution who provides liquidity (e.g., in fiat currency and/or other digital assets) to the designated financial institution 120b (i.e., the financial institution that is receiving a digital asset deposit from the user 110).

The main financial institution selector 226 is configurable or configured to select the main financial institution 120a from among a plurality of financial institutions 120 based on one or more criterion. For example, the main financial institution 120a may be selected based on whether or not the user 110 is an existing customer of the main financial institution 120a (which reduces or eliminates the need to perform new customer checks). As another example, the main financial institution 120a may be selected based on whether or not the main financial institution 120a is a participant or member of a customer information sharing network 108. As another example, the main financial institution 120a may be selected based on whether or not the main financial institution 120a shares or makes available customer information on the distributed ledger 104. As another example, the main financial institution 120a may be selected based on whether or not the main financial institution 120a and a current financial institution 120c (i.e., an existing financial institution of the user 110) are participants or members of the same customer information sharing network 108. As another example, the main financial institution 120a may be selected based on whether or not the main financial institution 120a and a current financial institution 120c (i.e., an existing financial institution of the user 110) share or make available customer information on the same distributed ledger 104.

The Other Users Selector (e.g., Other Users Selector 227).

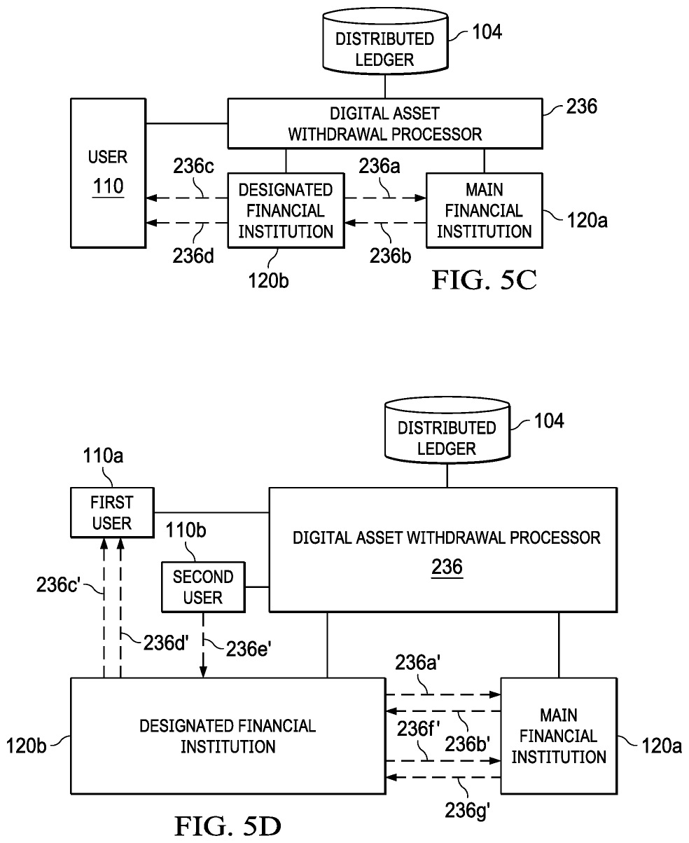

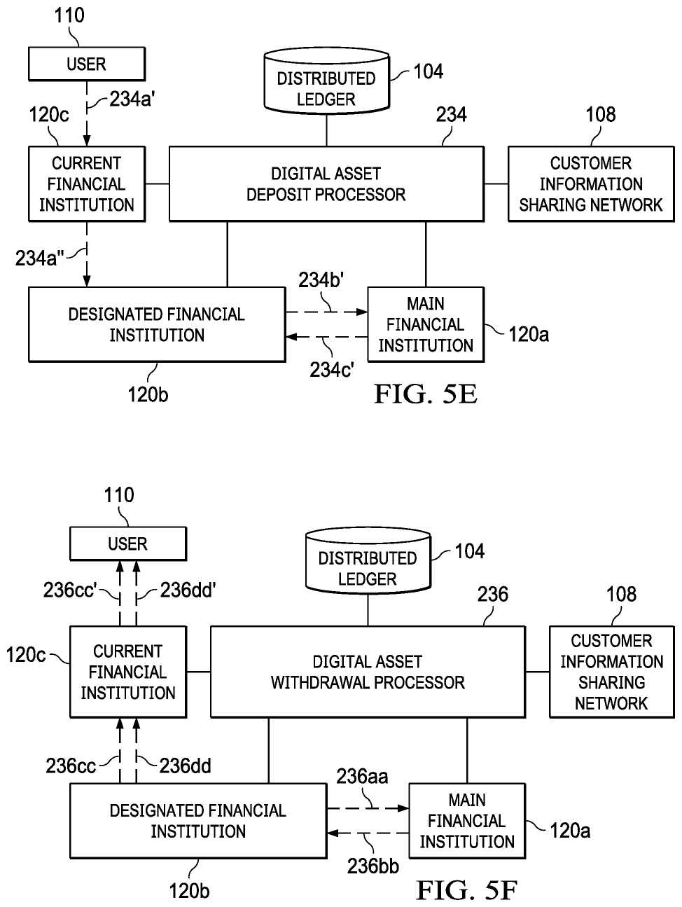

In an example embodiment, the request processor 220 includes one or more other users selectors (e.g., other users selector 227). The other users selector 227 is configurable or configured to cooperate with, among other elements, the request classification processor 222 to select one or more users 110. Specifically, when the request classification processor 222 classifies a request from a first user (e.g., user 110a, as illustrated in FIG. 5D) as being a request to perform early withdrawal of a digital asset term deposit, the other users selector 227 may be configurable or configured to select, from among a plurality of users 110, a second user (e.g., user 110b, as illustrated in FIG. 5D) who will take over a term deposit from the first user 110a (who wishes to perform an early withdrawal of his/her term deposit).

The other users selector 227 is configurable or configured to select the second user 110b (i.e., the user who will take over the term deposit) from among a plurality of users based on one or more criterion. For example, the second user 110b (who will take over the term deposit) may be selected based on historical and/or predicted/forecasted information regarding the second user 110b. Such historical and/or predicted/forecasted information may include, but is not limited to, whether or not the second user 110b is willing or expected to accept the interest accrued for the remainder of a term deposit. As another example, the second user 110b (who will take over the term deposit) may be selected based on whether or not the second user 110b is an existing customer of the designated financial institution 120b who is holding the term deposit for the first user 110a (which reduces or eliminates the need to perform new customer checks). As another example, the second user 110b (who will take over the term deposit) may be selected based on whether or not the second user 110b is an existing customer of the main financial institution 120a who is providing liquidity to the designated financial institution 120b for the term deposit (which reduces or eliminates the need to perform new customer checks). As another example, the second user 110b (who will take over the term deposit) may be selected based on whether or not the designated financial institution 120b who is holding the term deposit for the first user 110a and a current financial institution 120c (i.e., existing financial institution of the second user 110b) are participants or members of the same customer information sharing network 108. As another example, the second user 110b (who will take over the term deposit) may be selected based on whether or not the designated financial institution 120b who is holding the term deposit for the first user 110a and a current financial institution 120c (i.e., existing financial institution of the second user 110) share or make available customer information on the same distributed ledger 104.

The Transaction Processor (e.g., Transaction Processor 230).

In an example embodiment, the processor 200 includes one or more transaction processors (e.g., transaction processors 230) for performing, among other things, processing of transaction requests received from users 110, financial institutions 120, token issuers 102, merchants 112, exchanges 114, and/or customer information sharing networks 108.

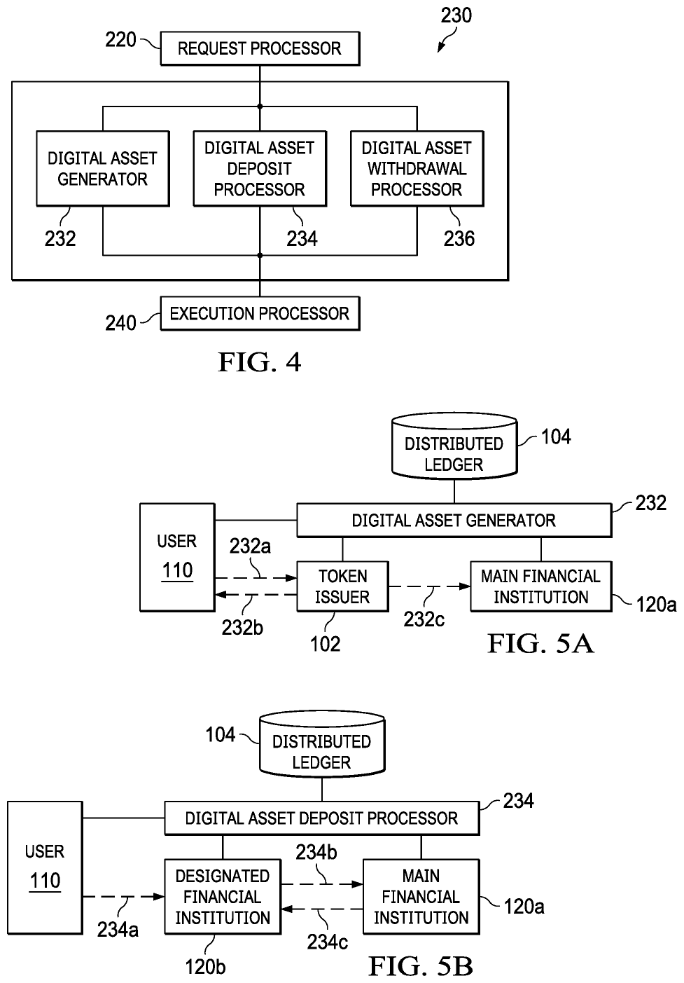

The transaction processor 230 includes one or more elements for performing the processing of the various different types or forms of requests received by the processor 200. As illustrated in FIG. 4, the transaction processor 230 may include one or more digital asset generator processors (e.g., digital asset generator processor 232). The digital asset generator processor 232 may perform, among other things, generation, issuance, and/or transfer of digital assets to token issuers 102, users 110, financial institutions 120, merchants 112, and/or exchanges 114. The transaction processor 230 may include one or more digital asset deposit processors (e.g., digital asset deposit processor 234). As will be further described in the present disclosure, the digital asset deposit processor 234 may process, among other things, a deposit of digital assets by a user 110 (or another financial institution 120 or a merchant 112 or an exchange 114) with a financial institution 120b. For example, the digital asset deposit processor 234 may process interest-bearing deposits of digital assets, interest-bearing deposits of fiat currencies, interest-bearing term deposits of digital assets, and/or interest-bearing term deposits of fiat currencies. The transaction processor 230 may include one or more digital asset withdrawal processors (e.g., digital asset withdrawal processor 236). As will be further described in the present disclosure, the digital asset withdrawal processor 236 may process, among other things, a withdrawal of digital assets by a user 110 (or another financial institution 120 or a merchant 112 or an exchange 114) from a financial institution 120b. For example, the digital asset withdrawal processor 236 may process withdrawals of interest-bearing deposits of digital assets, withdrawals of interest-bearing deposits of fiat currencies, withdrawals of interest-bearing term deposits of digital assets, early withdrawals of interest-bearing term deposits of digital assets, transfers or take-overs of existing interest-bearing term deposits of digital assets, and/or withdrawals of interest-bearing term deposits of fiat currencies.

Although FIGS. 4-5 may illustrate one digital asset generator 232, one digital asset deposit processor 234, and one digital asset withdrawal processor 236, it is to be understood that the transaction processor 230 may include more or less than one digital asset generator 232, more or less than one digital asset deposit processor 234, and/or more or less than one digital asset withdrawal processor 236 without departing from the teachings of the present disclosure. It is also to be understood in the present disclosure that, although the functions and/or processes performed by the transaction processor 230 are described in the present disclosure as being performed by particular elements of the transaction processor 230, the functions and/or processes performed by a particular element of the transaction processor 230 may also be performed by one or more other elements and/or cooperatively performed by more than one element of the transaction processor 230 without departing from the teachings of the present disclosure. It is also to be understood in the present disclosure that, although the functions and/or processes performed by the transaction processor 230 are described in the present disclosure as being performed by particular elements of the transaction processor 230, the functions and/or processes performed by two or more particular elements of the transaction processor 230 may be combined and performed by one element of the transaction processor 230 without departing from the teachings of the present disclosure.

These elements of the transaction processor 230 will now be further described with reference to the accompanying figures.

The Digital Asset Generator Processor (e.g., Digital Asset Generator Processor 232).

In an example embodiment, the transaction processor 230 includes one or more digital asset generator processors (e.g., digital asset generator processors 232). The digital asset generator processor 232 is configurable or configured to process digital asset requests, digital asset issuance requests, and/or requests to purchase digital assets. Such requests may be received from users 110 and/or other entities who wish to purchase digital assets, including financial institutions 120, merchants 112, exchanges 114, and/or token issuers 102. The digital asset generator processor 232 may process digital asset requests, digital asset issuance requests, and/or requests to purchase digital assets by cooperating with one or more other elements of the processor 200. For example, the digital asset generator processor 232 may receive processing results from the customer check processor 221 (including checks on the user who sent the request, as described in the present disclosure), the request classification processor 222 (including a classification that the request is for the purchase of digital assets, as described in the present disclosure), the request check processor 223 (including a confirmation that the request is a valid request, as described in the present disclosure), and/or the token issuer selector 224 (including a selection of a token issuer 102 to issue the digital assets to the user 110, as described in the present disclosure).

When a request is received by the processor 200 (either directly, via a designated financial institution 120b, via a main financial institution 120a, via a current financial institution 120c, or via a processor 200 of one of these financial institutions 120) from a user 110 (or other entity who wishes to purchase digital assets, including financial institutions 120, merchants 112, exchanges 114, or token issuers 102), the customer check processor 221 may perform a check on the user 110 (as described in the present disclosure). The request classification processor 222 may classify the request as being a digital asset request, digital asset issuance request, and/or request to purchase digital assets (as described in the present disclosure). The request check processor 223 may check to confirm the validity of the request (e.g., whether the user has sufficient fiat currency to purchase the requested digital assets, etc.). The token issuer selector 224 may select a token issuer 102 to issue the requested digital assets (e.g., a first amount of digital assets) to the user 110 (as described in the present disclosure). The main financial institution selector 226 may select a main financial institution 120a to receive fiat currency paid by the user 110 to the main financial institution 120a (as described in the present disclosure). The designated financial institution selector 225 may select one or more designated financial institutions 120b for receiving deposits of such issued digital assets.

In an example embodiment, the digital asset generator processor 232 may be configurable or configured to determine a first amount of fiat currency. The first amount of fiat currency may be and/or include an amount of fiat currency the user 110 is required to pay for the first amount of digital assets the user 110 has requested to purchase (which may or may not include other fees or charges, such as service charges, commissions, etc.). Put differently, the first amount of fiat currency may be based on and/or calculated from the first amount of digital assets the user 110 has requested to purchase. For example, if the digital assets being purchased are stablecoins that are pegged to the US Dollar, the first amount of fiat currency for a request to purchase 100 such stablecoins may be USD 100. In such an example, the first amount of fiat currency may also be a value equivalent of USD 100 in another fiat currency (e.g., Singapore Dollar, Japanese Yen, etc.). In some implementations, the first amount of fiat currency may be more (or less) than USD 100, such as in situations where a commission, service charge, etc. is applied and/or in situations where a promotion, sale, or reduction is applied.

As illustrated in FIG. 5A, the digital asset generator processor 232 may process a transfer of the first amount of fiat currency from the user 110 to the token issuer 102, as represented by the arrow 232a. Such transfer may represent a payment of the first amount of fiat currency for the purchase of the first amount of digital assets made by the user to the token issuer. The digital asset generator processor 232 may process a transfer of the first amount of digital assets (as requested in the digital asset request, digital asset issuance request, and/or request to purchase digital assets) from the token issuer 102 to the user 110, as represented by the arrow 232b. Such transfer may represent an issuance of the first amount of digital assets made by the token issuer to the user. The digital asset generator processor 232 may process a transfer (or deposit) of the first amount of fiat currency from the token issuer 102 to the main financial institution 120a, as represented by the arrow 232c. Such transfer may represent a deposit of the first amount of fiat currency by the token issuer 102 with the main financial institution 120a. In some example embodiments, instead of a transfer of the first amount of fiat currency from the user 110 to the token issuer 102 followed by a transfer of the first amount of fiat currency from the token issuer 102 to the main financial institution 120a, a single transfer of the first amount of fiat currency from the user 110 to a bank account of the token issuer 102 in the main financial institution 120a may be performed without departing from the teachings of the present disclosure.

The digital asset generator processor 232 may process a recording, in the distributed ledger 104, of the transfer of the first amount of digital assets to the user 110 (which may be considered as a new generation or issuance of digital assets to the user 110 and/or a transfer of digital assets from the token issuer 102 to the user 110). Such record may represent the issuance of the first amount of digital assets made to the user. The digital asset generator processor 232 may process a recording, in the distributed ledger 104 or other database 104, of the transfer of the first amount of fiat currency from the user 110 to the token issuer 102. Such record may represent a payment of the first amount of fiat currency for the purchase of the first amount of digital assets made by user to the token issuer. The digital asset generator processor 232 may process a sharing or making available of information pertaining to such completed or processed digital asset request, digital asset issuance request, and/or request to purchase digital assets in or on the customer information sharing network 108 and/or distributed ledger 104.

The Digital Asset Deposit Processor (e.g., Digital Asset Deposit Processor 234).

In an example embodiment, the transaction processor 230 includes one or more digital asset deposit processors (e.g., digital asset deposit processors 234). The digital asset deposit processor 234 is configurable or configured to process digital asset deposit requests, digital asset term deposit requests, fiat currency deposit requests, and/or fiat currency term deposit requests from users 110 (and/or other entities who wish to perform an interest-bearing deposit or term deposit of digital assets and/or fiat currencies, including financial institutions 120, merchants 112, exchanges 114, and/or token issuers 102). The digital asset deposit processor 234 may process digital asset deposit requests and digital asset term deposit requests by cooperating with one or more other elements of the processor 200. For example, the digital asset deposit processor 234 may receive processing results from the customer check processor 221 (including checks on the user who sent the request, as described in the present disclosure), the request classification processor 222 (including a classification that the request is for depositing digital assets and/or fiat currencies, as described in the present disclosure), the request check processor 223 (including a confirmation that the request is a valid request, as described in the present disclosure), the designated financial institution selector 225 (including a selection of a designated financial institution 120b to receive the deposit of digital assets, as described in the present disclosure), the main financial institution selector 226 (including a selection of a main financial institution 120a to provide liquidity to the designated financial institution 120b, as described in the present disclosure), and/or the other users selector 227 (including a selection of users 110 to take over term deposits of other users 110, as described in the present disclosure).

When a request is received by the processor 200 (either directly, via a designated financial institution 120b, via a main financial institution 120a, via a current financial institution 120c, or via a processor 200 of one of these financial institutions 120) from a user 110 (or other entity who wishes to perform an interest-bearing deposit or term deposit of digital assets and/or fiat currencies, including financial institutions 120, merchants 112, exchanges 114, or token issuers 102), the customer check processor 221 may perform a check on the user 110 (as described in the present disclosure). The request classification processor 222 may classify the request as being a digital asset deposit request, digital asset term deposit request, fiat currency deposit requests, and/or fiat currency term deposit requests (as described in the present disclosure). The request check processor 223 may check to confirm the validity of the request (e.g., whether the user has sufficient digital assets and/or fiat currency to make such deposit, etc.). The designated financial institution selector 225 may select one or more designated financial institutions 120b to receive the deposit of the digital assets (e.g., a first amount of digital assets) from the user 110 (as described in the present disclosure). The main financial institution selector 226 may select one or more main financial institutions 120a to cooperate with the designated financial institution 120b for the deposit, which may include providing liquidity (e.g., a first amount of fiat currency, other amount of fiat currency, other digital assets, credit, and/or other forms of value) to the designated financial institution 120b in exchange for receiving the first amount of digital assets deposited by the user 110 (as described in the present disclosure). In example embodiments, such an exchange between the designated financial institution 120b and the main financial institution 120a (and corresponding exchange back of the liquidity (e.g., the first amount of fiat currency) and the first amount of digital assets between the designated financial institution 120b and the main financial institution 120a for a digital asset withdrawal process, as further described for the digital asset withdrawal processor 236 and in the present disclosure) may be understood as, equivalent to, similar to, performed as, having similar or the same effect as, and/or analogous to a buy-back arrangement, or the like, in which the transfer of the first amount of digital assets (as deposited by the user 110) by the designated financial institution 120b to the main financial institution 120a (which also represents taking out the digital assets from circulation) in exchange for liquidity (e.g., the first amount of fiat currency) (as further described in the next paragraph and in the present disclosure; which may also be other forms of digital assets) includes an agreement or promise by the parties that, when the designated financial institution 120b receives a digital asset withdrawal request from the user 110 to withdraw some or all of the first amount of digital assets, the designated financial institution 120b will transfer fiat currency (such amount of fiat currency corresponding to or based on the amount of digital assets being withdrawn; for example, a second amount of digital assets being withdrawn, which is at least a portion of the first amount of digital assets previously deposited, may correspond to a second amount of fiat currency) to the main financial institution 120a and the main financial institution 120a will transfer digital assets (e.g., the second amount of digital assets) back to the designated financial institution 120b. It is recognized in the present disclosure that the receiving of the first amount of fiat currency by the designated financial institution 120b as part of a digital asset deposit provides liquidity to the designated financial institution 120b. In some embodiments, such transfer of the first amount of fiat currency may also be understood as, equivalent to, similar to, performed as, having similar or the same effect as, and/or analogous to a deposit of the first amount of fiat currency into an interest-bearing financial account (e.g., a conventional checking or savings account), and the interest accrued and/or considered to be accrued by such deposit may be used by the designated financial institution 120b to pay the user 110 for interest accrued by the deposit of the first amount of digital assets.

In an example embodiment, the digital asset deposit processor 234 may be configurable or configured to determine a first amount of fiat currency. The first amount of fiat currency may be the amount of fiat currency the main financial institution 120a is required to transfer to the designated financial institution 120b in exchange for receiving the first amount of digital assets deposited by the user 110 (which may or may not include other fees or charges, such as service charges, commissions, etc.). Put differently, the first amount of fiat currency may be based on and/or calculated from the first amount of digital assets deposited by the user 110 (or the amount of digital assets transferred from the designated financial institution 120b to the main financial institution, if different from the first amount of digital assets). For example, if the digital assets being deposited by the user 110 are stablecoins that are pegged to the US Dollar, the first amount of fiat currency for a request to deposit 100 such stablecoins may be USD 100. In such an example, the first amount of fiat currency may also be a value equivalent of USD 100 in another fiat currency (e.g., Singapore Dollar, Japanese Yen, etc.). In some implementations, the first amount of fiat currency may be more (or less) than USD 100, such as in situations where a commission, service charge, etc. is applied and/or in situations where a promotion, sale, or reduction is applied.

FIG. 5B illustrates an example embodiment of processing a digital asset deposit request and/or digital asset term deposit request. The digital asset deposit processor 234 may process a transfer of the first amount of digital assets from the user 110 to the designated financial institution 120b, as represented by the arrow 234a. Such transfer may represent the deposit of the first amount of digital assets made by the user 110 with the designated financial institution 120b. The digital asset deposit processor 234 may process a transfer of the first amount of digital assets from the designated financial institution 120b to the main financial institution 120a, as represented by the arrow 234b. Such transfer may represent the transfer of the first amount of digital assets from the designated financial institution 120b to the main financial institution 120a (and/or a deposit of the first amount of digital assets by the designated financial institution 120b with the main financial institution 120a) in exchange for a deposit of the first amount of fiat currency by the main financial institution 120a with the designated financial institution 120b (and/or in exchange for a transfer of the first amount of fiat currency from the main financial institution 120a to the designated financial institution 120b). The digital asset deposit processor 234 may process a transfer of the first amount of fiat currency from the main financial institution 120a to the designated financial institution 120b, as represented by the arrow 234c. Such transfer may represent the transfer of the first amount of fiat currency from the main financial institution 120a to the designated financial institution 120b (and/or a deposit of the first amount of fiat currency by the main financial institution 120a with the designated financial institution 120b) in exchange for a transfer of the first amount of digital assets from the designated financial institution 120b to the main financial institution 120a (and/or in exchange for a deposit of the first amount of digital assets by the designated financial institution 120b with the main financial institution 120a). In some example embodiments, instead of a transfer of the first amount of digital assets from the user 110 to the designated financial institution 120b followed by a transfer of the first amount of digital assets from the designated financial institution 120b to the main financial institution 120a, a single transfer of the first amount of digital assets from the user 110 to the main financial institution 120a may be performed without departing from the teachings of the present disclosure.

The digital asset deposit processor 234 may process a recording, in the distributed ledger 104, of the transfer of the first amount of digital assets from the user 110 to the designated financial institution 120b. Such record may represent the deposit of the first amount of digital assets made by the user 110 with the designated financial institution 120b. The digital asset deposit processor 234 may process a recording, in the distributed ledger 104, of the transfer of the first amount of digital assets from the designated financial institution 120b to the main financial institution 120a. Such record may represent the transfer of the first amount of digital assets from the designated financial institution 120b to the main financial institution 120a (and/or a deposit of the first amount of digital assets by the designated financial institution 120b with the main financial institution 120a) in exchange for a deposit of the first amount of fiat currency by the main financial institution 120a with the designated financial institution 120b (and/or in exchange for a transfer of the first amount of fiat currency from the main financial institution 120a to the designated financial institution 120b). The digital asset deposit processor 234 may process a recording, in the distributed ledger 104 or other database 104, of the transfer of the first amount of fiat currency from the main financial institution 120a to the designated financial institution 120b. Such record may represent the transfer of the first amount of fiat currency from the main financial institution 120a to the designated financial institution 120b (and/or a deposit of the first amount of fiat currency by the main financial institution 120a with the designated financial institution 120b) in exchange for a transfer of the first amount of digital assets from the designated financial institution 120b to the main financial institution 120a (and/or in exchange for a deposit of the first amount of digital assets by the designated financial institution 120b with the main financial institution 120a). The digital asset deposit processor 234 may process a recording, in the distributed ledger 104 or other database 104, of one or more terms, conditions, requirements, arrangements, interest rate(s), relevant date(s), etc. of the deposit of the first amount of digital assets by the user 110 with the designated financial institution 120b, the transfer(s) of the first amount of digital assets, and/or the transfer(s) of the first amount of fiat currency. In example embodiments where the digital asset deposit processor 234 processes digital asset term deposits, the digital asset deposit processor 234 may process a recording, in the distributed ledger 104 or other database 104, of one or more terms, conditions, requirements, arrangements, interest rate(s), start date, end date, other relevant dates (e.g., early withdrawal dates and corresponding interest accrued), etc. of the term deposit, the transfer(s) of the first amount of digital assets, and/or the transfer(s) of the first amount of fiat currency. The digital asset deposit processor 234 may process a sharing or making available of information pertaining to such completed or processed digital asset deposit request or digital asset term deposit request in or on the customer information sharing network 108 and/or distributed ledger 104.

FIG. 5E illustrates an example embodiment of processing a digital asset deposit by a user 110 with a designated financial institution 120b via a current financial institution 120c. Such an embodiment may arise in situations where the designated financial institution 120b offers a better interest rate than the current financial institution 120c and the user 110 is an existing customer of the current financial institution 120c but not an existing customer of the designated financial institution 120b (and the designated financial institution 120b has not previously performed a new customer check (as described in the present disclosure) for the user 110). In such situations, one option may be for the user 110 to directly contact the designated financial institution 120b to make the digital asset deposit. For such an option, the designated financial institution 120b may be required to perform a full new customer check (e.g., new customer onboarding or intake check, KYC, anti-money laundering or AML check, credit check, etc.). As another option, an example embodiment of the digital asset deposit processor 234 may process a transfer of the first amount of digital assets from the user 110 to the current financial institution 120c, as represented by the arrow 234a′. Such transfer may represent the deposit of the first amount of digital assets made by the user 110 with the current financial institution 120c. The digital asset deposit processor 234 may process a transfer of the first amount of digital assets from the current financial institution 120c to the designated financial institution 120b, as represented by the arrow 234a″. Such transfer may represent the deposit of the first amount of digital assets made by the current financial institution 120c with the designated financial institution 120b. In example embodiments, such transfer may represent the deposit of the first amount of digital assets made by the current financial institution 120c on behalf of the user 110 with the designated financial institution 120b. For such a transfer, an example embodiment of the digital asset deposit processor 234 may cooperate with the customer information sharing network 108 and/or the distributed ledger 104 to process a sharing or making available of the current financial institution's 120c customer information for the user 110 to the designated financial institution 120b (as described in the present disclosure). It is recognized in the present disclosure that such sharing or making available of customer information may enable the designated financial institution 120b to perform an abbreviated or shortened new customer intake or review process (as described in the present disclosure) instead of a full new customer check (e.g., new customer onboarding or intake check, KYC, anti-money laundering or AML, check, credit check, etc.). The digital asset deposit processor 234 may process a transfer of the first amount of digital assets from the designated financial institution 120b to the main financial institution 120a, as represented by the arrow 234b′. Such transfer may represent the transfer of the first amount of digital assets from the designated financial institution 120b to the main financial institution 120a (and/or a deposit of the first amount of digital assets by the designated financial institution 120b with the main financial institution 120a) in exchange for a deposit of the first amount of fiat currency by the main financial institution 120a with the designated financial institution 120b (and/or in exchange for a transfer of the first amount of fiat currency from the main financial institution 120a to the designated financial institution 120b). The digital asset deposit processor 234 may process a transfer of the first amount of fiat currency from the main financial institution 120a to the designated financial institution 120b, as represented by the arrow 234c′. Such transfer may represent the transfer of the first amount of fiat currency from the main financial institution 120a to the designated financial institution 120b (and/or a deposit of the first amount of fiat currency by the main financial institution 120a with the designated financial institution 120b) in exchange for a transfer of the first amount of digital assets from the designated financial institution 120b to the main financial institution 120a (and/or in exchange for a deposit of the first amount of digital assets by the designated financial institution 120b with the main financial institution 120a). In some example embodiments, instead of a transfer of the first amount of digital assets from the current financial institution 120c to the designated financial institution 120b followed by a transfer of the first amount of digital assets from the designated financial institution 120b to the main financial institution 120a, a single transfer of the first amount of digital assets from the current financial institution 120c to the main financial institution 120a may be performed without departing from the teachings of the present disclosure.

The digital asset deposit processor 234 may process a recording, in the distributed ledger 104, of the transfer of the first amount of digital assets from the user 110 to the current financial institution 120c. Such record may represent the deposit of the first amount of digital assets made by the user 110 with the current financial institution 120c. The digital asset deposit processor 234 may process a recording, in the distributed ledger 104, of the transfer of the first amount of digital assets from the current financial institution 120c to the designated financial institution 120b. Such record may represent the deposit of the first amount of digital assets made by the current financial institution 120c with the designated financial institution 120b. In example embodiments, such record may represent the deposit of the first amount of digital assets made by the current financial institution 120c on behalf of the user 110 with the designated financial institution 120b. The digital asset deposit processor 234 may process a recording, in the distributed ledger 104, of the transfer of the first amount of digital assets from the designated financial institution 120b to the main financial institution 120a. Such record may represent the transfer of the first amount of digital assets from the designated financial institution 120b to the main financial institution 120a (and/or a deposit of the first amount of digital assets by the designated financial institution 120b with the main financial institution 120a) in exchange for a deposit of the first amount of fiat currency by the main financial institution 120a with the designated financial institution 120b (and/or in exchange for a transfer of the first amount of fiat currency from the main financial institution 120a to the designated financial institution 120b). The digital asset deposit processor 234 may process a recording, in the distributed ledger 104 or other database 104, of the transfer of the first amount of fiat currency from the main financial institution 120a to the designated financial institution 120b. Such record may represent the transfer of the first amount of fiat currency from the main financial institution 120a to the designated financial institution 120b (and/or a deposit of the first amount of fiat currency by the main financial institution 120a with the designated financial institution 120b) in exchange for a transfer of the first amount of digital assets from the designated financial institution 120b to the main financial institution 120a (and/or in exchange for a deposit of the first amount of digital assets by the designated financial institution 120b with the main financial institution 120a). The digital asset deposit processor 234 may process a recording, in the distributed ledger 104 or other database 104, of one or more terms, conditions, requirements, arrangements, interest rate(s), relevant date(s), etc. of the deposit of the first amount of digital assets by the user 110 with the current financial institution 120c, the deposit of the first amount of digital assets by the current financial institution 120c with the designated financial institution 120b, the transfer(s) of the first amount of digital assets, and/or the transfer(s) of the first amount of fiat currency. In example embodiments where the digital asset deposit processor 234 processes digital asset term deposits, the digital asset deposit processor 234 may process a recording, in the distributed ledger 104 or other database 104, of one or more terms, conditions, requirements, arrangements, interest rate(s), start date, end date, other relevant dates (e.g., early withdrawal dates and corresponding interest accrued), etc. of the term deposit, the transfer(s) of the first amount of digital assets, and/or the transfer(s) of the first amount of fiat currency. The digital asset deposit processor 234 may process a sharing or making available of information pertaining to such completed or processed digital asset deposit request or digital asset term deposit request in or on the customer information sharing network 108 and/or distributed ledger 104.

The Digital Asset Withdrawal Processor (e.g., Digital Asset Withdrawal Processor 236).

In an example embodiment, the transaction processor 230 includes one or more digital asset withdrawal processors (e.g., digital asset withdrawal processors 236). The digital asset withdrawal processor 236 is configurable or configured to process requests from users 110 (and/or other entities who wish to perform withdrawals of digital assets and/or fiat currencies, including financial institutions 120, merchants 112, exchanges 114, and/or token issuers 102), including digital asset withdrawal requests, requests to withdraw digital asset term deposits, requests for early withdrawal of digital asset term deposits, requests to transfer digital asset term deposits, fiat currency withdrawal requests, requests to withdraw fiat currency term deposits, requests for early withdrawal of fiat currency deposits, and/or requests to transfer fiat currency term deposit. The digital asset withdrawal processor 236 may process digital asset withdrawal requests, requests to withdraw digital asset term deposits, requests for early withdrawal of digital asset term deposits, requests to transfer digital asset term deposits, fiat currency withdrawal requests, requests to withdraw fiat currency term deposits, requests for early withdrawal of fiat currency deposits, and/or requests to transfer fiat currency term deposit by cooperating with one or more other elements of the processor 200. For example, the digital asset withdrawal processor 236 may receive processing results from the customer check processor 221 (including checks on the user who sent the request, as described in the present disclosure), the request classification processor 222 (including a classification that the request is for withdrawing digital assets and/or fiat currencies, as described in the present disclosure), the request check processor 223 (including a confirmation that the request is a valid request, as described in the present disclosure), the designated financial institution selector 225 (including a selection of a designated financial institution 120b to provide the withdrawal of digital assets, as described in the present disclosure), the main financial institution selector 226 (including a selection of a main financial institution 120a to cooperate with the designated financial institution 120b to perform the withdrawal, as described in the present disclosure), and/or the other users selector 227 (including a selection of users 110 to take over term deposits of other users 110, as described in the present disclosure).

When a request is received by the processor 200 (either directly, via a designated financial institution 120b, via a main financial institution 120a, via a current financial institution 120c, or via a processor 200 of one of these financial institutions 120) from a user 110 (or other entity who wishes to withdraw digital assets and/or fiat currencies, including financial institutions 120, merchants 112, exchanges 114, or token issuers 102), the customer check processor 221 may perform a check on the user 110 (as described in the present disclosure). The request classification processor 222 may classify the request as being a digital asset withdrawal request, request to withdraw digital asset term deposits, request for early withdrawal of digital asset term deposits, request to transfer digital asset term deposits, fiat currency withdrawal request, request to withdraw fiat currency term deposit, request for early withdrawal of fiat currency deposit, and/or request to transfer fiat currency term deposit (as described in the present disclosure). The request check processor 223 may check to confirm the validity of the request (e.g., whether the user has indeed deposited digital assets and/or fiat currency to make such withdrawal, etc.). The designated financial institution selector 225 may select one or more designated financial institutions 120b for providing the withdrawal of the digital assets (e.g., a second amount of digital assets, which is at least a portion of the first amount of digital assets previously deposited by the user 11). In example embodiments, the designated financial institution(s) 120b selected for the withdrawal may be or include those designated financial institution(s) that received and/or are holding the deposit for the user 110. The main financial institution selector 226 may select one or more main financial institutions 120a to cooperate with the designated financial institution 120b for the withdrawal, which may include providing the second amount of digital assets back to the designated financial institution 120b in exchange for a transfer back (or withdrawal) of liquidity (e.g., a second amount of fiat currency, other amount of fiat currency, other digital assets, credit, and/or other forms of value) provided to the designated financial institution 120b as part of a corresponding deposit request (as described in the present disclosure). In example embodiments, such an exchange back between the designated financial institution 120b and the main financial institution 120a may be understood as, equivalent to, similar to, performed as, having similar or the same effect as, and/or analogous to a buy-back arrangement, or the like. Such buy-back arrangement, or the like, may be one in which the transfer of the first amount of digital assets (as deposited by the user 110) by the designated financial institution 120b to the main financial institution 120a in exchange for liquidity (e.g., the first amount of fiat currency) (as described in the present disclosure) includes an agreement or promise by the parties that, when the designated financial institution 120b receives a digital asset withdrawal request from the user 110 to withdraw some or all of the first amount of digital assets (e.g., the second amount of digital assets, which is at least a portion of the first amount of digital assets), the designated financial institution 120b will transfer fiat currency (or other forms of liquidity) to the main financial institution 120a (such amount of fiat currency corresponding to or based on the amount of digital assets being withdrawn; for example, the second amount of digital assets may correspond to the second amount of fiat currency) and the main financial institution 120a will transfer digital assets (e.g., the second amount of digital assets) back to the designated financial institution 120b. In some embodiments, such transfer of the second amount of fiat currency may also be understood as, equivalent to, similar to, performed as, having similar or the same effect as, and/or analogous to a withdrawal of the second amount of fiat currency from an interest-bearing financial account (e.g., a conventional checking or savings account), and the interest accrued and/or considered to be accrued leading up to the withdrawal may be used by the designated financial institution 120b to pay the user 110 for interest accrued by the deposit of the second amount of digital assets.

In an example embodiment, the digital asset withdrawal processor 236 may be configurable or configured to determine a second amount of fiat currency. The second amount of fiat currency may be the amount of fiat currency the designated financial institution 120b is required to transfer back to the main financial institution 120a in exchange for receiving the second amount of digital assets being withdrawn by the user 110 (which may or may not include other fees or charges, such as service charges, commissions, etc.). Put differently, the second amount of fiat currency may be based on and/or calculated from the amount of digital assets being withdrawn by the user 110 (or the amount of digital assets transferred from the main financial institution 120a to the designated financial institution 120b, if different from the second amount of digital assets). For example, if the digital assets being withdrawn by the user 110 are stablecoins that are pegged to the US Dollar, the second amount of fiat currency for a request to withdraw 50 such stablecoins may be USD 50. In such an example, the second amount of fiat currency may also be a value equivalent of USD 50 in another fiat currency (e.g., Singapore Dollar, Japanese Yen, etc.). In some implementations, the second amount of fiat currency may be more (or less) than USD 50, such as in situations where a commission, service charge, etc. is applied and/or in situations where a promotion, sale, or reduction is applied.

FIG. 5C illustrates an example embodiment of processing a digital asset withdrawal request or request to withdraw a digital asset term deposit. The digital asset withdrawal processor 236 may process a transfer of the second amount of digital assets from the main financial institution 120a to the designated financial institution 120b, as represented by the arrow 236b. Such transfer may represent the transfer back of the second amount of digital assets from the main financial institution 120a to the designated financial institution 120b (and/or a withdrawal of the second amount of digital assets by the designated financial institution 120b from the main financial institution 120a) in exchange for a withdrawal of the second amount of fiat currency by the main financial institution 120a from the designated financial institution 120b (and/or in exchange for a transfer back of the second amount of fiat currency from the designated financial institution 120b to the main financial institution 120a). The digital asset withdrawal processor 236 may process a transfer of the second amount of fiat currency from the designated financial institution 120b to the main financial institution 120a, as represented by the arrow 236a. Such transfer may represent the transfer back of the second amount of fiat currency from the designated financial institution 120b to the main financial institution 120a (and/or a withdrawal of the second amount of fiat currency by the main financial institution 120a from the designated financial institution 120b) in exchange for a transfer back of the second amount of digital assets from the main financial institution 120a to the designated financial institution 120b (and/or in exchange for a withdrawal of the second amount of digital assets by the designated financial institution 120b from the main financial institution 120a). The digital asset withdrawal processor 236 may process a transfer of the second amount of digital assets from the designated financial institution 120b to the user 110, as represented by the arrow 236c. Such transfer may represent the withdrawal of the second amount of digital assets from the designated financial institution 120b by the user 110. The digital asset withdrawal processor 236 may process a transfer of a first amount of accrued interest from the designated financial institution 120b to the user 110, as represented by the arrow 236d. Such transfer may represent a payment, from the designated financial institution 120b to the user 110, of interest accrued as result of depositing the second amount of digital assets until the withdrawal. In some example embodiments, instead of a transfer of the second amount of digital assets from the main financial institution 120a to the designated financial institution 120b followed by a transfer of the second amount of digital assets from the designated financial institution 120b to the user 110, a single transfer of the second amount of digital assets from the main financial institution 120a to the user 110 may be performed without departing from the teachings of the present disclosure.

The digital asset withdrawal processor 236 may process a recording, in the distributed ledger 104, of the transfer of the second amount of digital assets from the main financial institution 120a to the designated financial institution 120b. Such record may represent the transfer back of the second amount of digital assets from the main financial institution 120a to the designated financial institution 120b (and/or a withdrawal of the second amount of digital assets by the designated financial institution 120b from the main financial institution 120a) in exchange for a withdrawal of the second amount of fiat currency by the main financial institution 120a from the designated financial institution 120b (and/or in exchange for a transfer back of the second amount of fiat currency from the designated financial institution 120b to the main financial institution 120a). The digital asset withdrawal processor 236 may process a recording, in the distributed ledger 104 or other database 104, of the transfer of the second amount of fiat currency from the designated financial institution 120b to the main financial institution 120a. Such record may represent the transfer back of the second amount of fiat currency from the designated financial institution 120b to the main financial institution 120a (and/or a withdrawal of the second amount of fiat currency by the main financial institution 120a from the designated financial institution 120b) in exchange for a transfer back of the second amount of digital assets from the main financial institution 120a to the designated financial institution 120b (and/or in exchange for a withdrawal of the second amount of digital assets by the designated financial institution 120b from the main financial institution 120a). The digital asset withdrawal processor 236 may process a recording, in the distributed ledger 104 or other database 104, of the transfer of the second amount of digital assets from the designated financial institution 120b to the user 110. Such record may represent the withdrawal of the second amount of digital assets from the designated financial institution 120b by the user 110. The digital asset withdrawal processor 236 may process a recording, in the distributed ledger 104 or other database 104, of the transfer of the first amount of accrued interest from the designated financial institution 120b to the user 110. Such record may represent the payment, by the designated financial institution 120b to the user 110, of the interest accrued as a result of depositing the second amount of digital assets until the withdrawal. The digital asset withdrawal processor 234 may process a recording, in the distributed ledger 104 or other database 104, of one or more terms, conditions, requirements, arrangements, interest rate(s), relevant date(s), etc. of the withdrawal of the second amount of digital assets by the user 110 from the designated financial institution 120b, the transfer(s) of the second amount of digital assets, the transfer(s) of the second amount of fiat currency, and/or the transfer(s) of the first amount of accrued interest. In example embodiments where the digital asset withdrawal processor 236 processes withdrawals of digital asset term deposits, the digital asset withdrawal processor 236 may process a recording, in the distributed ledger 104 or other database 104, of one or more terms, conditions, requirements, arrangements, interest rate(s), start date of the term deposit, end date of the term deposit, withdrawal date of the term deposit, other relevant dates (e.g., early withdrawal dates and corresponding interest accrued), etc., the transfer(s) of the first amount of digital assets, and/or the transfer(s) of the first amount of fiat currency. The digital asset withdrawal processor 236 may process a sharing or making available of information pertaining to such completed or processed digital asset withdrawal request in or on the customer information sharing network 108 and/or distributed ledger 104.

In example embodiments, the digital asset withdrawal processor 236 may be configurable or configured to process requests for early withdrawals of term deposits (including those for digital assets and/or fiat currency). For example, a first user 110a may have an existing term deposit with a designated financial institution 120b for a first amount of digital assets, and may wish to perform an early withdrawal of the term deposit. The term deposit may have a start date, an end date, and a first maximum accrued interest, which may be payable to the first user 110a if the first user 110a withdraws the first amount of digital assets on or after the end date of the term deposit. The term deposit may also have at least one first early withdrawal accrued interest, which may be payable to the first user 110a if the first user 110a performs an early withdrawal of the term deposit on or after a specific date (e.g., an early withdrawal date, which is a date after the start date of the term deposit and before the end date of the term deposit) and the digital asset withdrawal processor 236 is able to identify another user (e.g., a second user 110b) to take over the term deposit.

When the processor 200 receives, from the first user 110a, a request for early withdrawal of the digital asset term deposit (which may be for a second amount of digital assets, the second amount of digital assets being at least a portion of the first amount of digital assets deposited in the term deposit; of course, the request may also be for the entire term deposit, or the first amount of digital assets), the digital asset withdrawal processor 236 may search for (e.g., via posting on platforms, websites, mobile applications, bulletins, chat groups, emails, etc.), locate, and/or identify one or more other users (e.g., second users 110b) to take over such term deposit from the first user 110a. In an example embodiment, the digital asset withdrawal processor 236 may be configurable or configured to identify the second user 110b to take over, from the first user 110a on a transfer date, the portion of the term deposit that the first user 110a is withdrawing early (or the entire term deposit if the first user 110a is performing an early withdrawal of the entire term deposit, or the first amount of digital assets). In this regard, the term deposit for the second user 110b (or second term deposit) will have a start date being the transfer date, an end date being the same end date as the original term deposit for the first user 110a (or another date mutually agreed upon with the designated financial institution 120b), and a second maximum accrued interest payable to the second user 110b if the second user 110b withdraws the second amount of digital assets on or after the end date of the second term deposit. It is recognized that the second maximum accrued interest may be less than the first maximum accrued interest in the original term deposit. The second term deposit may also have at least one second early withdrawal accrued interest, which may be payable to the second user 110b if the second user 110b performs an early withdrawal of the second term deposit on or after a specific date (e.g., a second early withdrawal date, which is a date after the start date of the second term deposit and before the end date of the second term deposit) and the digital asset withdrawal processor 236 is able to identify another user (e.g., a third user (not shown)) to take over the second term deposit.

FIG. 5D illustrates an example embodiment of processing a request for early withdrawal of digital asset term deposits. In an example embodiment, the digital asset term deposit that is being early withdrawn may be the digital asset term deposit described in the present disclosure and illustrated in at least FIG. 5B. The digital asset withdrawal processor 236 may process a transfer of the second amount of digital assets from the main financial institution 120a to the designated financial institution 120b, as represented by the arrow 236b′. Such transfer may represent the transfer back of the second amount of digital assets from the main financial institution 120a to the designated financial institution 120b (and/or a withdrawal of the second amount of digital assets by the designated financial institution 120b from the main financial institution 120a) in exchange for a withdrawal of the second amount of fiat currency by the main financial institution 120a from the designated financial institution 120b (and/or in exchange for a transfer back of the second amount of fiat currency from the designated financial institution 120b to the main financial institution 120a). The digital asset withdrawal processor 236 may process a transfer of the second amount of fiat currency from the designated financial institution 120b to the main financial institution 120a, as represented by the arrow 236a′. Such transfer may represent the transfer back of the second amount of fiat currency from the designated financial institution 120b to the main financial institution 120a (and/or a withdrawal of the second amount of fiat currency by the main financial institution 120a from the designated financial institution 120b) in exchange for a transfer back of the second amount of digital assets from the main financial institution 120a to the designated financial institution 120b (and/or in exchange for a withdrawal of the second amount of digital assets by the designated financial institution 120b from the main financial institution 120a). The digital asset withdrawal processor 236 may process a transfer of the second amount of digital assets from the designated financial institution 120b to the first user 110a, as represented by the arrow 236c′. Such transfer may represent the early withdrawal from the term deposit of the second amount of digital assets from the designated financial institution 120b by the first user 110a. The digital asset withdrawal processor 236 may process a transfer of a first amount of accrued interest (e.g., the first early withdrawal accrued interest) from the designated financial institution 120b to the first user 110a, as represented by the arrow 236d′. Such transfer may represent a payment, from the designated financial institution 120b by the first user 110a, of interest accrued as result of depositing the second amount of digital assets until the early withdrawal (or transfer date). In some example embodiments, instead of a transfer of the second amount of digital assets from the main financial institution 120a to the designated financial institution 120b followed by a transfer of the second amount of digital assets from the designated financial institution 120b to the first user 110a, a single transfer of the second amount of digital assets from the main financial institution 120a to the first user 110a may be performed without departing from the teachings of the present disclosure. The digital asset withdrawal processor 236 (and/or the digital asset deposit processor 324) may process a transfer of the second amount of digital assets from the second user 110b to the designated financial institution 120b, as represented by the arrow 236e′. Such transfer may represent the deposit of the second amount of digital assets made by the second user 110b with the designated financial institution 120b. Such transfer may also represent a take over the term deposit from the first user 110a. Such transfer may also represent the second user 110b depositing into the second term deposit. The digital asset withdrawal processor 236 (and/or the digital asset deposit processor 234) may process a transfer of the second amount of digital assets from the designated financial institution 120b to the main financial institution 120a, as represented by the arrow 236f. Such transfer may represent the transfer of the second amount of digital assets from the designated financial institution 120b to the main financial institution 120a (and/or a deposit of the second amount of digital assets by the designated financial institution 120b with the main financial institution 120a) in exchange for a deposit of the second amount of fiat currency by the main financial institution 120a with the designated financial institution 120b (and/or in exchange for a transfer of the second amount of fiat currency from the main financial institution 120a to the designated financial institution 120b). The digital asset withdrawal processor 236 (and/or the digital asset deposit processor 234) may process a transfer of the second amount of fiat currency from the main financial institution 120a to the designated financial institution 120b, as represented by the arrow 236g′. Such transfer may represent the transfer of the second amount of fiat currency from the main financial institution 120a to the designated financial institution 120b (and/or a deposit of the second amount of fiat currency by the main financial institution 120a with the designated financial institution 120b) in exchange for a transfer of the second amount of digital assets from the designated financial institution 120b to the main financial institution 120a (and/or in exchange for a deposit of the second amount of digital assets by the designated financial institution 120b with the main financial institution 120a). In some example embodiments, instead of a transfer of the second amount of digital assets from the second user 110b to the designated financial institution 120b followed by a transfer of the second amount of digital assets from the designated financial institution 120b to the main financial institution 120a, a single transfer of the second amount of digital assets from the second user 110b to the main financial institution 120a may be performed without departing from the teachings of the present disclosure.

The digital asset withdrawal processor 236 may process a recording, in the distributed ledger 104, of the transfer of the second amount of digital assets from the main financial institution 120a to the designated financial institution 120b, as represented by arrow 236b′. Such record may represent the transfer back of the second amount of digital assets from the main financial institution 120a to the designated financial institution 120b (and/or a withdrawal of the second amount of digital assets by the designated financial institution 120b from the main financial institution 120a) in exchange for a withdrawal of the second amount of fiat currency by the main financial institution 120a from the designated financial institution 120b (and/or in exchange for a transfer back of the second amount of fiat currency from the designated financial institution 120b to the main financial institution 120a). The digital asset withdrawal processor 236 may process a recording, in the distributed ledger 104 or other database 104, of the transfer of the second amount of fiat currency from the designated financial institution 120b to the main financial institution 120a, as represented by arrow 236a′. Such record may represent the transfer back of the second amount of fiat currency from the designated financial institution 120b to the main financial institution 120a (and/or a withdrawal of the second amount of fiat currency by the main financial institution 120a from the designated financial institution 120b) in exchange for a transfer back of the second amount of digital assets from the main financial institution 120a to the designated financial institution 120b (and/or in exchange for a withdrawal of the second amount of digital assets by the designated financial institution 120b from the main financial institution 120a). The digital asset withdrawal processor 236 may process a recording, in the distributed ledger 104 or other database 104, of the transfer of the second amount of digital assets from the designated financial institution 120b to the first user 110a, as represented by arrow 236c′. Such record may represent the early withdrawal from the term deposit of the second amount of digital assets from the designated financial institution 120b by the first user 110a. The digital asset withdrawal processor 236 may process a recording, in the distributed ledger 104 or other database 104, of the transfer of the first amount of accrued interest (e.g., the first early withdrawal accrued interest) from the designated financial institution 120b to the first user 110a, as represented by arrow 236d′. Such record may represent the payment, by the designated financial institution 120b to the first user 110a, of the interest accrued as a result of depositing the second amount of digital assets until the withdrawal. The digital asset withdrawal processor 236 may process a recording, in the distributed ledger 104 or other database 104, of one or more terms, conditions, requirements, arrangements, interest rate(s), relevant date(s), etc. of the withdrawal of the second amount of digital assets by the first user 110a from the designated financial institution 120b, the transfer(s) of the second amount of digital assets, the transfer(s) of the second amount of fiat currency, and/or the transfer(s) of the first amount of accrued interest. The digital asset withdrawal processor 236 may process a sharing or making available of information pertaining to such completed or processed digital asset withdrawal request in or on the customer information sharing network 108 and/or distributed ledger 104. The digital asset withdrawal processor (and/or the digital asset deposit processor 234) may process a recording, in the distributed ledger 104, of the transfer of the second amount of digital assets from the second user 110b to the designated financial institution 120b, as represented by the arrow 236e′. Such record may represent the deposit of the second amount of digital assets made by the second user 110b with the designated financial institution 120b. Such record may represent the taking over of the term deposit from the first user 110a. Such record may represent a deposit into the second term deposit by the second user 110b. The digital asset withdrawal processor (and/or the digital asset deposit processor 234) may process a recording, in the distributed ledger 104, of the transfer of the second amount of digital assets from the designated financial institution 120b to the main financial institution 120a, as represented by arrow 236f. Such record may represent the transfer of the second amount of digital assets from the designated financial institution 120b to the main financial institution 120a (and/or a deposit of the second amount of digital assets by the designated financial institution 120b with the main financial institution 120a) in exchange for a deposit of the second amount of fiat currency by the main financial institution 120a with the designated financial institution 120b (and/or in exchange for a transfer of the second amount of fiat currency from the main financial institution 120a to the designated financial institution 120b). The digital asset withdrawal processor (and/or the digital asset deposit processor 234) may process a recording, in the distributed ledger 104 or other database 104, of the transfer of the second amount of fiat currency from the main financial institution 120a to the designated financial institution 120b, as represented by arrow 236g′. Such record may represent the transfer of the second amount of fiat currency from the main financial institution 120a to the designated financial institution 120b (and/or a deposit of the second amount of fiat currency by the main financial institution 120a with the designated financial institution 120b) in exchange for a transfer of the second amount of digital assets from the designated financial institution 120b to the main financial institution 120a (and/or in exchange for a deposit of the second amount of digital assets by the designated financial institution 120b with the main financial institution 120a). The digital asset withdrawal processor (and/or the digital asset deposit processor 234) may process a recording, in the distributed ledger 104 or other database 104, of one or more terms, conditions, requirements, arrangements, interest rate(s), start date, end date, transfer date, other relevant dates (e.g., early withdrawal dates and corresponding interest accrued), etc. of the second term deposit of the second amount of digital assets by the second user 110b with the designated financial institution 120b, the transfer(s) of the second amount of digital assets, and/or the transfer(s) of the second amount of fiat currency. The digital asset withdrawal processor 236 (and/or the digital asset deposit processor 234) may process a sharing or making available of information pertaining to such completed or processed early withdrawal of digital asset term deposit requests in or on the customer information sharing network 108 and/or distributed ledger 104.

FIG. 5F illustrates an example embodiment of processing a digital asset withdrawal by a user 110 from a designated financial institution 120b via a current financial institution 120c (e.g., processing a withdrawal process for the deposit illustrated in FIG. 5E and described in the present disclosure). The withdrawal request may be for a second amount of digital assets, which is at least a portion of the amount of digital assets (i.e., first amount of digital assets) deposited by the user 110. The digital asset withdrawal processor 236 may process a transfer of the second amount of digital assets from the main financial institution 120a to the designated financial institution 120b, as represented by the arrow 236bb. Such transfer may represent the transfer back of the second amount of digital assets from the main financial institution 120a to the designated financial institution 120b (and/or a withdrawal of the second amount of digital assets by the designated financial institution 120b from the main financial institution 120a) in exchange for a withdrawal of the second amount of fiat currency by the main financial institution 120a from the designated financial institution 120b (and/or in exchange for a transfer back of the second amount of fiat currency from the designated financial institution 120b to the main financial institution 120a). The digital asset withdrawal processor 236 may process a transfer of the second amount of fiat currency from the designated financial institution 120b to the main financial institution 120a, as represented by the arrow 236aa. Such transfer may represent the transfer back of the second amount of fiat currency from the designated financial institution 120b to the main financial institution 120a (and/or a withdrawal of the second amount of fiat currency by the main financial institution 120a from the designated financial institution 120b) in exchange for a transfer back of the second amount of digital assets from the main financial institution 120a to the designated financial institution 120b (and/or in exchange for a withdrawal of the second amount of digital assets by the designated financial institution 120b from the main financial institution 120a). The digital asset withdrawal processor 236 may process a transfer of the second amount of digital assets from the designated financial institution 120b to the current financial institution 120c, as represented by the arrow 236cc. Such transfer may represent the withdrawal of the second amount of digital assets from the designated financial institution 120b by the current financial institution 120c. Such transfer may represent the withdrawal, by the current financial institution 120c on behalf of the user 110, of the second amount of digital assets from the designated financial institution 120b. The digital asset withdrawal processor 236 may process a transfer of a first amount of accrued interest from the designated financial institution 120b to the current financial institution 120c, as represented by the arrow 236dd. Such transfer may represent a payment, from the designated financial institution 120b to the current financial institution 120c, of interest accrued as a result of depositing the second amount of digital assets until the withdrawal. Such transfer may represent receiving, by the current financial institution 120c on behalf of the user 110, of interest accrued as a result of depositing the second amount of digital assets with the designated financial institution 120b until the withdrawal. The digital asset withdrawal processor 236 may process a transfer of the second amount of digital assets from the current financial institution 120c to the user 110, as represented by the arrow 236cc′. Such transfer may represent the withdrawal of the second amount of digital assets from the current financial institution 120c by the user 110. The digital asset withdrawal processor 236 may process a transfer of the first amount of accrued interest from the current financial institution 120c to the user 110, as represented by the arrow 236dd′. Such transfer may represent a payment, from the current financial institution 120c to the user 110, of interest accrued as result of depositing the second amount of digital assets until the withdrawal.

The digital asset withdrawal processor 236 may process a recording, in the distributed ledger 104, of the second amount of digital assets from the main financial institution 120a to the designated financial institution 120b, as represented by the arrow 236bb. Such record may represent the transfer back of the second amount of digital assets from the main financial institution 120a to the designated financial institution 120b (and/or a withdrawal of the second amount of digital assets by the designated financial institution 120b from the main financial institution 120a) in exchange for a withdrawal of the second amount of fiat currency by the main financial institution 120a from the designated financial institution 120b (and/or in exchange for a transfer back of the second amount of fiat currency from the designated financial institution 120b to the main financial institution 120a). The digital asset withdrawal processor 236 may process a recording, in the distributed ledger 104, of the second amount of fiat currency from the designated financial institution 120b to the main financial institution 120a, as represented by the arrow 236aa. Such record may represent the transfer back of the second amount of fiat currency from the designated financial institution 120b to the main financial institution 120a (and/or a withdrawal of the second amount of fiat currency by the main financial institution 120a from the designated financial institution 120b) in exchange for a transfer back of the second amount of digital assets from the main financial institution 120a to the designated financial institution 120b (and/or in exchange for a withdrawal of the second amount of digital assets by the designated financial institution 120b from the main financial institution 120a). The digital asset withdrawal processor 236 may process a recording, in the distributed ledger 104, of the second amount of digital assets from the designated financial institution 120b to the current financial institution 120c, as represented by the arrow 236cc. Such record may represent the withdrawal of the second amount of digital assets from the designated financial institution 120b by the current financial institution 120c. Such record may represent the withdrawal, by the current financial institution 120c on behalf of the user 110, of the second amount of digital assets from the designated financial institution 120b. The digital asset withdrawal processor 236 may process a recording, in the distributed ledger 104, of a first amount of accrued interest from the designated financial institution 120b to the current financial institution 120c, as represented by the arrow 236dd. Such record may represent a payment, from the designated financial institution 120b to the current financial institution 120c, of interest accrued as a result of depositing the second amount of digital assets until the withdrawal. Such record may represent receiving, by the current financial institution 120c on behalf of the user 110, of interest accrued as a result of depositing the second amount of digital assets with the designated financial institution 120b until the withdrawal. The digital asset withdrawal processor 236 may process a recording, in the distributed ledger 104, of the second amount of digital assets from the current financial institution 120c to the user 110, as represented by the arrow 236cc′. Such record may represent the withdrawal of the second amount of digital assets from the current financial institution 120c by the user 110. The digital asset withdrawal processor 236 may process a recording, in the distributed ledger 104, of the first amount of accrued interest from the current financial institution 120c to the user 110, as represented by the arrow 236dd′. Such record may represent a payment, from the current financial institution 120c to the user 110, of interest accrued as result of depositing the second amount of digital assets until the withdrawal.

The Execution Processor (e.g., Execution Processor 240).

In an example embodiment, the processor 200 includes one or more execution processors (e.g., execution processors 240). The execution processor 240 is configurable or configured to communicate with, including receiving of instructions from, the transaction processor 230, the request processor 220, and/or the transaction interface 210. The execution processor 240 may be configurable or configured to communicate with one or more other processors 200 and/or one or more entities (and/or processors of such entities), including one or more financial institutions 120, one or more customer information sharing networks 108, one or more distributed ledgers 104, one or more token issuers 102, one or more users 110, one or more merchants 112, and/or one or more exchanges 114. The execution processor 240 may be configurable or configured to perform, among other things, one or more actions and/or processes to carry out the processing results of one or more other elements of the processor 200. For example, the execution processor 240 may be configurable or configured to communicate with a user 110 (and/or processor thereof), the digital asset generator 232, a token issuer 102 (and/or processor thereof), a main financial institution 120a (and/or processor thereof), a distributed ledger 104, and/or a customer information sharing network 108 to carry out a digital asset issuance (e.g., as illustrated in FIG. 5A and described in the present disclosure). As another example, the execution processor 240 may be configurable or configured to communicate with a user 110 (and/or processor thereof), a digital asset deposit processor 234, a designated financial institution 120b (and/or processor thereof), a main financial institution 120a (and/or processor thereof), a distributed ledger 104, and/or a customer information sharing network 108 to carry out a digital asset deposit (e.g., as illustrated in FIG. 5B and described in the present disclosure). As another example, the execution processor 240 may be configurable or configured to communicate with a user 110 (and/or processor thereof), a digital asset withdrawal processor 236, a designated financial institution 120b (and/or processor thereof), a main financial institution 120a (and/or processor thereof), a distributed ledger 104, and/or a customer information sharing network 108 to carry out a digital asset withdrawal (e.g., as illustrated in FIG. 5C and described in the present disclosure). As another example, the execution processor 240 may be configurable or configured to communicate with a first user 110a (and/or processor thereof), a second user 110b (and/or processor thereof), a digital asset withdrawal processor 236, a designated financial institution 120b (and/or processor thereof), a main financial institution 120a (and/or processor thereof), a distributed ledger 104, and/or a customer information sharing network 108 to carry out an early withdrawal of a term deposit (e.g., as illustrated in FIG. 5D and described in the present disclosure). As another example, the execution processor 240 may be configurable or configured to communicate with a user 110 (and/or processor thereof), a digital asset deposit processor 234, a designated financial institution 120b (and/or processor thereof), a main financial institution 120a (and/or processor thereof), a current financial institution 120c (and/or processor thereof), a customer information sharing network 108, and/or a distributed ledger 104 to carry out a digital asset deposit with the designated financial institution 120b by the current financial institution 120c on behalf of the user 110 (e.g., as illustrated in FIG. 5E and described in the present disclosure). As another example, the execution processor 240 may be configurable or configured to communicate with a user 110 (and/or processor thereof), a digital asset withdrawal processor 236, a designated financial institution 120b (and/or processor thereof), a main financial institution 120a (and/or processor thereof), a current financial institution 120c (and/or processor thereof), a customer information sharing network 108, and/or a distributed ledger 104 to carry out a digital asset withdrawal of a deposit with the designated financial institution 120b by the current financial institution 120c on behalf of the user 110 (e.g., as illustrated in FIG. 5F and described in the present disclosure). It is to be understood in the present disclosure that, in carrying out one or more of the processes described above and in the present disclosure, the execution processor 240 may be configurable or configured to record, directly or indirectly, transfers of digital assets and/or fiat currency between parties and other information pertaining to such transactions.

### Example Embodiments of a Method of Managing Digital Assets

An example embodiment of a method of managing digital assets may include issuing digital assets (e.g., method 600). Alternatively or in addition, the method of managing digital assets may include depositing digital assets and/or performing digital asset term deposits (e.g., method 700). Alternatively or in addition, the method of managing digital assets may include withdrawing digital assets (e.g., method 800). Alternatively or in addition, the method of managing digital assets may include performing an early withdrawal of digital assets from a digital asset term deposit (e.g., method 900). These and other methods, processes, and/or actions of the method of managing digital assets will now be further described with reference to the system 100 (as described in the present disclosure), the processor 200 (as described in the present disclosure), elements of the system 100 and/or processor 200 (as described in the present disclosure), methods, processes, and/or actions performed by the elements of the system 100 and/or processor 200 (as described in the present disclosure), and the accompanying FIGS. 1-9.

### Example Embodiments of a Method of Issuing Digital Assets (e.g., Method 600)

An example embodiment of a method (e.g., method 600) for issuing and/or generating digital assets (referred to herein as “issuing”, “issue”, “issued”, “issuance”, each as applicable) is illustrated in at least FIG. 6 and FIG. 5A. Digital assets may be issued when a user (e.g., user 110) submits a digital asset request, a digital asset issuance request, and/or a request to purchase digital assets (referred to herein as “digital asset request”). The method 600 of issuing digital assets may include receiving, from a user, a digital asset request for a first amount of a digital asset (e.g., action 602). The method 600 may include determining a first amount of a fiat currency (e.g., action 604). The first amount of fiat currency may be based on the first amount of digital assets. The method 600 may include receiving, from the user, the first amount of fiat currency, which may represent payment for the first amount of digital assets (e.g., action 606). The method 600 may include transferring, from a token issuer (e.g., the token issuer 102), the first amount of digital assets to the user (e.g., action 608). The method 600 may include depositing, with a main financial institution (e.g., the main financial institution 120a), the first amount of fiat currency (e.g., action 610). The method 600 may include recording, in a distributed ledger (e.g., the distributed ledger 104), the transfer of the first amount of digital assets to the user (e.g., action 612). The method 600 may be performed by example embodiments of the processor 200, including the digital asset generator 232, as described in the present disclosure.

These and other processes and/or actions of method 600 will now be further described with reference to the accompanying figures.

Receiving a Digital Asset Request for a First Amount of Digital Assets (e.g., Action 602).

In an example embodiment, the method of issuing digital assets 600 includes receiving a digital asset request (e.g., action 602). As used in the present disclosure, a digital asset request may also be referred to as a digital asset issuance request, request to purchase digital assets, or the like. A digital asset request may be sent from a user (e.g., a first user 110) (or processor thereof) and/or any other entity (or processor thereof) who wishes to purchase such digital assets. Such other entities may include, but are not limited to, financial institutions (e.g., financial institutions 120, 120a, 120b, 120c), token issuers (e.g., token issuers 102), members of a customer information sharing network (e.g., customer information sharing network 108), merchants (e.g., merchants 112), and/or exchanges (e.g., exchange 114). The digital asset request may be received by an example embodiment of the processor (e.g., the processor 200) directly. Alternatively or in addition, the digital asset request may be received by the processor 200 indirectly, such as via a token issuer (e.g., token issuer 102), a financial institution (e.g., a financial institution 120, including a designated financial institution 120b, a main financial institution 120a, and/or a current financial institution 120c), a merchant (e.g., merchant 112), an exchange (e.g., exchange 114), and/or a processor of one of these entities. The digital asset request may be a request to purchase a specified amount and/or value of a specified digital asset (e.g., a first amount of a digital asset). For example, the digital asset request may be a request to purchase 200 units of a particular stablecoin that is pegged to a particular fiat currency (e.g., the US Dollar).

Upon receiving a digital asset request from a user (and/or other request, including, but not limited to, a digital asset deposit request, a digital asset term deposit request, a digital asset withdrawal request, a request to withdraw digital assets from a digital asset term deposit, a request for early withdrawal of a digital asset term deposit, etc.), example embodiments of the method 600 may include performing checks, verifications, queries, reviews, and/or research on the user (e.g., onboarding checks, intake checks, KYC checks, credit checks, credit rating checks, etc.), including checks via a customer information sharing network (e.g., the customer information sharing network 108), a distributed ledger 104 (e.g., the distributed ledger 104), and/or financial institutions (e.g., a current financial institution 120c of the user), as described in the present disclosure for the customer check processor (e.g., the customer check processor 221). In situations where the user is a new customer (and/or a new customer check has not been performed for the user and/or a previously performed new customer check is now outdated or expired), example embodiments of the method 600 may perform a new customer check by performing an abbreviated or shortened new customer intake or review process. As described in the present disclosure for the customer check processor 221, such abbreviated or shortened new customer intake or review process may include, rely on, be based on, leverage, and/or take advantage of new customer checks (and/or existing customer information) for the user that were previously performed by (and/or already in possession of) one or more other entities or financial institutions.

Determining a First Amount of a Fiat Currency (e.g., Action 604).

In an example embodiment, the method of issuing digital assets 600 includes determining a first amount of a fiat currency (e.g., action 604). The first amount of fiat currency may be (or may include or may be a part of) an amount in fiat currency that the user is required to pay for the purchase of the first amount of digital assets. The first amount of fiat currency may be determined based on, among other things, the first amount of digital assets being purchased. For example, if the digital asset request is a request to purchase 200 units of a particular stablecoin, each of which are pegged to the US Dollar, then the first amount of fiat currency may be USD 200 (or an equivalent value in another fiat currency). It is to be understood that, in situations where the token issuer and/or any other entity involved in the issuing of digital assets applies a surcharge (e.g., commission, service, charge, etc.), discount (reduction in the amount of fiat currency required to purchase the first amount of digital assets), and/or bonus (free digital assets and/or fiat currency) to the purchase of the first amount of digital assets, such amount may or may not be included in the determination of the first amount of fiat currency.

Receiving the First Amount of Fiat Currency from User as Payment for the First Amount of Digital Assets (e.g., Action 606).

In an example embodiment, the method of issuing digital assets 600 includes receiving the first amount of fiat currency from the user (e.g., action 606). The first amount of fiat currency may be sent by the user, directly or indirectly, and received by a token issuer 102, directly or indirectly, in exchange for the token issuer issuing or generating the requested first amount of digital assets. For example, the user may transfer the first amount of fiat currency from a current financial institution (e.g., current financial institution 120c) of the user (or via other forms of payment, such as credit cards, debit cards, etc.) to a financial institution of the token issuer (e.g., the main financial institution referred to in action 610 below).

Transferring the First Amount of Digital Assets to the User (e.g., Action 608).

In an example embodiment, the method of issuing digital assets 600 includes transferring the first amount of digital assets to the user (e.g., action 608). The first amount of digital assets may be transferred, directly or indirectly, from a token issuer to the user. For example, the token issuer may transfer the first amount of digital assets to a digital wallet of the user.

Depositing, with a Main Financial Institution, the First Amount of Fiat Currency (e.g., Action 610).

In an example embodiment, the method of issuing digital assets 600 includes depositing the first amount of fiat currency (e.g., action 610). Specifically, after the user transfers the first amount of fiat currency to the token issuer in exchange for the transfer of the first amount of digital assets, the token issuer may deposit the received first amount of fiat currency with a main financial institution. It is to be understood that, in situations where the user transfers the first amount of fiat currency to a financial institution of the token issuer (e.g., action 606), action 610 may not be required. It is also to be understood in the present disclosure that the main financial institution may or may not be the same main financial institution that provides liquidity to designated financial institutions (e.g., as part of a digital asset deposit process, as described in the present disclosure).

Recording, in a Distributed Ledger, the Transfer of the First Amount of Digital Assets to the User (e.g., Action 612).

In an example embodiment, the method of issuing digital assets 600 includes recording the transfer of the first amount of digital assets to the user (e.g., action 612). The transfer of the first amount of digital assets from the token issuer to the user may be recorded in or on a distributed ledger (e.g., distributed ledger 104) and/or other database (e.g., other database 104). It is recognized in the present disclosure that the distributed ledger 104 referred to in the present disclosure may include and/or be designed to accommodate, record, and/or process smart contracts, or the like. In this regard, in processing a digital asset request (method 600), the parties (user, token issuer, and/or main financial institution), the transfer of the first amount of digital assets from the token issuer to the user, the transfer of the first amount of fiat currency from the user to the token issuer, the transfer of the first amount of fiat currency from the token issuer to the main financial institution, and/or other information pertaining to the processing of the digital asset request may be recorded in the distributed ledger.

### Example Embodiments of a Method of Depositing Digital Assets (e.g., Method 700)

FIG. 7 and FIGS. 5B and 5E illustrate example embodiments of a method (e.g., method 700) for depositing digital assets. Such depositing of digital assets may be for users (e.g., the user 110) who would like to earn interest on their digital assets when such digital assets are not being used. In this regard, example embodiments enable users who own, hold, and/or control digital assets to perform interest-bearing or interest-accruing deposits of their digital assets with designated financial institutions (e.g., the designated financial institution). It is recognized in the present disclosure that example embodiments of the method of depositing digital assets 700 enables such interest-bearing or interest-accruing deposits (and corresponding withdrawals) of digital assets to be achieved without being considered, classified, or interpreted as a security under certain jurisdictional laws (e.g., the United States of America).

The method of depositing digital assets 700 may include receiving a digital asset deposit request or a digital asset term deposit request (e.g., action 702). The method 700 may include determining a first amount of a fiat currency (e.g., action 704). The method 700 may include identifying a designated financial institution for receiving the deposit and/or term deposit (e.g., action 706). The method 700 may include transferring, from the user to the designated financial institution, the first amount of digital assets to deposit (e.g., action 708). The method 700 may include recording, in a distributed ledger, the transfer of the first amount of digital assets from the user to the designated financial institution (e.g., action 710). The method 700 may include transferring, from the designated financial institution to a main financial institution, the first amount of digital assets (e.g., action 712). The method 700 may include recording, in the distributed ledger, the transfer of the first amount of digital assets from the designated financial institution to the main financial institution (e.g., action 714). The method 700 may include transferring, from the main financial institution to the designated financial institution, the first amount of fiat currency (e.g., action 716). The method 700 may be performed by example embodiments of the processor 200, including the digital asset deposit processor 234, as described in the present disclosure.

These and other processes and/or actions of method 700 will now be further described with reference to the accompanying figures.

Receiving a Digital Asset Deposit Request to Deposit a First Amount of Digital Assets (e.g., Action 702).

In an example embodiment, the method of depositing digital assets 700 includes receiving a digital asset deposit request and/or digital asset term deposit request (e.g., action 702). As used in the present disclosure, a digital asset deposit request may also be referred to as a request to deposit digital assets, or the like, and a digital asset term deposit request may also be referred to as a request to deposit digital assets in a term deposit. Although the present disclosure describes digital asset deposits and digital asset term deposits as being performed for users (e.g., a first user 110) (or processor thereof), it is recognized in the present disclosure that digital asset deposits and digital asset term deposits may be performed for any other entity (or processor thereof) who wishes to deposit such digital assets. Such other entities may include, but are not limited to, financial institutions (e.g., financial institutions 120, 120a, 120b, 120c), token issuers (e.g., token issuers 102), members of a customer information sharing network (e.g., customer information sharing network 108), merchants (e.g., merchants 112), and/or exchanges (e.g., exchange 114). The digital asset deposit request and/or digital asset term deposit request may be received by an example embodiment of the processor (e.g., the processor 200) directly and/or indirectly, such as via a financial institution (e.g., a financial institution 120, including a designated financial institution 120b, a main financial institution 120a, and/or a current financial institution 120c) and/or a processor of a financial institution. The digital asset deposit request may be a request to perform an interest-bearing deposit of a specified amount and/or value of a specified digital asset (e.g., a first amount of a digital asset). For example, the digital asset deposit request may be a request to deposit 200 units of a particular stablecoin that is pegged to a particular fiat currency (e.g., the US Dollar) at an interest rate of 5% per annum. The digital asset term deposit request may be a request to perform an interest-bearing term deposit of a specified amount and/or value of a specified digital asset (e.g., a first amount of a digital asset) for a specified term or duration. For example, the digital asset term deposit request may be a request to deposit 200 units of a particular stablecoin that is pegged to a particular fiat currency (e.g., the US Dollar) for 5 months at an interest rate of 5% for the term.

Upon receiving a digital asset deposit request from a user (and/or other request, including, but not limited to, a digital asset request, a digital asset term deposit request, a digital asset withdrawal request, a request to withdraw digital assets from a digital asset term deposit, a request for early withdrawal of a digital asset term deposit, etc.), example embodiments of the method 700 may include performing checks, verifications, queries, reviews, and/or research on the user (e.g., onboarding checks, intake checks, KYC checks, credit checks, credit rating checks, etc.), including checks via a customer information sharing network (e.g., the customer information sharing network 108), a distributed ledger 104 (e.g., the distributed ledger 104), and/or financial institutions (e.g., a current financial institution 120c of the user), as described in the present disclosure for the customer check processor (e.g., the customer check processor 221). In situations where the user is a new customer (and/or a new customer check has not been performed for the user and/or a previously performed new customer check is now outdated or expired), example embodiments of the method 700 may perform a new customer check by performing an abbreviated or shortened new customer intake or review process. As described in the present disclosure for the customer check processor 221, such abbreviated or shortened new customer intake or review process may include, rely on, be based on, leverage, and/or take advantage of new customer checks (and/or existing customer information) for the user that were previously performed by (and/or already in possession of) one or more other entities or financial institutions.

Determining a First Amount of a Fiat Currency (e.g., Action 704).

In an example embodiment, the method of depositing digital assets 700 includes determining a first amount of a fiat currency (e.g., action 704). As described in the present disclosure and further described below, the first amount of fiat currency may be an amount of fiat currency that a main financial institution (e.g., main financial institution 120a), who is cooperating with the designated financial institution for the deposit, will provide to the designated financial institution (see action 716) for the purpose of providing liquidity to the designated financial institution and in exchange for receiving, from the designated financial institution by the main financial institution, the first amount of digital assets deposited by the user (see action 712).

The first amount of fiat currency may be (or may include or may be a part of) a value in fiat currency of the first amount of digital assets. The first amount of fiat currency may or may not be the same as the amount in fiat currency that the user paid for the purchase of the first amount of digital assets (e.g., action 604). Examples may include situations where the digital assets are not stablecoins (e.g., value of the digital asset in fiat currency may fluctuate) and/or situations where the fiat currency in method 600 (action 604) is a different than the fiat currency in method 700 (action 704). In this regard, the first amount of fiat currency determined in the method of issuing digital assets 600 may or may not be the same as the first amount of fiat currency determined in the method of depositing digital assets 700.

The first amount of fiat currency in action 704 may be determined based on, among other things, the first amount of digital assets being deposited. For example, if the digital asset deposit request is a request to deposit 200 units of a particular stablecoin, each of which are pegged to the US Dollar, then the first amount of fiat currency may be USD 200 (or an equivalent value in another fiat currency). It is to be understood that, in situations where any entity involved in the deposit of digital assets applies a surcharge (e.g., commission, service, charge, etc.), discount (e.g., reduction in the first amount of fiat currency in action 704), and/or bonus (e.g., additional fiat currency in action 704 and/or reduction in digital assets in action 712) to the deposit of the first amount of digital assets, such amount may or may not be included in the determination of the first amount of fiat currency.

Identifying a Designated Financial Institution for Receiving the Deposit and/or Term Deposit (e.g., Action 706).

In an example embodiment, the method of depositing digital assets 700 includes identifying a designated financial institution (e.g., designated financial institution 120b) for receiving the deposit and/or term deposit (e.g., action 706). In situations where the user has selected a designated financial institution (e.g., user selects by directly contacting and/or sending a digital asset deposit request to such designated financial institution; or user selects, via a central portal, website, mobile application, or the like, a designated financial institution from among a plurality of financial institutions), the identified designated financial institution will be such selected financial institution. Alternatively or in addition, the method 700 and/or action 706 may include selecting, from among a plurality of financial institutions (e.g., financial institution 120), a designated financial institution for receiving the deposit and/or term deposit. The plurality of financial institutions available to be selected may be those financial institutions that offer, provide, and/or capable of offering and/or providing example embodiments of interest-bearing or interest-accruing digital asset deposits and withdrawals, including digital asset term deposits, withdrawals of digital asset term deposits, transfers of digital asset term deposits, early withdrawals of digital asset term deposits, and/or take-overs of digital asset term deposits, as described in the present disclosure. Alternatively or in addition, the plurality of financial institutions available may be financial institutions selected based on one or more criterion, including one or more of those described below and in the present disclosure.

The designated financial institution may be selected from among a plurality of financial institutions based on one or more criterion. For example, the designated financial institution may be selected based on interest rate(s) offered for digital asset deposits (e.g., whichever financial institution offers the highest interest rate). As another example, the designated financial institution may be selected based on whether or not the user is an existing customer of the designated financial institution (which reduces or eliminates the need to perform new customer checks). As another example, the designated financial institution may be selected based on whether or not the designated financial institution is a participant or member of a customer information sharing network. As another example, the designated financial institution may be selected based on whether or not the designated financial institution shares or makes available customer information on a distributed ledger. As another example, the designated financial institution may be selected based on whether or not the designated financial institution and a current financial institution (i.e., an existing financial institution of the user) are participants or members of a same or common customer information sharing network. As another example, the designated financial institution may be selected based on whether or not the designated financial institution and a current financial institution (i.e., an existing financial institution of the user) share or make available customer information on a same or common distributed ledger.

Transferring, from the User to the Designated Financial Institution, the First Amount of Digital Assets to Deposit (e.g., Action 708).

In an example embodiment, the method of depositing digital assets 700 includes transferring the first amount of digital assets from the user to the designated financial institution (e.g., action 708). The first amount of digital assets may be transferred, directly or indirectly, from the user to the designated financial institution. For example, the user may transfer the first amount of digital assets from a digital wallet of the user to a digital wallet of the designated financial institution. The transfer of the first amount of digital assets from the user may represent an interest-bearing or non-interest-bearing deposit of the first amount of digital assets by the user with the designated financial institution. For term deposits, the transfer of the first amount of digital assets from the user to the designated financial institution may represent an interest-bearing or interest-accruing term deposit of the first amount of digital assets by the user with the designated financial institution. For interest-bearing deposits with a designated financial institution via a current financial institution (e.g., as illustrated in FIG. 5E and described in the present disclosure), the transfer of the first amount of digital assets from the user to the current financial institution and transfer of the first amount of digital assets from the current financial institution to the designated financial institution may represent an interest-bearing or interest-accruing deposit of the first amount of digital assets with the designated financial institution by the current financial institution on behalf of the user (or by the user via the current financial institution).

Recording, in a Distributed Ledger, the Transfer of the First Amount of Digital Assets from the User to the Designated Financial Institution (e.g., Action 710).

In an example embodiment, the method of depositing digital assets 700 includes recording the transfer of the first amount of digital assets from the user to the designated financial institution (e.g., action 710). The transfer of the first amount of digital assets from the user to the designated financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the issuance of the digital assets (e.g., action 612), and may include and/or be designed to accommodate, record, and/or process smart contracts, or the like. In this regard, in processing a digital asset deposit request (method 700), the type of deposit (e.g., interest-bearing deposit, non-interest-bearing deposit, interest-bearing term deposit, interest-bearing flexible term deposit with early withdrawal option, interest-bearing deposit with a designated financial institution via a current financial institution of the user (e.g., FIG. 5E), etc.), the parties (e.g., the user, designated financial institution, main financial institution, current financial institution, etc.), the interest rate(s), the relevant date(s) (e.g., deposit date, start date for term deposits, end date for term deposits, early withdrawal date(s) for flexible term deposits, etc.), the transfer of the first amount of digital assets from the user to the designated financial institution (e.g., for interest-bearing deposits or term deposits), the transfer of the first amount of digital assets from the user to a current financial institution (e.g., the current financial institution 120c, as described in the present disclosure) (e.g., for interest-bearing deposits with a designated financial institution via a current financial institution of the user, as illustrated in FIG. 5E and described in the present disclosure), the transfer of the first amount of digital assets from the current financial institution to the designated financial institution (e.g., for interest-bearing deposit with a designated financial institution via a current financial institution of the user, as illustrated in FIG. 5E and described in the present disclosure), the transfer of the first amount of digital assets from the designated financial institution to the main financial institution (see action 712), the transfer of the first amount of fiat currency from the main financial institution to the designated financial institution (see action 716), and/or other information pertaining to the processing of the digital asset deposit request or digital asset term deposit request (and may also include all information pertaining to the processing of a digital asset withdrawal request (see method 800) and/or processing of a request for early withdrawal of a digital asset term deposit (see method 900)) may be recorded in the distributed ledger. The recording, in the distributed ledger, of the transfer of the first amount of digital assets from the user to the designated financial institution may represent an interest-bearing or interest-accruing deposit of the first amount of digital assets by the user with the designated financial institution. For term deposits, the recording, in the distributed ledger, of the transfer of the first amount of digital assets from the user to the designated financial institution may represent an interest-bearing or interest-accruing term deposit of the first amount of digital assets by the user with the designated financial institution. For interest-bearing deposits with a designated financial institution via a current financial institution (e.g., FIG. 5E), the recording, in the distributed ledger, of the transfer of the first amount of digital assets from the user to current financial institution and transfer of the first amount of digital assets from the current financial institution to the designated financial institution may represent an interest-bearing or interest-accruing deposit of the first amount of digital assets with the designated financial institution by the current financial institution on behalf of the user.

Transferring, from the Designated Financial Institution to a Main Financial Institution, the First Amount of Digital Assets (e.g., Action 712).

In an example embodiment, the method of depositing digital assets 700 includes transferring the first amount of digital assets from the designated financial institution to a main financial institution (e.g., main financial institution 120a) (e.g., action 712). Such transfer may represent a transfer of the first amount of digital assets from the designated financial institution to the main financial institution (and/or a deposit of the first amount of digital assets by the designated financial institution with the main financial institution) in exchange for a deposit of the first amount of fiat currency by the main financial institution with the designated financial institution (and/or in exchange for a transfer of the first amount of fiat currency from the main financial institution to the designated financial institution). As described in the present disclosure, the first amount of fiat currency may be an amount of fiat currency that the main financial institution, who is cooperating with the designated financial institution for the deposit, will provide to the designated financial institution (see action 716) for the purpose of providing liquidity to the designated financial institution and in exchange for receiving the first amount of digital assets deposited by the user (this action 712). In example embodiments, such an exchange between the designated financial institution and the main financial institution may be understood as, equivalent to, similar to, performed as, having similar or the same effect as, and/or analogous to a buy-back arrangement, two-way deposit and withdrawal, or the like. Such arrangement may be one in which the transfer of the first amount of digital assets (as deposited by the user) by the designated financial institution to the main financial institution in exchange for liquidity (e.g., the first amount of fiat currency) (see action 716) includes an arrangement, agreement, and/or promise by the parties that, when the designated financial institution receives a digital asset withdrawal request (or request to withdraw digital assets from a term deposit) from the user to withdraw such deposited digital assets, the designated financial institution will transfer back fiat currency to the main financial institution (such amount of fiat currency corresponding to or based on the amount of digital assets being withdrawn; for example, a second amount of digital assets being withdrawn, which is at least a portion of the first amount of digital assets previously deposited, may correspond to a second amount of fiat currency). Pursuant to such arrangement, the main financial institution will correspondingly transfer back the deposited digital assets to the designated financial institution (such amount of digital assets corresponding to the amount of digital assets being withdrawn; e.g., the second amount of digital assets).

The first amount of digital assets may be transferred, directly or indirectly, from the designated financial institution to the main financial institution. For example, the designated financial institution may transfer the first amount of digital assets from a digital wallet of the designated financial institution to a digital wallet of the main financial institution. The transfer of the first amount of digital assets from the designated financial institution may represent an interest-bearing or non-interest-bearing deposit and/or term deposit of the first amount of digital assets by the designated financial institution with the main financial institution.

In an example embodiment, the method of depositing digital assets 700 may include identifying the main financial institution (e.g., main financial institution 120a) for providing liquidity (e.g., in fiat currency and/or other digital assets) to the designated financial institution 120b (i.e., the financial institution that is receiving a digital asset deposit from the user 110). In situations where the designated financial institution has selected the main financial institution, the identified main financial institution will be such selected financial institution. Alternatively or in addition, the method 700 and/or action 712 may include selecting, from among a plurality of financial institutions (e.g., financial institution 120), the main financial institution. The main financial institution may be selected from among a plurality of financial institutions based on one or more criterion. For example, the main financial institution 120a may be selected based on whether or not the user is an existing customer of the main financial institution (which reduces or eliminates the need to perform new customer checks). As another example, the main financial institution may be selected based on whether or not the main financial institution is a participant or member of a customer information sharing network. As another example, the main financial institution may be selected based on whether or not the main financial institution shares or makes available customer information on the distributed ledger. As another example, the main financial institution may be selected based on whether or not the main financial institution and a current financial institution (i.e., an existing financial institution of the user) are participants or members of the same customer information sharing network. As another example, the main financial institution may be selected based on whether or not the main financial institution and a current financial institution (i.e., an existing financial institution of the user) share or make available customer information on the same distributed ledger.

Recording, in the Distributed Ledger, the Transfer of the First Amount of Digital Assets from the Designated Financial Institution to the Main Financial Institution (e.g., Action 714).

In an example embodiment, the method of depositing digital assets 700 includes recording the transfer of the first amount of digital assets from the designated financial institution to the main financial institution (e.g., action 714). The transfer of the first amount of digital assets from the designated financial institution to the main financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the user to the designated financial institution (e.g., action 710) and/or issuance of the digital assets (e.g., action 612), and may include and/or be designed to accommodate, record, and/or process smart contracts, or the like. The recording, in the distributed ledger, of the transfer of the first amount of digital assets from the designated financial institution to the main financial institution may represent a transfer of the first amount of digital assets from the designated financial institution to the main financial institution (and/or a deposit of the first amount of digital assets by the designated financial institution with the main financial institution) in exchange for a deposit of the first amount of fiat currency by the main financial institution with the designated financial institution (and/or in exchange for a transfer of the first amount of fiat currency from the main financial institution to the designated financial institution). It is to be understood in the present disclosure that, in some embodiments, recording, in the distributed ledger, of the transfer of the first amount of digital assets from the designated financial institution to the main financial institution may represent an interest-bearing or interest-accruing deposit of the first amount of digital assets by the designated financial institution with the main financial institution.

Transferring, from the Main Financial Institution to the Designated Financial Institution, the First Amount of Fiat Currency (e.g., Action 716).

In an example embodiment, the method of depositing digital assets 700 includes transferring the first amount of fiat currency from the main financial institution to the designated financial institution (e.g., action 716). Such transfer may represent a transfer of the first amount of fiat currency from the main financial institution to the designated financial institution (and/or a deposit of the first amount of fiat currency by the main financial institution with the designated financial institution) in exchange for a transfer of the first amount of digital assets from the designated financial institution to the main financial institution (and/or in exchange for a deposit of the first amount of digital assets by the designated financial institution with the main financial institution). As described in the present disclosure, the first amount of fiat currency may be an amount of fiat currency that the main financial institution, who is cooperating with the designated financial institution for the deposit, will provide to the designated financial institution for the purpose of providing liquidity to the designated financial institution and in exchange for receiving the first amount of digital assets deposited by the user (see action 712).

The method of depositing digital assets 700 may include recording the transfer of the first amount of fiat currency from the main financial institution to the designated financial institution. The transfer of the first amount of fiat currency from the main financial institution to the designated financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the first amount of fiat currency from the main financial institution to the designated financial institution may represent a transfer of the first amount of fiat currency from the main financial institution to the designated financial institution (and/or a deposit of the first amount of fiat currency by the main financial institution with the designated financial institution) in exchange for a transfer of the first amount of digital assets by the designated financial institution to the main financial institution (and/or in exchange for a deposit of the first amount of digital assets by the designated financial institution with the main financial institution).

### Example Embodiments of a Method of Withdrawing Digital Assets (e.g., Method 800)

FIG. 8 and FIGS. 5C and 5F illustrate example embodiments of a method (e.g., method 800) for withdrawing digital assets. Example embodiments enable users who have performed interest-bearing deposits of digital assets (e.g., method 700) to perform withdrawals of their digital assets along with accrued interest from designated financial institutions. It is recognized in the present disclosure that example embodiments of the method of withdrawing digital assets 800 enables withdrawals of such interest-bearing or interest-accruing deposits of digital assets to be achieved without being considered, classified, or interpreted as a security under certain jurisdictional laws (e.g., the United States of America).

The method 800 of withdrawing digital assets may include receiving a digital asset withdrawal request to withdraw a second amount of digital assets (e.g., action 802). Such withdrawal request may be for withdrawing digital asset deposits and/or digital asset term deposits. The method 800 may include determining a second amount of a fiat currency (e.g., action 804). The method 800 may include determining a first accrued amount (e.g., action 806). The method 800 may include transferring, from the designated financial institution to the main financial institution, the second amount of fiat currency (e.g., action 808). The method 800 may include transferring, from the main financial institution to the designated financial institution, the second amount of digital assets (e.g., action 810). The method 800 may include recording, in a distributed ledger, the transfer of the second amount of digital assets from the main financial institution to the designated financial institution (e.g., action 812). The method 800 may include transferring, from the designated financial institution to the user, the second amount of digital assets (e.g., action 814). The method 800 may include recording, in the distributed ledger, the transfer of the second amount of digital assets from the designated financial institution to the user (e.g., action 816). The method 800 may include transferring, from the designated financial institution to the user, the first accrued amount (e.g., action 818).

These and other processes and/or actions of method 800 will now be further described with reference to the accompanying figures.

Receiving a Digital Asset Withdrawal Request to Withdraw a Second Amount of Digital Assets (e.g., Action 802).

In an example embodiment, the method of withdrawing digital assets 800 includes receiving a digital asset withdrawal request and/or a request to withdraw digital asset term deposits (e.g., action 802). As used in the present disclosure, a digital asset withdrawal request may also be referred to as a request to withdraw digital assets, or the like, and may include requests to withdraw digital asset term deposits. Although the present disclosure describes digital asset withdrawals as being performed for users (e.g., a first user 110) (or processor thereof), it is recognized in the present disclosure that digital asset withdrawals may be performed for any other entity (or processor thereof) who wishes to withdraw deposited digital assets. Such other entities may include, but are not limited to, financial institutions (e.g., financial institutions 120, 120a, 120b, 120c), token issuers (e.g., token issuers 102), members of a customer information sharing network (e.g., customer information sharing network 108), merchants (e.g., merchants 112), and/or exchanges (e.g., exchange 114). The digital asset withdrawal request may be received by an example embodiment of the processor (e.g., the processor 200) directly and/or indirectly, such as via a financial institution (e.g., a financial institution 120, including a designated financial institution 120b, a main financial institution 120a, and/or a current financial institution 120c) and/or a processor of a financial institution. The digital asset withdrawal request may be a request to withdraw an interest-bearing deposit of a specified amount and/or value of a specified digital asset (e.g., a second amount of a digital asset) and accrued interest (e.g., a first amount of accrued interest) from a designated financial institution. For example, the digital asset withdrawal request may be a request to withdraw 100 units of a particular stablecoin that is pegged to a particular fiat currency (e.g., the US Dollar) at an interest rate of 5% per annum from a designated financial institution.

Upon receiving a digital asset withdrawal from a user (and/or other request, including, but not limited to, a digital asset request, a digital asset deposit request, a digital asset term deposit request, a digital asset withdrawal request, a request to withdraw digital assets from a digital asset term deposit, a request for early withdrawal of a digital asset term deposit, etc.), example embodiments of the method 800 may include performing checks, verifications, queries, reviews, and/or research on the user (e.g., onboarding checks, intake checks, KYC checks, credit checks, credit rating checks, etc.), including checks via a customer information sharing network (e.g., the customer information sharing network 108), a distributed ledger 104 (e.g., the distributed ledger 104), and/or financial institutions (e.g., a current financial institution 120c of the user), as described in the present disclosure for the customer check processor (e.g., the customer check processor 221). In situations where the user is a new customer (and/or a new customer check has not been performed for the user and/or a previously performed new customer check is now outdated or expired), example embodiments of the method 800 may perform a new customer check by performing an abbreviated or shortened new customer intake or review process. As described in the present disclosure for the customer check processor 221, such abbreviated or shortened new customer intake or review process may include, rely on, be based on, leverage, and/or take advantage of new customer checks (and/or existing customer information) for the user that were previously performed by (and/or already in possession of) one or more other entities or financial institutions.

Determining a Second Amount of a Fiat Currency (e.g., Action 804).

In an example embodiment, the method of withdrawing digital assets 800 includes determining a second amount of a fiat currency (e.g., action 804). As described in the present disclosure, the second amount of fiat currency may be an amount of fiat currency that the designated financial institution will return to the main financial institution (the main financial institution who cooperated with the designated financial institution for the corresponding deposit of digital assets by the user with the designated financial institution) in exchange for receiving, from the main financial institution by the designated financial institution, the second amount of digital assets previously deposited by the user (see actions 712, 714, and 716).

The second amount of fiat currency may be (or may include or may be a part of) a value in fiat currency of the second amount of digital assets being withdrawn by the user. The second amount of fiat currency may or may not be the same as the amount in fiat currency that the user paid for the purchase of the second amount of digital assets (e.g., action 604). The second amount of fiat currency determined in the method of depositing digital assets 700 may or may not be the same as the second amount of fiat currency determined in the method of withdrawing digital assets 800.

The second amount of fiat currency in action 804 may be determined based on, among other things, the second amount of digital assets being withdrawn. For example, if the digital asset withdrawal request is a request to withdraw 100 units of a particular stablecoin, each of which are pegged to the US Dollar, then the second amount of fiat currency may be USD 100 (or an equivalent value in another fiat currency). It is to be understood that, in situations where any entity involved in the withdrawal of digital assets applies a surcharge (e.g., commission, service, charge, etc.) and/or interest (e.g., additional fiat currency along with the second amount of fiat currency), such amount may or may not be included in the determination of the second amount of fiat currency.

Determining a First Accrued Amount (e.g., Action 806).

In an example embodiment, the method of withdrawing digital assets 800 includes determining a first accrued amount or first amount of accrued interest (e.g., action 804). As described in the present disclosure, the first accrued amount may be an amount of accrued interest that the designated financial institution will pay to the user along with the second amount of digital assets being withdrawn by the user. It is recognized in the present disclosure that the first accrued amount may be in fiat currency (e.g., US Dollar) or digital assets (e.g., the same type or form of digital assets being withdrawn).

Transferring, from the Designated Financial Institution to the Main Financial Institution, the Second Amount of Fiat Currency (e.g., Action 808).

In an example embodiment, the method of withdrawing digital assets 800 includes transferring the second amount of fiat currency from the designated financial institution to the main financial institution (e.g., action 808). Such transfer may represent a transfer back of the second amount of fiat currency from the designated financial institution to the main financial institution (and/or a withdrawal of the second amount of fiat currency by the main financial institution from the designated financial institution) in exchange for a transfer of the second amount of digital assets from the main financial institution to the designated financial institution (and/or in exchange for a withdrawal of the second amount of digital assets by the designated financial institution from the main financial institution). As described in the present disclosure, the second amount of fiat currency may be the amount of fiat currency that the main financial institution, who cooperated with the designated financial institution for the corresponding deposit, provided to the designated financial institution for the purpose of providing liquidity to the designated financial institution and in exchange for receiving the second amount of digital assets deposited by the user (see action 712).

The method of withdrawing digital assets 800 may include recording the transfer of the second amount of fiat currency from the designated financial institution to the main financial institution. The transfer of the second amount of fiat currency from the designated financial institution to the main financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the second amount of fiat currency from the designated financial institution to the main financial institution may represent a transfer back of the second amount of fiat currency from the designated financial institution to the main financial institution (and/or a withdrawal of the second amount of fiat currency by the main financial institution from the designated financial institution) in exchange for a transfer back of the second amount of digital assets by the main financial institution to the designated financial institution (and/or in exchange for a withdrawal of the second amount of digital assets by the designated financial institution from the main financial institution).

Transferring, from the Main Financial Institution to the Designated Financial Institution, the Second Amount of Digital Assets (e.g., Action 810).

In an example embodiment, the method of withdrawing digital assets 800 includes transferring the second amount of digital assets from the main financial institution to the designated financial institution (e.g., action 810). Such transfer may represent a transfer back of the second amount of digital assets from the main financial institution to the designated financial institution (and/or a withdrawal of the second amount of digital assets by the designated financial institution from the main financial institution) in exchange for a transfer back of the second amount of fiat currency from the designated financial institution to the main financial institution (and/or in exchange for the withdrawal of the second amount of fiat currency by the main financial institution from the designated financial institution).

Recording, in a Distributed Ledger, the Transfer of the Second Amount of Digital Assets from the Main Financial Institution to the Designated Financial Institution (e.g., Action 812).

In an example embodiment, the method of withdrawing digital assets 800 includes recording the transfer of the second amount of digital assets from the main financial institution to the designated financial institution. The transfer of the second amount of digital assets from the main financial institution to the designated financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of fiat currency from the designated financial institution to the main financial institution (e.g., action 808), the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the second amount of digital assets from the main financial institution to the designated financial institution may represent a transfer back of the second amount of digital assets from the main financial institution to the designated financial institution (and/or a withdrawal of the second amount of digital assets by the designated financial institution from the main financial institution) in exchange for the transfer back of the second amount of fiat currency by the designated financial institution to the main financial institution (and/or in exchange for the withdrawal of the second amount of fiat currency by the main financial institution from the designated financial institution).

Transferring, from the Designated Financial Institution to the User, the Second Amount of Digital Assets (e.g., Action 814).

In an example embodiment, the method of withdrawing digital assets 800 includes transferring the second amount of digital assets from the designated financial institution to the user (e.g., action 814). Such transfer may represent the withdrawal of the second amount of digital assets from the designated financial institution by the user.

Recording, in the Distributed Ledger, the Transfer of the Second Amount of Digital Assets from the Designated Financial Institution to the User (e.g., Action 816).

In an example embodiment, the method of withdrawing digital assets 800 includes recording the transfer of the second amount of digital assets from the designated financial institution to the user (e.g., action 816). The transfer of the second amount of digital assets from the designated financial institution to the user may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the designated financial institution to the user (e.g., action 814), the transfer of fiat currency from the designated financial institution to the main financial institution (e.g., action 808), the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the second amount of digital assets from the designated financial institution to the user may represent the withdrawal of the second amount of digital assets from the designated financial institution by the user.

Transferring, from the Designated Financial Institution to the User, the First Accrued Amount (e.g., Action 818).

In an example embodiment, the method of withdrawing digital assets 800 includes transferring the first accrued amount from the designated financial institution to the user (e.g., action 818). Such transfer may represent the payment, by the designated financial institution to the user, of the interest accrued by the users' deposit of the second amount of digital assets with the designated financial institution.

The method of withdrawing digital assets 800 may include recording the transfer of the first accrued amount from the designated financial institution to the user. The transfer of the first accrued amount from the designated financial institution to the user may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the designated financial institution to the user (e.g., action 814), the transfer of fiat currency from the designated financial institution to the main financial institution (e.g., action 808), the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the first accrued amount from the designated financial institution to the user may represent the payment of the first accrued amount by the designated financial institution to the user.

### Example Embodiments of a Method of Performing an Early Withdrawal of Digital Assets from a Term Deposit (e.g., Method 900)

FIG. 9 and FIG. 5D illustrate example embodiments of a method (e.g., method 800) for performing an early withdrawal of digital asset term deposits. A first user who has made an interest-bearing term deposit of digital assets with a designated financial institution may perform an early withdrawal of their digital assets from the term deposit by having a second user take over the portion of the term deposit that is being withdrawn early. The method 900 of performing an early withdrawal of digital asset term deposits may include receiving an early withdrawal request to withdraw a second amount of digital assets before the end of the term deposit (e.g., action 902). The method 900 may include identifying a second user to take over, from the first user on a transfer date, the term deposit (e.g., action 904). The method 900 may include determining a first early withdrawal accrued amount (e.g., action 906). The method 900 may include determining a second amount of a fiat currency (e.g., action 908). The method 900 may include transferring, from the designated financial institution to the main financial institution, the second amount of fiat currency (e.g., action 910). The method 900 may include transferring, from the main financial institution to the designated financial institution, the second amount of digital assets (e.g., action 912). The method 900 may include recording, in a distributed ledger, the transfer of the second amount of digital assets from the main financial institution to the designated financial institution (e.g., action 914). The method 900 may include transferring, from the designated financial institution to the first user, the second amount of digital assets (e.g., action 916). The method 900 may include recording, in the distributed ledger, the transfer of the second amount of digital assets from the designated financial institution to the first user (e.g., action 918). The method 900 may include transferring, from the designated financial institution to the first user, the first early withdrawal accrued amount (e.g., action 920). The method 900 may include transferring, from the second user to the designated financial institution, the second amount of digital assets to deposit (e.g., action 922). The method 900 may include recording, in the distributed ledger, the transfer of the second amount of digital assets from the second user to the designated financial institution (e.g., action 924). The method 900 may include transferring, from the designated financial institution to the main financial institution, the second amount of digital assets (e.g., action 926). The method 900 may include recording, in the distributed ledger, the transfer of the second amount of digital assets from the designated financial institution to the main financial institution (e.g., action 928). The method 900 may include transferring, from the main financial institution to the designated financial institution, the second amount of fiat currency (e.g., action 930).

These and other processes and/or actions of method 800 will now be further described with reference to the accompanying figures.

Receiving an Early Withdrawal Request to Withdraw a Second Amount of Digital Assets Before the End of the Term Deposit (e.g., Action 902).

In an example embodiment, the method of performing an early withdrawal of digital asset term deposits 900 includes receiving an early withdrawal request to withdraw a second amount of digital assets before the end of the term deposit (e.g., action 902). Although the present disclosure describes such early withdrawals of digital asset term deposits as being performed for users (e.g., a first user 110) (or processor thereof), it is recognized in the present disclosure that early withdrawals of digital asset term deposits may be performed for any other entity (or processor thereof) who wishes to perform early withdrawals of digital asset term deposits. Such other entities may include, but are not limited to, financial institutions (e.g., financial institutions 120, 120a, 120b, 120c), token issuers (e.g., token issuers 102), members of a customer information sharing network (e.g., customer information sharing network 108), merchants (e.g., merchants 112), and/or exchanges (e.g., exchange 114). The request to perform early withdrawal of digital asset term deposits may be received by an example embodiment of the processor (e.g., the processor 200) directly and/or indirectly, such as via a financial institution (e.g., a financial institution 120, including a designated financial institution 120b, a main financial institution 120a, and/or a current financial institution 120c) and/or a processor of a financial institution. The request to perform early withdrawal of digital asset term deposits may be a request to withdraw, before an end date of the term deposit, an interest-bearing term deposit of a specified amount and/or value of a specified digital asset (e.g., a second amount of a digital asset, which is at least a portion of a total amount that the user has previously deposited) and accrued interest (e.g., the first early withdrawal accrued interest or first early withdrawal accrued amount) from a designated financial institution. For example, the request to perform early withdrawal of a digital asset term deposit may be a request to withdraw, after 5 months from the start date of the term deposit, 100 units of a particular stablecoin that is pegged to a particular fiat currency (e.g., the US Dollar) for a term deposit having a term of 10 months (or end date that is 10 months from the start date of the term deposit) and an interest rate of 6%.

Upon receiving a request for early withdrawal of a digital asset term deposit from a user (and/or other request, including, but not limited to, a digital asset request, digital asset deposit request, a digital asset term deposit request, a digital asset withdrawal request, a request to withdraw digital assets from a digital asset term deposit, etc.), example embodiments of the method 900 may include performing checks, verifications, queries, reviews, and/or research on the user (e.g., onboarding checks, intake checks, KYC checks, credit checks, credit rating checks, etc.), including checks via a customer information sharing network (e.g., the customer information sharing network 108), a distributed ledger 104 (e.g., the distributed ledger 104), and/or financial institutions (e.g., a current financial institution 120c of the user), as described in the present disclosure for the customer check processor (e.g., the customer check processor 221). In situations where the user is a new customer (and/or a new customer check has not been performed for the user and/or a previously performed new customer check is now outdated or expired), example embodiments of the method 900 may perform a new customer check by performing an abbreviated or shortened new customer intake or review process. As described in the present disclosure for the customer check processor 221, such abbreviated or shortened new customer intake or review process may include, rely on, be based on, leverage, and/or take advantage of new customer checks (and/or existing customer information) for the user that were previously performed by (and/or already in possession of) one or more other entities or financial institutions.

Identifying a Second User to Take Over, from the First User on a Transfer Date, the Term Deposit (e.g., Action 904).

In an example embodiment, the method of performing an early withdrawal of digital asset term deposits 900 includes identifying a second user to take over, from the first user on a transfer date, the term deposit (e.g., action 904). When a request to perform early withdrawal of a digital asset term deposit is received from a first user (e.g., user 110a), a second user (e.g., user 110b) may be selected, from among a plurality of users, to take over the term deposit from the first user 110a.

The second user 110b (who will take over the term deposit) may be selected from among a plurality of users based on one or more criterion. For example, the second user 110b (who will take over the term deposit) may be selected based on historical and/or predicted/forecasted information regarding the second user 110b. Such historical and/or predicted/forecasted information may include, but is not limited to, whether or not the second user 110b is willing or expected to accept the interest accrued for the remainder of a term deposit (e.g., for the example above in which the first user is performing an early withdrawal of a 10 month term deposit after 5 months from the start date of the term deposit, the first early withdrawal accrued interest for the first user 110a may be 3% and the interest rate for the second user 110b may be 3% for the remainder of the term deposit (e.g., remaining 5 months)). As another example, the second user 110b (who will take over the term deposit) may be selected based on whether or not the second user 110b is an existing customer of the designated financial institution who is holding the term deposit for the first user 110a (which reduces or eliminates the need to perform new customer checks). As another example, the second user 110b (who will take over the term deposit) may be selected based on whether or not the second user 110b is an existing customer of the main financial institution who is providing liquidity to the designated financial institution for the term deposit (which reduces or eliminates the need to perform new customer checks). As another example, the second user 110b (who will take over the term deposit) may be selected based on whether or not the designated financial institution who is holding the term deposit for the first user 110a and a current financial institution (i.e., existing financial institution of the second user 110b) are participants or members of the same customer information sharing network. As another example, the second user 110b (who will take over the term deposit) may be selected based on whether or not the designated financial institution who is holding the term deposit for the first user 110a and a current financial institution (i.e., existing financial institution of the second user 110b) share or make available customer information on the same distributed ledger.

Determining a First Early Withdrawal Accrued Amount (e.g., Action 906).

In an example embodiment, the method of performing an early withdrawal of digital asset term deposits 900 includes determining a first early withdrawal accrued amount (e.g., action 906). As described in the present disclosure, the first early withdrawal accrued amount may be an amount of accrued interest that the designated financial institution will pay to the first user 110a along with the second amount of digital assets that are being early withdrawn before the end of the term deposit. It is recognized in the present disclosure that the first early withdrawal accrued amount may be in fiat currency (e.g., US Dollar) or digital assets (e.g., the same type or form of digital assets being withdrawn).

It is recognized in the present disclosure that the first early withdrawal accrued amount may be determined in one or more of a plurality of ways. For example, the first early withdrawal accrued amount may be determined based on a percentage or proportion of the first accrued amount (or the amount of accrued interest that the first user 110a would have received if the first user 110a withdrew the second amount of digital assets on or after the end date of the term deposit). For example, the first early withdrawal accrued amount may be equal to (the first accrued amount)*[(number of days between the start date and the transfer date date)/(number of days between the start date and the end date)]. In this regard, accrued amount or accrued interest for the term deposit that the second user 110b is taking over from the first user 110a may also be determined based on a percentage or proportion of the first accrued amount. For example, the accrued amount for the second user 110b (assuming the second user 110b withdraws on or after the end date of the term deposit) may be equal to (the first accrued amount)*[(number of days between the transfer date and the end date date)/(number of days between the start date and the end date)]. Other ways of determining the first early withdrawal accrued amount and/or the accrued amount for the term deposit that the second user 110b is taking over from the first user 110a are also contemplated without departing from the teachings of the present disclosure.

Determining a Second Amount of a Fiat Currency (e.g., Action 908).

In an example embodiment, the method of performing an early withdrawal of digital asset term deposits 900 includes determining a second amount of a fiat currency (e.g., action 908). As described in the present disclosure, the second amount of fiat currency may be an amount of fiat currency that the designated financial institution will return to the main financial institution (the main financial institution is the financial institution who cooperated with the designated financial institution for the corresponding term deposit of digital assets by the first user 110a with the designated financial institution) in exchange for receiving, from the main financial institution by the designated financial institution, the second amount of digital assets previously deposited in the term deposit by the user (see actions 712, 714, and 716).

The second amount of fiat currency may be (or may include or may be a part of) a value in fiat currency of the second amount of digital assets being withdrawn by the user. The second amount of fiat currency may or may not be the same as the amount in fiat currency that the user paid for the purchase of the second amount of digital assets (e.g., action 604). The second amount of fiat currency determined in the method of depositing digital assets 700 may or may not be the same as the second amount of fiat currency determined in the method of performing early withdrawal of digital asset term deposits 900.

The second amount of fiat currency in action 908 may be determined based on, among other things, the second amount of digital assets being withdrawn. For example, if the request for early withdrawal of the digital asset term deposit is a request to withdraw 100 units of a particular stablecoin, each of which are pegged to the US Dollar, then the second amount of fiat currency may be USD 100 (or an equivalent value in another fiat currency). It is to be understood that, in situations where any entity involved in the withdrawal of digital assets applies a surcharge (e.g., commission, service, charge, etc.) and/or interest (e.g., additional fiat currency along with the second amount of fiat currency), such amount may or may not be included in the determination of the second amount of fiat currency.

Transferring, from the Designated Financial Institution to the Main Financial Institution, the Second Amount of Fiat Currency (e.g., Action 910).

In an example embodiment, the method of performing an early withdrawal of digital asset term deposits 900 includes transferring the second amount of fiat currency from the designated financial institution to the main financial institution (e.g., action 910). Such transfer may represent a transfer back of the second amount of fiat currency from the designated financial institution to the main financial institution (and/or a withdrawal of the second amount of fiat currency by the main financial institution from the designated financial institution) in exchange for a transfer of the second amount of digital assets from the main financial institution to the designated financial institution (and/or in exchange for a withdrawal of the second amount of digital assets by the designated financial institution from the main financial institution). As described in the present disclosure, the second amount of fiat currency may be the amount of fiat currency that the main financial institution, who cooperated with the designated financial institution for the corresponding term deposit, provided to the designated financial institution for the purpose of providing liquidity to the designated financial institution and in exchange for receiving the second amount of digital assets deposited in the term deposit by the user (see action 712).

The method of performing an early withdrawal of digital asset term deposits 900 may include recording the transfer of the second amount of fiat currency from the designated financial institution to the main financial institution. The transfer of the second amount of fiat currency from the designated financial institution to the main financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the second amount of fiat currency from the designated financial institution to the main financial institution may represent a transfer back of the second amount of fiat currency from the designated financial institution to the main financial institution (and/or a withdrawal of the second amount of fiat currency by the main financial institution from the designated financial institution) in exchange for a transfer back of the second amount of digital assets by the main financial institution to the designated financial institution (and/or in exchange for a withdrawal of the second amount of digital assets by the designated financial institution from the main financial institution).

Transferring, from the Main Financial Institution to the Designated Financial Institution, the Second Amount of Digital Assets (e.g., Action 912).

In an example embodiment, the method of performing an early withdrawal of digital asset term deposits 900 includes transferring the second amount of digital assets from the main financial institution to the designated financial institution (e.g., action 912). Such transfer may represent a transfer back of the second amount of digital assets from the main financial institution to the designated financial institution (and/or a withdrawal of the second amount of digital assets by the designated financial institution from the main financial institution) in exchange for the transfer back of the second amount of fiat currency from the designated financial institution to the main financial institution (and/or in exchange for the withdrawal of the second amount of fiat currency by the main financial institution from the designated financial institution).

Recording, in a Distributed Ledger, the Transfer of the Second Amount of Digital Assets from the Main Financial Institution to the Designated Financial Institution (e.g., Action 914).

In an example embodiment, the method of performing an early withdrawal of digital asset term deposits 900 includes recording the transfer of the second amount of digital assets from the main financial institution to the designated financial institution. The transfer of the second amount of digital assets from the main financial institution to the designated financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of fiat currency from the designated financial institution to the main financial institution (e.g., action 910), the transfer of digital assets from the first user 110a to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the second amount of digital assets from the main financial institution to the designated financial institution may represent a transfer back of the second amount of digital assets from the main financial institution to the designated financial institution (and/or a withdrawal of the second amount of digital assets by the designated financial institution from the main financial institution) in exchange for the transfer back of the second amount of fiat currency by the designated financial institution to the main financial institution (and/or in exchange for the withdrawal of the second amount of fiat currency by the main financial institution from the designated financial institution).

Transferring, from the Designated Financial Institution to the First User, the Second Amount of Digital Assets (e.g., Action 916).

In an example embodiment, the method of performing an early withdrawal of digital asset term deposits 900 includes transferring the second amount of digital assets from the designated financial institution to the first user (e.g., action 916). Such transfer may represent the early withdrawal of the second amount of digital assets from the designated financial institution by the first user 110a.

Recording, in the Distributed Ledger, the Transfer of the Second Amount of Digital Assets from the Designated Financial Institution to the First User (e.g., Action 918).

In example embodiment, the method of performing an early withdrawal of digital asset term deposits 900 includes recording the transfer of the second amount of digital assets from the designated financial institution to the first user (e.g., action 918). The transfer of the second amount of digital assets from the designated financial institution to the first user 110a may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the designated financial institution to the user (e.g., action 916), the transfer of digital assets from the main financial institution to the designated financial institution (e.g., action 914), the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the second amount of digital assets from the designated financial institution to the first user 110a may represent the early withdrawal of the second amount of digital assets from the designated financial institution by the first user 110a.

Transferring, from the Designated Financial Institution to the First User, the First Early Withdrawal Accrued Amount (e.g., Action 920).

In an example embodiment, the method of performing an early withdrawal of digital asset term deposits 900 includes transferring the first early withdrawal accrued amount from the designated financial institution to the first user (e.g., action 920). Such transfer may represent the payment, by the designated financial institution to the first user 110a, of the interest accrued up to the early withdrawal of the second amount of digital assets from the designated financial institution.

The method of performing an early withdrawal of digital asset term deposits 900 may include recording the transfer of the first early withdrawal accrued amount from the designated financial institution to the first user 110a. The transfer of the first early withdrawal accrued amount from the designated financial institution to the first user 110a may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the designated financial institution to the user (e.g., action 914), the transfer of fiat currency from the designated financial institution to the main financial institution (e.g., action 910), the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the first early withdrawal accrued amount from the designated financial institution to the first user 110a may represent the payment of the first early withdrawal accrued amount by the designated financial institution to the first user 110a.

Transferring, from the Second User to the Designated Financial Institution, the Second Amount of Digital Assets to Deposit (e.g., Action 922).

In an example embodiment, the method of performing an early withdrawal of digital asset term deposits 900 includes transferring the second amount of digital assets from the second user to the designated financial institution (e.g., action 922). The second amount of digital assets may be transferred, directly or indirectly, from the second user 110b to the designated financial institution. For example, the second user 110b may transfer the second amount of digital assets from a digital wallet of the second user 110b to a digital wallet of the designated financial institution. The transfer of the second amount of digital assets from the second user 110b may represent the taking over (from the first user 110a) of the interest-bearing or interest-accruing term deposit by the second user 110b.

Recording, in the Distributed Ledger, the Transfer of the Second Amount of Digital Assets from the Second User to the Designated Financial Institution (e.g., Action 924).

In an example embodiment, the method of performing an early withdrawal of digital asset term deposits 900 includes recording the transfer of the second amount of digital assets from the second user to the designated financial institution (e.g., action 924). The transfer of the second amount of digital assets from the second user 110b to the designated financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of the first early withdrawal accrued amount (e.g., action 920), the transfer of digital assets from the designated financial institution to the user (e.g., action 914), the transfer of fiat currency from the designated financial institution to the main financial institution (e.g., action 910), the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the second amount of digital assets from the second user 110b to the designated financial institution may represent the taking over (from the first user 110a) of the interest-bearing or interest-accruing term deposit by the second user 110b.

Transferring, from the Designated Financial Institution to the Main Financial Institution, the Second Amount of Digital Assets (e.g., Action 926).

In an example embodiment, the method of performing an early withdrawal of digital asset term deposits 900 includes transferring the second amount of digital assets from the designated financial institution to the main financial institution (e.g., action 926). The main financial institution may be the same main financial institution referred to in actions 910, 912, and 914 or may be a different main financial institution. The transfer may represent a transfer of the second amount of digital assets from the designated financial institution to the main financial institution (and/or a deposit of the second amount of digital assets by the designated financial institution with the main financial institution) in exchange for a deposit of the second amount of fiat currency by the main financial institution with the designated financial institution (and/or in exchange for a transfer of the second amount of fiat currency from the main financial institution to the designated financial institution). It is to be understood in the present disclosure that, in some embodiments, the transfer of the second amount of digital assets from the designated financial institution to the main financial institution may represent an interest-bearing or interest-accruing deposit or term deposit of the second amount of digital assets by the designated financial institution with the main financial institution.

The second amount of digital assets may be transferred, directly or indirectly, from the designated financial institution to the main financial institution. For example, the designated financial institution may transfer the second amount of digital assets from a digital wallet of the designated financial institution to a digital wallet of the main financial institution.

Recording, in the Distributed Ledger, the Transfer of the Second Amount of Digital Assets from the Designated Financial Institution to the Main Financial Institution (e.g., Action 928).

In an example embodiment, the method of performing an early withdrawal of digital asset term deposits 900 includes recording the transfer of the second amount of digital assets from the designated financial institution to the main financial institution (e.g., action 928). The transfer of the second amount of digital assets from the designated financial institution to the main financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the second user to the designated financial institution (e.g., action 924), the transfer of the first early withdrawal accrued amount (e.g., action 920), the transfer of digital assets from the designated financial institution to the user (e.g., action 914), the transfer of fiat currency from the designated financial institution to the main financial institution (e.g., action 910), the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the second amount of digital assets from the designated financial institution to the second user 120b may represent the taking over (from the first user 110a) of the interest-bearing or interest-accruing term deposit by the second user 110b.

Transferring, from the Main Financial Institution to the Designated Financial Institution, the Second Amount of Fiat Currency (e.g., Action 930).

In an example embodiment, the method of performing an early withdrawal of digital asset term deposits 900 includes transferring the second amount of fiat currency from the main financial institution to the designated financial institution (e.g., action 930). Such transfer may represent a transfer of the second amount of fiat currency from the main financial institution to the designated financial institution (and/or a deposit of the second amount of fiat currency by the main financial institution with the designated financial institution) in exchange for the transfer of the second amount of digital assets from the designated financial institution to the main financial institution (and/or in exchange for the deposit of the second amount of digital assets by the designated financial institution with the main financial institution). As described in the present disclosure, the second amount of fiat currency may be an amount of fiat currency that the main financial institution, who is cooperating with the designated financial institution for the term deposit, will provide to the designated financial institution for the purpose of providing liquidity to the designated financial institution and in exchange for receiving the second amount of digital assets deposited by the user (see action 926).

The method of performing an early withdrawal of digital asset term deposits 900 may include recording the transfer of the second amount of fiat currency from the main financial institution to the designated financial institution. The transfer of the second amount of fiat currency from the main financial institution to the designated financial institution may be recorded in or on a distributed ledger (e.g., distributed ledger 104) and/or other database (e.g., other database 104). It is recognized in the present disclosure that the distributed ledger 104 may be the same distributed ledger as the distributed ledger used for recording the transfer of digital assets from the designated financial institution to the main financial institution (e.g., action 928), the transfer of digital assets from the second user to the designated financial institution (e.g., action 924), the transfer of the first early withdrawal accrued amount (e.g., action 920), the transfer of digital assets from the designated financial institution to the user (e.g., action 914), the transfer of fiat currency from the designated financial institution to the main financial institution (e.g., action 910), the transfer of digital assets from the user to the designated financial institution (e.g., action 710), the transfer of digital assets from the designated financial institution to the main financial institution (e.g., action 714), and/or issuance of the digital assets (e.g., action 612), and may include and/or be designed to accommodate, record, and/or process smart contracts, or the like. The recording, in the distributed ledger, of the transfer of the second amount of fiat currency from the main financial institution to the designated financial institution may represent the transfer of the second amount of fiat currency from the main financial institution to the designated financial institution (and/or the deposit of the second amount of fiat currency by the main financial institution with the designated financial institution) in exchange for the transfer of the second amount of digital assets by the designated financial institution to the main financial institution (and/or in exchange for the deposit of the second amount of digital assets by the designated financial institution with the main financial institution).

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, “communication”, “communicate”, “connection”, “connect”, or other similar terms should generally be construed broadly to mean a wired, wireless, and/or other form of, as applicable, connection between elements, devices, computing devices, telephones, processors, controllers, servers, networks, telephone networks, the cloud, and/or the like, which enable voice and/or data to be sent, transmitted, broadcasted, received, intercepted, acquired, and/or transferred (each as applicable). Furthermore, a digital asset or digital token (as used in the present disclosure) is a term known in the art and, where applicable, may include and/or broadly and equivalently refer to cryptocurrencies, digital tokens, security-backed tokens, unsecured tokens, utility tokens, stablecoins, altcoins, public key and private key pairs, smart contracts, RSA, and the like. Furthermore, hashing (as used in the present disclosure), or the like, is a term known in the art and, where applicable, may include and/or broadly and equivalently refer to a transformation or mapping of an input into a fixed-length string or series of characters (e.g., by using a hashing algorithm, hashing function, or the like). Similarly, a hash (as used in the present disclosure) is a term known in the art and, where applicable, may include and/or broadly refer to a fixed-length string or series of characters resulting from the hashing of an input (e.g., by using a hashing algorithm (e.g., SHA-256, SHA-3, etc.), hashing function, or the like). Furthermore, encrypting, encryption, encrypt, and the like, are terms known in the art and, where applicable, may include and/or broadly and equivalently refer to a conversion of an input into a series of characters (or encrypted input) in such a way that the input can be readily recovered from the encrypted input (e.g., if an appropriate key is applied to decrypt the encrypted input). Furthermore, digitally signing, digital signing, digitally sign, signing, sign, and the like, are terms known in the art and, where applicable, may include and/or broadly and equivalently refer to creating digital signatures, including encrypting an input using a private key (i.e., for digital signatures, which is unlike the general approach of encrypting a message using a public key) so as to create a digital signature in such a manner that a recipient can, by applying a corresponding public key (i.e., a public key that corresponds to the private key used to create the digital signature; for digital signatures, the public key is used to decrypt the digital signature, which is unlike the general approach of decrypting a message using a private key), validate that the digital signature was signed (or encrypted) by the private key.

Also, as referred to herein, a processor, device, computing device, telephone, phone, server, gateway server, communication gateway server, and/or controller, may be any processor, computing device, and/or communication device, and may include a virtual machine, computer, node, instance, host, or machine in a networked computing environment. Also as referred to herein, a network or cloud may be or include a collection of machines connected by communication channels that facilitate communications between machines and allow for machines to share resources. Network may also refer to a communication medium between processes on the same machine. Also as referred to herein, a network element, node, or server may be a machine deployed to execute a program operating as a socket listener and may include software instances. Database (or memory or storage) may comprise any collection and/or arrangement of volatile and/or non-volatile components suitable for storing data. For example, memory may comprise random access memory (RAM) devices, read-only memory (ROM) devices, magnetic storage devices, optical storage devices, solid state devices, and/or any other suitable data storage devices. In particular embodiments, database may represent, in part, computer-readable storage media on which computer instructions and/or logic are encoded. Database may represent any number of memory components within, local to, and/or accessible by a processor and/or computing device.

Various terms used herein have special meanings within the present technical field. Whether a particular term should be construed as such a “term of art” depends on the context in which that term is used. Such terms are to be construed in light of the context in which they are used in the present disclosure and as one of ordinary skill in the art would understand those terms in the disclosed context. The above definitions are not exclusive of other meanings that might be imparted to those terms based on the disclosed context. Words of comparison, measurement, and timing such as “at the time”, “equivalent”, “during”, “complete”, and the like should be understood to mean “substantially at the time”, “substantially equivalent”, “substantially during”, “substantially complete”, etc., where “substantially” means that such comparisons, measurements, and timings are practicable to accomplish the implicitly or expressly stated desired result.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A method of managing digital asset deposits, the method comprising:
receiving, from a first user, a first deposit request, the first deposit request being a request to deposit a first amount of a digital asset;
performing, by a processor, a digital asset deposit process, the digital asset deposit process for processing the first deposit request, the digital asset deposit process including:
determining a first amount of a fiat currency, the first amount of the fiat currency determined based on the first amount of the digital asset; and
generating, in a first distributed ledger, a first deposit record, the first deposit record including:
a first record, the first record being a record of a transfer of the first amount of the digital asset from the first user to a designated financial institution, the first record representing a deposit of the first amount of the digital asset made by the first user with the designated financial institution; and
a second record, the second record being a record of a transfer of the first amount of the digital asset from the designated financial institution to a main financial institution, the second record representing a transfer of the first amount of the digital asset from the designated financial institution to the main financial institution in exchange for a deposit of the first amount of the fiat currency by the main financial institution with the designated financial institution;
receiving, from the first user, a first withdrawal request, the first withdrawal request being a request to withdraw a second amount of the digital asset, the second amount of the digital asset being at least a portion of the first amount of the digital asset deposited by the first user pursuant to the first deposit record; and
performing, by the processor, a digital asset withdrawal process, the digital asset withdrawal process for processing the first withdrawal request, the digital asset withdrawal process including:
determining a second amount of the fiat currency, the second amount of the fiat currency determined based on the second amount of the digital asset;
determining a first accrued amount, the first accrued amount representing an amount of interest accrued by depositing the second amount of the digital asset;
generating, in the first distributed ledger, a first withdrawal record, the first withdrawal record including:
a third record, the third record being a record of a transfer of the second amount of the digital asset from the main financial institution to the designated financial institution, the third record representing a transfer of the second amount of the digital asset from the main financial institution to the designated financial institution in exchange for a withdrawal of the second amount of the fiat currency by the main financial institution from the designated financial institution; and
a fourth record, the fourth record being a record of a transfer of the second amount of the digital asset from the designated financial institution to the first user, the fourth record representing a withdrawal of the second amount of the digital asset by the first user from the designated financial institution; and
generating, by the processor, an instruction to the designated financial institution to transfer the first accrued amount to the first user.

2. The method of claim 1, wherein the digital asset deposit process further includes one or more of the following:
generating, from the designated financial institution to the main financial institution, an institutional deposit request, the institutional deposit request being a request to transfer the first amount of the digital asset from the designated financial institution to the main financial institution in exchange for the main financial institution depositing the first amount of the fiat currency with the designated financial institution, wherein the generating of the second record is performed after the designated financial institution receives a confirmation from the main financial institution that the main financial institution will deposit the first amount of the fiat currency with the designated financial institution; and/or
generating, for the first user, a deposit result record, the deposit result record including information for use in withdrawing, at a later date, some or all of the digital assets deposited pursuant to the first deposit record.

3. The method of claim 1, wherein prior to the processor performing the digital asset deposit process:
determining whether or not the designated financial institution has previously completed a first new customer intake process for the first user, the first new customer intake process being a process performed by the designated financial institution before accepting a new customer;
responsive to a determination that the designated financial institution has not completed the first new customer intake process for the first user:
determining whether or not the main financial institution has previously performed a second new customer intake process for the first user, the second new customer intake process being a process performed by the main financial institution before accepting a new customer; and
responsive to a determination that the main financial institution has previously performed the second new customer intake process for the first user:
sharing, by the main financial institution to the designated financial institution, one or more results from the second new customer intake process for the first user;
performing an abbreviated customer review process in replacement of the first new customer intake process, the abbreviated customer review process including using the one or more shared results from the second new customer intake process for the first user; and
allowing the processor to proceed with performing the digital asset deposit process based on the abbreviated customer review process.

4. The method of claim 1, wherein prior to the processor performing the digital asset deposit process:
determining whether or not the designated financial institution has previously completed a first new customer intake process for the first user, the first new customer intake process being a process performed by the designated financial institution before accepting a new customer;
responsive to a determination that the designated financial institution has not completed the first new customer intake process for the first user:
identifying a second designated financial institution that has previously performed a second new customer intake process for the first user, the second new customer intake process being a process performed by the second designated financial institution before accepting a new customer, the second designated financial institution being a financial institution other than the designated financial institution and the main financial institution; and
responsive to a determination that the second designated financial institution has previously performed the second new customer intake process for the first user:
sharing, by the second designated financial institution to the designated financial institution, one or more results from the second new customer intake process for the first user;
performing an abbreviated customer review process in replacement of the first new customer intake process, the abbreviated customer review process including using the one or more shared results from the second new customer intake process for the first user; and
allowing the processor to proceed with performing the digital asset deposit process based on the abbreviated customer review process.

5. (canceled)

6. The method of claim 1, wherein the digital asset deposit process further includes one or more of the following:
transferring, from a digital wallet of the first user to the designated financial institution, the first amount of the digital asset; and/or
transferring, from the designated financial institution to the main financial institution, the first amount of the digital asset; and/or
transferring, from the main financial institution to the designated financial institution, the first amount of the fiat currency.

7. The method of claim 1, wherein the digital asset withdrawal process further includes:
generating, from the designated financial institution to the main financial institution, an institutional withdrawal request, the institutional withdrawal request being a request to transfer the second amount of the digital asset from the main financial institution to the designated financial institution in exchange for the withdrawal of the second amount of the fiat currency by the main financial institution from the designated financial institution;
wherein the generating of the third record is performed after the designated financial institution receives confirmation that the main financial institution will transfer the second amount of the digital asset to the designated financial institution.

8. The method of claim 1, wherein the digital asset withdrawal process further includes one or more of the following:
transferring, from the main financial institution to the designated financial institution, the second amount of the digital asset; and/or
transferring, from the designated financial institution to a digital wallet of the first user, the second amount of the digital asset; and/or
transferring, from the designated financial institution to the main financial institution, the second amount of the fiat currency; and/or
transferring, from the designated financial institution to the first user, the first accrued amount.

9. (canceled)

10. The method of claim 1, wherein one of the following apply:
wherein the first accrued amount is an amount in the digital asset, and wherein the transfer of the first accrued amount from the designated financial institution to the first user includes generating, in the first distributed ledger, a fifth record, the fifth record being a record of a transfer of the first accrued amount from the designated financial institution to the first user, the fifth record representing interest accrued by the depositing of the second amount of the digital asset by the first user with the designated financial institution; or
wherein the first accrued amount is an amount in the fiat currency.

11. The method of claim 1, wherein one or more of the following apply:
the first deposit request is received by the designated financial institution; and/or
the first deposit request is received by the main financial institution; and/or
the first withdrawal request is received by the designated financial institution; and/or
the first withdrawal request is received by the main financial institution; and/or
the first accrued amount is determined based on an amount of interest that has and/or would have accrued as a result of depositing the second amount of the fiat currency by the main financial institution with the designated financial institution; and/or
the digital asset is a stablecoin; and/or
the first distributed ledger is a blockchain; and/or
the main financial institution is a separate financial institution from the designated financial institution; and/or
the first amount of the fiat currency is determined based on a valuation in the fiat currency of the first amount of the digital asset; and/or
the second amount of the digital asset is less than or equal to the first amount of the digital asset; and/or
the first accrued amount is determined based on an interest rate provided to the first user pursuant to the first deposit request.

12. The method of claim 1, wherein:
prior to performing the digital asset deposit process, performing, by the processor, a financial institution selection process, the financial institution selection process including one or more of the following:
selecting, from among a plurality of financial institutions, the designated financial institution based on one or more first predetermined criterion; and/or
selecting, from among a plurality of financial institutions, the main financial institution based on one or more second predetermined criterion.

13. The method of claim 12, wherein one or more of the following apply:
the one or more first predetermined criterion includes one or more of the following:
an interest rate offered by each of the plurality of financial institutions for digital asset deposits; and/or
a confirmation of willingness to accept digital asset deposits; and/or
a confirmation of willingness to pay interest for digital asset deposits; and/or
a confirmation of participation in a KYC information sharing process with the main financial institution; and/or
one or more requirements and/or criterion provided by the first user in the first deposit request; and/or
one or more requirements and/or criterion provided by the main financial institution; and/or
the one or more second predetermined criterion includes one or more of the following:
a confirmation of willingness to provide the fiat currency to the designated financial institution in exchange for receiving digital assets from the designated financial institution; and/or
a confirmation of participation in a KYC information sharing process with the designated financial institution; and/or
one or more requirements and/or criterion provided by the first user in the first deposit request; and/or
one or more requirements and/or criterion provided by the designated financial institution.

14. (canceled)

15. A method of managing digital asset deposits, the method comprising:
receiving, from a first user, a first deposit request, the first deposit request being a request to deposit a first amount of a digital asset;
selecting, by a processor from among a plurality of financial institutions, a designated financial institution for the first deposit request based on one or more predetermined criterion;
identifying, by the processor, a main financial institution;
performing, by the processor, a digital asset deposit process, the digital asset deposit process for processing the first deposit request, the digital asset deposit process including:
determining a first amount of a fiat currency, the first amount of the fiat currency determined based on the first amount of the digital asset;
generating, in a first distributed ledger, a first deposit record, the first deposit record including:
a first record, the first record being a record of a transfer of the first amount of the digital asset from the first user to the designated financial institution, the first record representing a deposit of the first amount of the digital asset made by the first user with the designated financial institution; and
a second record, the second record being a record of a transfer of the first amount of the digital asset from the designated financial institution to the main financial institution, the second record representing a transfer of the first amount of the digital asset from the designated financial institution to the main financial institution in exchange for a deposit of the first amount of the fiat currency by the main financial institution with the designated financial institution; and
transferring, from the main financial institution to the designated financial institution, the first amount of the fiat currency;
receiving, from the first user, a first withdrawal request, the first withdrawal request being a request to withdraw the first amount of the digital asset deposited by the first user pursuant to the first deposit record; and
performing, by the processor, a digital asset withdrawal process, the digital asset withdrawal process for processing the first withdrawal request, the digital asset withdrawal process including:
determining a first accrued amount, the first accrued amount representing an amount of interest accruable and/or accrued by depositing the first amount of the fiat currency with the designated financial institution;
generating, in the first distributed ledger, a first withdrawal record, the first withdrawal record including:
a third record, the third record being a record of a transfer of the first amount of the digital asset from the main financial institution to the designated financial institution, the third record representing a transfer of the first amount of the digital asset from the main financial institution to the designated financial institution in exchange for a withdrawal of the first amount of the fiat currency by the main financial institution from the designated financial institution; and
a fourth record, the fourth record being a record of a transfer of the first amount of the digital asset from the designated financial institution to the first user, the fourth record representing a withdrawal of the first amount of the digital asset by the first user from the designated financial institution;
transferring, from the designated financial institution to the main financial institution, the first amount of the fiat currency; and
transferring, from the designated financial institution to the first user, the first accrued amount.

16. The method of claim 15, wherein the digital asset deposit process further includes one or more of the following:
generating, from the designated financial institution to the main financial institution, an institutional deposit request, the institutional deposit request being a request to transfer the first amount of the digital asset from the designated financial institution to the main financial institution in exchange for the main financial institution depositing the first amount of the fiat currency with the designated financial institution, wherein the generating of the second record is performed after the designated financial institution receives a confirmation from the main financial institution that the main financial institution will deposit the first amount of the fiat currency with the designated financial institution; and/or
generating, for the first user, a deposit result record, the deposit result record including information for use in withdrawing, at a later date, some or all of the digital assets deposited pursuant to the first deposit record.

17. The method of claim 15, wherein prior to the processor performing the digital asset deposit process:
determining whether or not the designated financial institution has previously completed a first new customer intake process for the first user, the first new customer intake process being a process performed by the designated financial institution before accepting a new customer;
responsive to a determination that the designated financial institution has not completed the first new customer intake process for the first user:
determining whether or not the main financial institution has previously performed a second new customer intake process for the first user, the second new customer intake process being a process performed by the main financial institution before accepting a new customer; and
responsive to a determination that the main financial institution has previously performed the second new customer intake process for the first user:
sharing, by the main financial institution to the designated financial institution, one or more results from the second new customer intake process for the first user;
performing an abbreviated customer review process in replacement of the first new customer intake process, the abbreviated customer review process including using the one or more shared results from the second new customer intake process for the first user; and
allowing the processor to proceed with performing the digital asset deposit process based on the abbreviated customer review process.

18. The method of claim 15, wherein prior to the processor performing the digital asset deposit process:
determining whether or not the designated financial institution has previously completed a first new customer intake process for the first user, the first new customer intake process being a process performed by the designated financial institution before accepting a new customer;
responsive to a determination that the designated financial institution has not completed the first new customer intake process for the first user:
identifying a second designated financial institution that has previously performed a second new customer intake process for the first user, the second new customer intake process being a process performed by the second designated financial institution before accepting a new customer, the second designated financial institution being a financial institution other than the designated financial institution and the main financial institution; and
responsive to a determination that the second designated financial institution has previously performed the second new customer intake process for the first user:
sharing, by the second designated financial institution to the designated financial institution, one or more results from the second new customer intake process for the first user;
performing an abbreviated customer review process in replacement of the first new customer intake process, the abbreviated customer review process including using the one or more shared results from the second new customer intake process for the first user; and
allowing the processor to proceed with performing the digital asset deposit process based on the abbreviated customer review process.

19. (canceled)

20. The method of claim 15, wherein the digital asset deposit process further includes one or more of the following:
transferring, from a digital wallet of the first user to the designated financial institution, the first amount of the digital asset; and/or
transferring, from the designated financial institution to the main financial institution, the first amount of the digital asset.

21. The method of claim 15, wherein the digital asset withdrawal process further includes:
generating, from the designated financial institution to the main financial institution, an institutional withdrawal request, the institutional withdrawal request being a request to transfer the first amount of the digital asset from the main financial institution to the designated financial institution in exchange for the withdrawal of the first amount of the fiat currency by the main financial institution from the designated financial institution;
wherein the generating of the third record is performed after the designated financial institution receives confirmation that the main financial institution will transfer the second amount of the digital asset to the designated financial institution.

22. The method of claim 15, wherein the digital asset withdrawal process further includes one or more of the following:
transferring, from the main financial institution to the designated financial institution, the first amount of the digital asset; and/or
transferring, from the designated financial institution to a digital wallet of the first user, the first amount of the digital asset.

23. (canceled)

24. The method of claim 15, wherein one of the following apply:
wherein the first accrued amount is an amount in the digital asset, and wherein the transfer of the first accrued amount from the designated financial institution to the first user includes generating, in the first distributed ledger, a fifth record, the fifth record being a record of a transfer of the first accrued amount from the designated financial institution to the first user, the fifth record representing interest accrued by the depositing of the first amount of the digital asset by the first user with the designated financial institution; or
wherein the first accrued amount is an amount in the fiat currency.

25. The method of claim 15, wherein one or more of the following apply:
the first deposit request is received by the designated financial institution; and/or
the first deposit request is received by the main financial institution; and/or
the first withdrawal request is received by the designated financial institution; and/or
the first withdrawal request is received by the main financial institution; and/or
the first accrued amount is determined based on an amount of interest that has and/or would have accrued as a result of depositing the first amount of the fiat currency by the main financial institution with the designated financial institution; and/or
the digital asset is a stablecoin; and/or
the first distributed ledger is a blockchain; and/or
the main financial institution is a separate financial institution from the designated financial institution; and/or
the first amount of the fiat currency is determined based on a valuation in the fiat currency of the first amount of the digital asset; and/or
the first accrued amount is determined based on an interest rate provided to the first user pursuant to the first deposit record.

26. The method of claim 15, wherein:
prior to performing the digital asset deposit process, performing, by the processor, a selecting, from among a plurality of financial institutions, the main financial institution based on one or more predetermined criterion.

27. The method of claim 26, wherein the one or more predetermined criterion includes one or more of the following:
a confirmation of willingness to provide the fiat currency to the designated financial institution in exchange for receiving digital assets from the designated financial institution; and/or
a confirmation of participation in a KYC information sharing process with the designated financial institution; and/or
one or more requirements and/or criterion provided by the first user in the first deposit request; and/or
one or more requirements and/or criterion provided by the designated financial institution.

28. (canceled)

29. The method of claim 15, wherein the identifying of the main financial institution includes selecting the main financial institution from among a plurality of financial institutions, the selecting of the main financial institution being performed based on one or more second predetermined criterion.

30. The method of claim 29, wherein the one or more second predetermined criterion includes one or more of the following:
a confirmation of willingness to provide the fiat currency to the designated financial institution in exchange for receiving digital assets from the designated financial institution; and/or
a confirmation of participation in a KYC information sharing process with the designated financial institution; and/or
one or more requirements and/or criterion provided by the first user in the first deposit request; and/or
one or more requirements and/or criterion provided by the designated financial institution.

31-46. (canceled)

47. A method of managing digital asset deposits, the method comprising:
receiving, from a first user, a first deposit request, the first deposit request being a request to deposit a first amount of a digital asset;
selecting, by a processor from among a plurality of financial institutions, a designated financial institution for the first deposit request based on one or more predetermined criterion;
identifying, by the processor, a main financial institution;
determining, by the processor, whether or not the designated financial institution has previously completed a first new customer intake process for the first user, the first new customer intake process being a process performed by the designated financial institution before accepting a new customer;
responsive to a determination that the designated financial institution has not completed the first new customer intake process for the first user:
determining, by the processor, whether or not a second financial institution has previously performed a second new customer intake process for the first user, the second new customer intake process being a process performed by the second financial institution before accepting a new customer, the second financial institution being a financial institution other than the designated financial institution; and
responsive to a determination that the second financial institution has previously performed the second new customer intake process for the first user:
providing, by the processor to the designated financial institution, one or more results from the second new customer intake process for the first user;
performing, by the processor, an abbreviated customer review process in replacement of the first new customer intake process, the abbreviated customer review process including using the one or more results from the second new customer intake process for the first user; and
performing, by the processor, a digital asset deposit process based on the abbreviated customer review process, the digital asset deposit process for processing the first deposit request, the digital asset deposit process including:
generating, in a first distributed ledger, a first deposit record, the first deposit record including:
a first record, the first record being a record of a transfer of the first amount of the digital asset from the first user to a designated financial institution, the first record representing a deposit of the first amount of the digital asset made by the first user with the designated financial institution; and
a second record, the second record being a record of a transfer of the first amount of the digital asset from the designated financial institution to the main financial institution, the second record representing a transfer of the first amount of the digital asset from the designated financial institution to the main financial institution in exchange for a deposit of the first amount of the fiat currency by the main financial institution with the designated financial institution;
receiving, from the first user, a first withdrawal request, the first withdrawal request being a request to withdraw a second amount of the digital asset, the second amount of the digital asset being at least a portion of the first amount of the digital asset deposited by the first user pursuant to the first deposit record; and
performing, by the processor, a digital asset withdrawal process, the digital asset withdrawal process for processing the first withdrawal request, the digital asset withdrawal process including:
determining a second amount of a fiat currency, the second amount of the fiat currency determined based on the second amount of the digital asset;
determining a first accrued amount, the first accrued amount representing an amount of interest accrued by depositing the second amount of the digital asset;
generating, in the first distributed ledger, a first withdrawal record, the first withdrawal record including:
a third record, the third record being a record of a transfer of the second amount of the digital asset from the main financial institution to the designated financial institution, the third record representing a transfer of the second amount of the digital asset from the main financial institution to the designated financial institution in exchange for a withdrawal of the second amount of the fiat currency by the main financial institution from the designated financial institution; and
a fourth record, the fourth record being a record of a transfer of the second amount of the digital asset from the designated financial institution to the first user, the fourth record representing a withdrawal of the second amount of the digital asset by the first user from the designated financial institution; and
generating, by the processor, an instruction to the designated financial institution to transfer the first accrued amount to the first user.

48. (canceled)

49. (canceled)
